(19) United States
(12) Patent Application Publication
(10) Pub. No.: US 2007/0266817 A1
(43) Pub. Date: Nov. 22, 2007

(54) Rotary-to-linear actuator, with particular use in motorcycle control

(76) Inventor: Charles L. Lassiter, Palo Alto, CA (US)

Correspondence Address: David R. Graham, 1337 Chewpon Avenue, Milpitas, CA, 95035, US

(21) Appl. No.: 11/879,995

(22) Filed: Jul. 19, 2007

Related U.S. Application Data
(63) Continuation-in-part of application No. 11/522,113, filed on Sep. 14, 2006.
(60) Provisional application No. 60/717,139, filed on Sep. 14, 2005.

(51) Int. Cl. B62K 21/12

(52) U.S. Cl. 74/551.8

(57) ABSTRACT

A bar-mounted or handle-mounted rotary-to-linear actuator is adapted for operation by hand via a Rotatable Assembly. A motorcycle control mechanism can be manually actuated via a Rotatable Assembly. A short-stroke rotary-to-linear actuator is adapted for operation by hand via a Rotatable Assembly. A low-displacement rotary-to-linear actuator is adapted for operation by hand via a Rotatable Assembly.

### BACKGROUND OF THE INVENTION

1. Field of the Invention

The invention relates to a bar-mounted or handle-mounted rotary-to-linear actuator adapted for operation by hand via a Rotatable Assembly. The invention also relates to a device for manual actuation of a motorcycle control mechanism via a Rotatable Assembly. The invention also relates to a short-stroke rotary-to-linear actuator adapted for operation by hand via a Rotatable Assembly. The invention also relates to a low-displacement rotary-to-linear actuator adapted for operation by hand via a Rotatable Assembly.

2. Related Art

The development of the modern motorcycle began over a hundred years ago, and apparatus for effecting control of operation of the motorcycle has evolved over that time. During the 1950's, the conventions for motorcycle controls began to settle into the standards which exist today. However, just as in the evolution of animal species, specialization occurs. About the time conventions for motorcycle controls began to solidify, the machines began to change. Since the 1950's, motorcycles have evolved into many classes of machines for the dirt, boulevard, motocross track, road circuit, drag strip, trials course, flat track, freestyle air, and even the ice rink. Remarkably, the controls used to handle all of these classes is still largely the same.

Apparatus for effecting control of an aspect of the operation of a motorcycle has been implemented so that the control is hand-actuated. Apparatus for effecting control of an aspect of the operation of a motorcycle has also been implemented so that the control is foot-actuated. In current conventional implementations of a motorcycle, hand-actuated throttle, front brake, and clutch controls are paired with foot-actuated gear selector and rear brake controls.

A pattern emerges when analyzing these controls: implement a distinct function, such as acceleration, through a distinct physical action, such as wrist extension. Implement deceleration through a second distinct physical action, such as finger contraction. These distinctions help prevent any cognitive overlap of function which might result in confusion (or worse) for the rider.

Hand-actuated motorcycle control apparatus has been implemented so that a lever assembly is used to effect control of an aspect of the operation of a motorcycle (sometimes referred to herein as “handlebar-lever-actuated control”). Hand-actuated motorcycle control apparatus has also been implemented so that a rotatable handgrip assembly is used to effect control of an aspect of the operation of a motorcycle (sometimes referred to herein as “rotatable-handgrip-actuated control”). FIG. 1A illustrates a lever-actuated control apparatus implemented on a handlebar 101: a lever 103 includes a cable tip recess area 103a which is accessed through the bottom of the lever, and can be used to move a cable (inside the cable sheath 104) to effect the handlebar-lever-actuated control. For the mechanism in FIG. 1A, the rider usually holds onto the fixed handgrip 102 with his thumb and shorter fingers while using his index and middle fingers to pull the lever 103. A perch clamp 106 mounts the perch assembly 105 to the handlebar. The perch assembly 105 includes a locking cable tension adjuster 105a for cable slack adjustment. FIG. 1B illustrates a rotatable-handgrip-actuated control apparatus implemented on a handlebar 101: a right-hand rotatable handgrip 107 is fixed to a throttle control tube (not shown) to enable rotation of the tube's cable flange and a pulley mechanism contained in the throttle control assembly 109. A throttle cable (inside the cable sheath 110) connects the cable flange to the actual throttle mechanism in the carburetor or fuel injection system. A grip washer 108 facilitates movement of the grip by decreasing friction between the grip and housing.

Typically, for a motorcycle, handlebar-lever-actuated control has been used when the control apparatus must produce a relatively large force to effect the desired control (such as is typically required to actuate a clutch or a brake), while rotatable-handgrip-actuated control has been used when the control apparatus need only produce a relatively small force to effect the desired control (such as is typically required to actuate a throttle). For instance, in current conventional implementations of a motorcycle, control of the front brake is effected using a lever assembly attached to the right handlebar of the motorcycle (i.e., the handlebar intended to be gripped by the rider's right hand when the rider is positioned on the motorcycle), control of the throttle is effected using a rotatable handgrip assembly of the right handlebar, and control of the clutch is effected using a lever assembly attached to the left handlebar of the motorcycle (i.e., the handlebar intended to be gripped by the rider's left hand when the rider is positioned on the motorcycle). One exception to the foregoing conventional implementation of hand-actuated motorcycle control is a custom motorcycle designed by Exile Cycles of North Hollywood, Calif., which includes no handlebar-lever-actuated control, and in which throttle and clutch actuation is effected using rotatable-handgrip-actuated control apparatus that is integrated into a custom set of handlebars. For aesthetic purposes, the mechanisms for effecting both throttle and clutch actuation have been built into the lateral ends of the modified handlebars, with all cable routing directed through the interior portion of the handlebar tube(s), and with cables traveling through and exiting custom-drilled components of the motorcycle's front suspension and steering assemblies.

Exceptions aside, the foregoing conventions have made interfacing with many different types of motorcycles predictable. However, aspects of the conventional controls described above can be problematic. For example, an off-road motorcycle rider's feet frequently leave the footpegs during turns and low-speed maneuvers to act as stabilizers or outriggers for preventing spills (as used here, the term “off-road” is intended to include most non-street categories of motorcycling such as motocross, supercross, enduro, flat-track, supermoto, etc.). Rear brake control is conventionally implemented so that such control is actuated by a rider using the rider's right foot and leg. However, if the rider's right foot and leg extend so that the foot leaves the footpeg to provide stabilization as discussed above, the rider no longer has access to the rear brake control. Conversely, if, in such situations, the rider leaves the rider's right foot planted on the right footpeg, the rider is at risk of not being able to extend the foot and leg in time to prevent a slide or spill. It might prove both convenient and beneficial for the rider to have a second mechanism for actuating the rear brake.

For more advanced off-road riders, there may be even greater benefits to having a second mechanism for actuating the rear brake. Techniques such as trail braking (slight application of the brakes while cornering, which gradually decreases as power is applied through the turn's apex) and brake sliding (locking the rear wheel in a turn, and using the rear wheel's skid to accelerate rotation of the motorcycle around the turn's apex) can be performed with more confidence in right turns if the rider is provided a secondary mechanism for actuating the rear brake. This way, the rider's right leg and foot can remain extended during the turn to “catch” the leaning motorcycle in case too much throttle or braking force is applied and the machine begins to slide out of control. For riders descending extreme hills, a technique known as “bulldogging” (walking beside the motorcycle while holding the handlebars and applying the brakes to prevent a runaway descent) normally occurs with the rider having no access to the rear brake since his or her feet are on the ground. Providing a secondary mechanism for these riders to actuate the rear brake could prove most beneficial. Finally, off-road riders even use their brakes while in the air. When riders engage in jumping maneuvers (launching the motorcycle into the air off of bumps or hills), maintaining the proper pitch of the machine while in the air can be most critical. In fact, landing with the front wheel too high or too low can be very dangerous. Riders can control the motorcycle's pitch while in the air by using the throttle and/or rear brake to create a gyroscopic torque on the machine in order to lift (throttle) or lower (rear brake) the elevation of the front wheel. If a rider's right foot leaves the footpeg, either accidentally or intentionally (such as in performing the aerial acrobatics of freestyle motocross), the rider may have no way to control the pitch of the motorcycle before landing. Once again, providing a secondary mechanism for these riders to actuate the rear brake could prove most beneficial.

Provision of a single handlebar-lever-actuated control on the right side of the handlebars that actuated both the front brake assembly and the rear brake assembly simultaneously might enable a rider to apply the brakes while his or her right leg was extended for stabilization purposes, but the current convention of separate controls for the front brake assembly and the rear brake assembly has already resulted in the advanced riding techniques described above for controlling the motorcycle by selective application of braking at the front or rear of the machine. These options would be sacrificed with a simultaneous front-and-rear-brake-actuating handlebar-lever-actuated control.

Provision of an additional handlebar-lever-actuated control on the right or left side of the handlebars to actuate the rear brake might enable a rider to apply the rear brake while his or her right leg was extended for stabilization purposes, but the cognitive process of selecting which of two levers to pull when the two levers are co-located on the same side of the handlebars, and the dexterity required when the rider chose to select only one of the two levers to pull at a given time, would likely result in lowered performance for the rider.

Provision of symmetric access to the rear brake control (i.e., providing rear brake control that can be activated using either the right foot or left foot) might enable a rider to use the right or left leg for stabilization as described above without sacrificing the ability to actuate the rear brake at the same time. Such innovation might increase both performance and safety, but the implementation of rear brake control so that such control can be activated by a rider using the rider's left foot would introduce undesirable complexity and/or expense, particularly since gear selection control is also conventionally effected using the left foot.

### SUMMARY OF THE INVENTION

As appreciated from the detailed description of the invention below, a solution to the above-described asymmetric rear brake actuation problem can be found with the hands, rather than at the feet. Cognitively, the conventional handlebar-mounted controls paradigm puts acceleration and stopping (throttle and front brake) in the right hand, while the left hand manages power delivery through the clutch. The throttle utilizes a handlebar-mounted rotatable handgrip assembly (t-rha), while the front brake and clutch are controlled with handlevers. The invention modifies this conventional paradigm to provide improved motorcycle control.

In accordance with the invention, a mechanism is provided which converts the rotation of a bar-mounted assembly, operated by an articulated hand/wrist/forearm with an average maximum flexion or extension range of about 90 degrees, to a linear motion useful for displacing linear mechanisms such as cables, rods, arms, hydraulic pistons, plungers, and other linear devices. The mechanism can be limited to a fixed range which matches one forward and backward movement of the hand/wrist/forearm; this range can be, for example, similar to the range of a doorknob and latch. Alternatively, the mechanism can incorporate ratcheting assemblies which provide a continuous directional action by temporarily locking the drive section as the hand resets or releases and rotates backward to continue a forward drive (and vice versa); this can be, for example, similar to the ratchet of a manual winch or socket wrench/ratchet drive mechanism. While suitable for a host of applications such as latches, switches, and valves, the invention can be particularly advantageous when used for motorcycle control applications.

The current spectrum of powered machines, which may include motorcycles and other machines controlled with a bar or handlebar, includes a kinetic energy conversion assembly, such as a brake assembly, which converts the kinetic energy of the machine to heat using friction, or a kinetic energy conversion assembly, such as a kinetic energy recovery system, which converts the kinetic energy of the machine upon deceleration by accelerating an integrated flywheel, or an electrical equivalent of the kinetic energy recovery system, which converts the kinetic energy of the machine upon deceleration into electricity which is stored as electrical potential using capacitors, batteries, etc.

The invention encompasses a variety of aspects. In one aspect, the invention concerns a Rotatable Assembly (RA) actuating mechanism which is applicable to multiple individual control systems such as clutch, brake, and other controls.

In another aspect, the invention concerns a Rotatable Assembly (RA) for a clutch-actuating mechanism which provides a control interface superior to lever-actuated systems. The forward rotation actuation matches the existing throttle control paradigm: rearward rotation=acceleration and forward rotation=deceleration.

In another aspect, the invention concerns a Rotatable Assembly (RA) actuating mechanism which is superior to lever extensions in a crash or accident: the RA is far less susceptible to breakage, bending, or dislocation in a spill due to its cylindrical bar-mounted profile.

In another aspect, the invention concerns a Rotatable Assembly (RA) actuating mechanism which is easily transferrable between handles or handlebars (e.g., 0.875″/22 mm) of other machines since it interfaces with standard (stock) control systems.

In another aspect, the invention concerns a Rotatable Assembly (RA) actuating mechanism with an integrated locking component which allows the user to lock the mechanism in a particular state with one finger, then release the lock by rotating the mechanism.

In another aspect, the invention concerns a Rotatable Handgrip Assembly (RHA) actuating mechanism which is superior to a lever-actuated mechanism due to the elimination of the need to release fingers from the handgrip for actuation, thus providing greater control and stability to the user.

In another aspect, the invention concerns a Rotatable Handgrip Assembly (RHA) actuating mechanism with a housing which exhibits a high degree of rotational positionability relative to other controls due to the circular symmetry of the handgrip's cylindrical bar-mounted profile.

In another aspect, the invention concerns multiple implementations for increasing a hand's torque on a Rotatable Handgrip Assembly (RHA) without significantly decreasing the hand's hold or “grip” on the machine.

In another aspect, the invention concerns a Rotatable Handgrip Assembly (RHA) with a forward-rotating actuating mechanism that includes a stop block component which provides the secure, fixed, non-rotating feel of a permanent, non-articulated handgrip when the user is not actuating the mechanism.

In another aspect, the invention concerns a Rotatable Assembly (RA) with a control housing featuring a haptic feedback device composed of a spring-loaded detent contacting a pattern of indentations with varying frequency such that the rider can sense where the control is in its range of movement.

In another aspect, the invention concerns a Rotatable Assembly (RA) actuating mechanism with a rotatable housing which uses the radial length and mass of its housing to provide increased torque and/or decreased muscle force required to actuate the mechanism.

In another aspect, the invention concerns a Rotatable Assembly (RA) with a rotatable housing featuring a collet lock mounting component which automatically centers the mechanism housing on the handle or handlebar axis while providing a quick-release mounting action.

In another aspect, the invention concerns a Rotatable Assembly (RA) with a rotatable housing featuring a plate lock mounting component with set screws and knurled locking plates which also can be used to center the mechanism housing on the handle or handlebar axis.

In another aspect, the invention concerns a Rotatable Assembly (RA) with a rotatable housing featuring a plate lock mounting component which provides a flat profile to the medial exterior wall of the housing where it meets the handlebar.

In another aspect, the invention concerns a Rotatable Assembly compound actuator (X-RA) mechanism which is applicable to multiple combined control systems such as clutch+brake, throttle+brake, etc.

In another aspect, the invention concerns a hybrid Rotatable Assembly compound actuator (X-RA Hybrid) mechanism which is applicable to multiple combined control systems such as clutch+brake, throttle+brake, lever-actuated brake+RA clutch, etc.

In another aspect, the invention concerns a hybrid Rotatable Assembly compound actuator (X-RA Hybrid) with a rotatable housing which integrates a conventional lever-actuated cable or conventional lever-actuated hydraulic mechanism to provide increased torque and/or decreased muscle force required to actuate the mechanism.

In another aspect, the invention concerns a hybrid Rotatable Assembly compound actuator (X-RA Hybrid) for clutches with a rotatable housing which integrates a conventional lever-actuated cable brake or conventional lever-actuated hydraulic brake mechanism in order to provide the most leverage consistency in the vertical axis due to the shorter horizontal range of motion of the brake lever.

In another aspect, the invention concerns a hybrid Rotatable Handgrip Assembly compound actuator (X-RHA Hybrid) with a rotatable housing in which the combination of lever-actuated control B into the housing of X-RHA control A enhances the function and usability of both X-RHA control A and lever-actuated control B, while increasing available space on the handle or handlebar.

In another aspect, the invention concerns a hybrid Rotatable Handgrip Assembly compound actuator (X-RHA Hybrid) with a rotatable housing in which the combination of lever-actuated control B into the housing of X-RHA control A maintains the position of the wrist and thumb relative to the lever in order to maximize the strength of the forearm muscles through the wrist, thus maximizing finger strength on the lever.

In another aspect, the invention concerns a hybrid Rotatable Assembly compound actuator (X-RA Hybrid) with a rotatable housing featuring a pivot clamp mounting component which attaches to the medial exterior wall of the rotatable housing and allows standard lever-type control perches to bolt to its clamp section in order to provide additional leverage to the rider for rotating the housing.

In another aspect, the invention concerns a hybrid Rotatable Assembly compound actuator (X-RA Hybrid) with a rotatable housing which uses the mass of its housing and radial length of a conventional cable or hydraulic lever and perch assembly mounted to a matching pivot clamp to provide increased torque and/or decreased muscle force required to actuate the rotating mechanism.

In another aspect, the invention concerns a hybrid Rotatable Assembly compound actuator (X-RA Hybrid) for clutches with a rotatable housing which accommodates a conventional lever-actuated cable or conventional lever-actuated hydraulic perch assembly for brake actuation mounted to a matching pivot clamp in order to provide the most leverage consistency in the vertical axis due to the shorter horizontal range of motion of the brake lever.

In another aspect, the invention concerns a hybrid Rotatable Handgrip Assembly compound actuator (X-RHA Hybrid) with a rotatable housing for which the addition of conventional lever-actuated control B onto the housing of X-RHA control A via the pivot clamp enhances the function and usability of both X-RHA control A and conventional lever-actuated control B.

In another aspect, the invention concerns a hybrid Rotatable Handgrip Assembly compound actuator (X-RHA Hybrid) with a rotatable housing for which the addition of conventional lever-actuated control B onto the housing of X-RHA control A via the pivot clamp maintains the position of the wrist and thumb relative to the lever in order to maximize the strength of the forearm muscles through the wrist, thus maximizing finger strength on the lever.

In another aspect, the invention concerns implementation of a tube with a locking flange which provides high rotational positionability relative to the rack wheel or side plate, and interlocks with the rack wheel or side plate to provide high strength.

In another aspect, the invention concerns implementation of a collar with a locking flange which provides high rotational positionability relative to the rack wheel or side plate, and interlocks with the rack wheel or side plate to provide high strength.

In another aspect, the invention incorporates a housing and components capable of accommodating different pinion/rack wheel gear ratio pairs with common center distances which the user can change to suit his preferences.

In another aspect, the invention concerns a screw-actuated hydraulic piston component suitable for hydraulic brake controls, hydraulic clutch controls, and other hydraulic systems.

In another aspect, the invention concerns a hydraulic piston component which does not require a return spring for assembly or proper actuation of a sprung (e.g. clutch) mechanism.

In another aspect, the invention concerns a hydraulic cylinder (barrel) component which can be manufactured significantly shorter than its lever-actuated counterpart due to the elimination of a return spring for assembly or proper actuation of a sprung (e.g. clutch) mechanism.

In another aspect, the invention concerns multiple components for lengthening the jacket of a stock cable, thus removing slack from the sliding steel leader: the split long-nosed adjuster insert, the split mid-cable insert, and the split tail addition are such components.

In another aspect, the invention concerns a supplemental system (secondary arm) for foot pedal-actuated mechanisms which leaves normal foot pedal function intact while providing auxiliary hand-actuated operation.

In another aspect, the invention concerns a switch valve assembly which affords the alternating use of two hydraulic master cylinders with one slave cylinder without misdirecting hydraulic fluids into the reservoir of the inactive master cylinder.

In another aspect, the invention concerns a switch valve assembly suitable for use with multiple types and brands of hydraulic master cylinders without modifications to the switch valve assembly or the master cylinders.

In another aspect, the invention concerns a magnetic switch valve assembly which is enhanced for extreme conditions by the use of magnets for securing the switch mechanism.

### BRIEF DESCRIPTION OF THE DRAWINGS

Note: the term “open side view” has been used to describe illustrations for which the side plate (e.g. FIG. 16) and tube (e.g. FIG. 6E) of the housing have been removed to reveal occluded components. See FIG. 23D.

FIG. 1A is a top view of a handlebar on which conventional lever-actuated control apparatus is implemented.

FIG. 1B is a top view of a handlebar on which conventional rotatable-handgrip-actuated control apparatus is implemented.

FIG. 2A is a side view of a hand imparting forward rotation to a bar using muscular flexion of the hand and wrist.

FIG. 2B is a side view of a hand imparting rearward rotation to a bar using muscular extension of the hand and wrist.

FIG. 3A is a perspective view of a conventional throttle control tube, on which is formed a cable flange and a stop flange.

FIG. 3B is a perspective view of a conventional handgrip including a grip flange.

FIGS. 4A through 4L are each a cross-sectional view of an RHA tube, illustrating a variety of tube shapes that can be used with embodiments of the invention.

FIGS. 5A through 5N are each a perspective view of a left-hand RHA grip that can be used with embodiments of the invention.

FIG. 6A is a side view of a locking flange formed with a perimeter having a pattern of regularly spaced gear-like teeth.

FIG. 6B is a side view of a locking flange formed with a perimeter having a pattern of regularly spaced petal shapes.

FIG. 6C is a side view of a locking flange formed with a perimeter having a pattern of regularly spaced square teeth.

FIG. 6D is a side view of a locking flange having an octagonally-shaped perimeter.

FIG. 6E is a perspective view of a locking flange tube formed with a petal-pattern flange.

FIG. 6F is a perspective view of a locking flange collar formed with a petal-pattern flange.

FIG. 7A is a perspective view of a forward-rotating tube lever.

FIG. 7B is a perspective view of a rearward-rotating tube lever.

FIG. 7C is a perspective view of a combined forward-and-rearward-rotating tube lever.

FIG. 7D is a perspective view of a thumb paddle.

FIG. 8A is a perspective view of a rack wheel and an associated bearing that can be used in embodiments of an RA according to the invention that include a stationary housing.

FIG. 8B is an exploded perspective view of a collet lock, set screws, two sealed bearings, and a rack hub that can be used in embodiments of an RA according to the invention that include a rotatable housing.

FIG. 8C is a latitudinal cross-sectional view of the collet lock, two sealed bearings, and rack hub of FIG. 8B attached to a handlebar within a rotatable housing.

FIG. 8D is an exploded perspective view of a plate lock, set screws, and a rack hub that can be used in embodiments of an RA according to the invention that include a rotatable housing.

FIG. 9A is a perspective view of a stop block.

FIG. 9B is an open side view of a stop block positioned in a housing of an RA according to the invention.

FIG. 10 is a perspective view of a pinion and associated bearing that can be used in embodiments of the invention.

FIG. 11A illustrates two different gear ratios with a constant center distance between gear axes.

FIG. 11B is a perspective view of a threaded pinion hub and threaded pinion bore, and a side view of rack and pinion gear sets.

FIG. 12 is a perspective view of a screw with multiple starts and straight splines that can be used in embodiments of the invention.

FIG. 13 is a side view of a coupler that can be used with an RA for cable actuation according to the invention.

FIG. 14 is a side view of a piston that can be used with an RA for hydraulic actuation according to the invention.

FIG. 15A is a perspective view of a handlebar on which is mounted a stationary housing RHA for cable actuation, according to an embodiment of the invention.

FIG. 15B is a perspective view of a handlebar on which is mounted a rotatable housing RHA for cable actuation, according to an embodiment of the invention.

FIG. 15C is a perspective view of a handlebar on which is mounted a stationary housing RHA for hydraulic actuation, according to an embodiment of the invention.

FIG. 15D is a perspective view of a handlebar on which is mounted a rotatable housing RHA for hydraulic actuation, according to an embodiment of the invention.

FIG. 15E is a full perspective view of a stationary housing RHA for cable actuation illustrating the different sections of the housing.

FIG. 16A is a side view of a two-piece side plate, one-piece side plate, and associated one-piece gasket.

FIG. 16B is an exploded perspective view of a thick inset side plate with a petal-pattern locking flange recess, and an associated locking flange tube with petal-pattern flange for use with an RHA.

FIG. 17A is a rear view of a custom housing of an RHA according to the invention, including a mirror mount, kill switch, and push-button lock assembly.

FIG. 17B is a longitudinal cross-sectional view of a push-button lock assembly and associated cylindrical rack assembly within a custom housing that can be used with embodiments of the invention.

FIG. 18 is a perspective view of a spring-loaded detent and a cylindrical rack assembly having a scored gradation pattern on an inside surface of the cylindrical rack assembly to enable the provision of haptic feedback when actuating the RA.

FIG. 19 is an exploded perspective view of the barrel section of a cable-actuating housing and a cable tension adjuster with slotted centering insert and associated o-ring that can be used in embodiments of the invention.

FIGS. 20A, 20B, and 20C are perspective views of three types of cable spacers that can be used with an RHA according to the invention.

FIG. 21 is a perspective view of a mudguard, and two examples of integrated fasteners.

FIG. 22 is a latitudinal cross-sectional view of the barrel section of an RA for cable actuation, according to an embodiment of the invention, illustrating construction and assembly of parts of an RA for cable actuation that are enclosed within a housing.

FIGS. 23A through 23D are photographs showing perspective views and an open side view of the gear section of a stationary housing RHA for cable actuation, according to an embodiment of the invention, illustrating construction and assembly of the RHA.

FIGS. 24A and 24B are open side views of the gear section of a rotatable housing RA for cable actuation, according to an embodiment of the invention, illustrating rotation of a housing around a locked cylindrical rack assembly during operation of the RA.

FIG. 25 is an exploded perspective view of an internal snap ring and an external snap ring and corresponding grooves that can be used with embodiments of the invention.

FIG. 26 is a latitudinal cross-sectional view of the barrel section of an RA for hydraulic actuation, according to an embodiment of the invention, illustrating construction and assembly of parts of an RA for hydraulic actuation that are enclosed within a housing:

FIGS. 27A and 27B are open side views of the gear section of a rotatable housing RA for hydraulic actuation, according to an embodiment of the invention, illustrating rotation of a housing around a locked cylindrical rack assembly during operation of the RA.

FIG. 28 is a latitudinal cross-sectional view of the barrel section of a B-RA for hydraulic actuation, according to an embodiment of the invention, illustrating construction and assembly of parts of a B-RA for hydraulic actuation that are enclosed within a housing.

FIG. 29 is an exploded perspective view of piston face holes, primary seal, and return spring.

FIGS. 30A and 30B are opposing side views of a secondary arm for cable and rod-actuated rear drum brakes.

FIGS. 31A and 31B are cross-sectional views of a switch valve assembly and a magnetic switch valve assembly, respectively, that can be used with embodiments of the invention.

FIGS. 32A through 32F are simplified cross-sectional views of a switch valve assembly illustrating an actuation sequence of the switch valve assembly.

FIG. 33 is an open side view of the gear section of an X-RA, according to an embodiment of the invention, adapted for mounting on a left handlebar to enable clutch and rear brake actuation.

FIG. 34 is an open side view of the gear section of an X-RA, according to an embodiment of the invention, adapted for mounting on a right handlebar to enable throttle and front brake actuation.

FIG. 35 is a perspective view of an X-RHA hybrid, according to an embodiment of the invention, integrated to enable lever actuation of a brake master cylinder, and clutch actuation via a rotatable housing.

FIG. 36 is a perspective view of a lever, RHA handgrip, and two arrows illustrating the conventional and rotational axes of leverage for the X-RA hybrid lever.

FIG. 37 is an exploded perspective view of a hydraulic lever assembly, pivot clamp parts, and a rotatable housing equipped with a plate lock.

FIG. 38 is a perspective view of horizontal and vertical pivot clamps.

FIG. 39 is a table showing several possible combinations of X-RA Hybrids for Clutch and Rear Brake Control.

FIGS. 40A and 40B are open side views of a first ratcheting mechanism and a second ratcheting mechanism that can be used with embodiments of the invention.

### DETAILED DESCRIPTION OF THE INVENTION

I. Overview

The invention takes advantage of an opportunity in asymmetry: by converting the clutch control from lever-actuation (as is the case with conventional motorcycle control apparatus) to a handlebar-mounted Rotatable Assembly (C-RA), we avail the left hand lever for rear brake actuation. This conversion unifies the usage of levers on the left side and right side of the handlebars for brake control, a change which also unifies the cognitive association of levers with stopping. In addition, this conversion unifies the usage of handlebar-mounted rotatable assemblies on the left side and right side of the handlebars for acceleration, a change which also unifies the cognitive association of handlebar-mounted rotatable assemblies with accelerating.

This alteration provides another significant benefit: levers are extremely susceptible to bending and breaking, even in a mild spill. When the right front brake lever is broken, the rider still has the use of the rear brake to slow the machine. When the left clutch lever is broken, the rider is stuck with no safe way to shift the machine's gears. By changing to a clutch-actuating handlebar-mounted Rotatable Assembly (C-RA), the likelihood of losing actuation of the clutch mechanism is reduced drastically.

The bar-mounted assembly may be implemented with or without an integral rotatable handgrip. Excluding the differences in components required for the operator to interface with the internal mechanism, the remainders of the handgrip-equipped and handgrip-removed devices are virtually identical. But the ergonomic benefits of having the handgrip rotate with the assembly, along with the additional torque provided by fingers rotating the handgrip, will be welcomed for many applications. Consequently, the term Rotatable Handgrip Assembly (RHA) will be used to describe versions of the device which incorporate a handgrip for rotation. The superset term Rotatable Assembly (RA) subsumes the term Rotatable Handgrip Assembly (RHA), and will be used to designate a superclass of the device which offers an array of mechanisms for the operator to interface with the device. The articulated handgrip is but one of those mechanisms. In other words, all RHAs are RAs, but not all RAs are RHAs.

Throughout this document, several terms recur which warrant explanation. Firstly, the terms Rotatable Assembly (or RA) and Rotatable Handgrip Assembly (or RHA) are frequently used to refer to versions of the invention. The relationship between the terms Rotatable Assembly (or RA) and Rotatable Handgrip Assembly (or RHA) is detailed above. These terms or their abbreviations will usually begin with capital letters. Within the Claims and Claims-related sections of this document, the term “rotatable assembly” is used to describe the invention(s) with strict veracity. Elsewhere, the terms (RA and RHA) may appear with prefix letters such as C, B, T, X, and possibly others. These letters generally refer to the particular control or system the Rotatable Assembly is actuating (e.g. Clutch, Brake, Throttle, or combinations thereof). In some instances, the term “rotating” may be substituted for “rotatable”. The term “rotating” is not intended to imply a continuously spinning object (e.g. the earth), but instead may be understood to mean rotatable, or something that is capable of being rotated by hand, or, in other instances, to be interpreted as the gerund of the verb “rotate” (by hand). Other forms of the word “rotate” (such as “rotation” or “rotational”) may appear, and virtually all instances of those forms are intended to imply something that is being rotated by hand, or something that is capable of being rotated by hand (as opposed to continuously spinning). The term “rotary”, as used in the document title “Rotary-To-Linear Actuator” and elsewhere, is intended to categorize the core mechanism(s) of the invention in the spectrum of mechanical apparatus.

Herein, the invention is often particularly described as implemented in a motorcycle, but the invention can apply broadly to other machines and vehicles having handlebars, such as other types of two-wheeled vehicles, all-terrain vehicles (ATVs), etc. Additionally, the terms “rider” and “operator” are each sometimes used to describe a person operating a machine or vehicle of which the invention is part: those terms are used interchangeably.

Within the motorcycle industry, the terms “bar”, “bars”, “handlebar”, and “handlebars” are frequently used interchangeably. The term “handlebars” is the proper name within the motorcycle industry. Generally, the terms imply the circular tube, tubes, or handles which the rider or operator grasps to control the machine, and the terms “left” and “right”, when applied to handlebars, connote the motorcycle rider's left-hand or right-hand side when operating the machine. “Handlebars” is frequently implied to mean a single, long, hollow, one-piece tube, often ⅞″ or 22 mm outside diameter, which extends across the width of a motorcycle, and is clamped to the motorcycle at the midpoint of the tube. The tube usually is formed with a precision bend or bends to best fit the rider's riding position or positions. The tube usually remains hollow and un-altered, with fixtures, clamps, cables, and wiring being fastened to the tube's external surface with removable, reusable hardware. The controls, cables, accessories, and electronics are adapted to enable removal from, and attachment to, the handlebars without altering the composition or structural integrity of the tube itself. Devices intended to protect the lateral ends of the handlebars and/or the rider's hands are sometimes inserted 1 to 2 inches into the tube's ends, but the majority of the tube remains vacant. The simplicity of handlebar design is intended to facilitate handlebar replacement in the event of a crash or spill which deforms the precise bends of the tube. Handlebar replacement is particularly frequent for off-road motorcycles. Handlebars may also be fabricated from two shorter hollow tubes clamped to the motorcycle individually (e.g. for street bikes and road-racing motorcycles), but the general rules of replace-ability, structural integrity, simplicity, and vacancy still apply.

Herein, a conventional handlebar-mounted rotatable handgrip assembly which controls fuel delivery is not referred to as a “throttle.” Instead, the abbreviation t-rha is used for throttle control via a rotatable handgrip assembly. Similarly, the abbreviation C-RA is used for clutch control via a Rotatable Assembly, and the abbreviation C-RHA is used to designate a C-RA assembly which features a rotatable handgrip.

A C-RHA (clutch control) for a motorcycle can be mounted on the left handlebar, which, for a conventional motorcycle, is where a fixed grip is normally found. When initially considering the design and construction of such a device, the designer may be tempted to use the internal mechanism from a straight-pull throttle assembly for the RHA, but the name straight-pull is actually a misnomer, as the cable actually travels around a pulley inside the throttle control housing, making a sharp 90 degree turn on its way to the cable flange of the throttle tube. This turn is not physically significant for the thin and light throttle cable, but for a clutch cable, the forces involved in bending its thickness around a pulley exceed the structural integrity of the straight-pull mechanism. In addition, energy is wasted simply trying to bend a thicker cable around a pulley; thicker cables have larger minimum-bend radii. Consequently, it is more appropriate for the clutch cable pull to use a true straight-pull mechanism, similar to that created by a lever, in order to create a linear path for the cable, just as a lever would. A C-RHA can have an external appearance that vaguely resembles that of a conventional straight-pull t-rha (throttle control); however, the internal construction of the two is very different, as is evident from the description below of a C-RHA according to the invention. Further, unlike a conventional t-rha for a motorcycle, a C-RHA can be constructed so that the resistive spring forces of the clutch are encountered when the C-RHA's grip is rotated forward, that is, over and toward the front of the motorcycle. The C-RHA can be constructed so that such forward rotation disengages the clutch and slows the motorcycle. Since forward rotation of a t-rha as conventionally implemented on a motorcycle closes the throttle, also slowing the motorcycle, construction of a C-RHA in this manner can advantageously achieve a cognitive symmetry in the control interface: rearward rotation produces acceleration and forward rotation produces deceleration. However, while construction of a C-RHA in this manner can be advantageous for the reason given above, the invention can alternatively be implemented so that rearward rotation of the C-RHA disengages the clutch and slows the motorcycle. Construction of a C-RHA so that forward rotation disengages the clutch can have an additional benefit: when the rider is not actuating the C-RHA, the C-RHA grip exhibits the secure, fixed, non-rotating feel of a permanent, non-articulated handgrip due to the C-RHA housing's internal stop block. This secure impression is due to the fact that when a rider is positioned behind the controls, the rider naturally tends to pull lightly backwards and downwards on the handlebars. The t-rha's (throttle control's) rearward rotation does not provide this secure feel.

As mentioned previously, the device can be manufactured for rearward rotation with minimal internal changes. Some riders may have preferences or physical limitations which require rearward rotation.

Beyond forward-only and rearward-only actuation, it may also be desirable to use an internal hydraulic switch mechanism described later to enable both forward and rearward actuation of a hydraulic system.

While the motorcycle control paradigm described above (i.e., rotational input to produce acceleration and lever actuation to produce braking) provides a desirable and consistent interface to a rider, there may be situations in which a different control paradigm is deemed appropriate. For example, a rider may want to use an RA (Rotatable Assembly) for brake actuation. A brake-actuating Rotatable Assembly (B-RA) can be easily derived from a C-RA by appropriately modifying the C-RA: modifications that can be made to produce such structure are described in more detail below.

Multiple actuators (i.e., a B-RA, C-RA, and/or T-RA) can be combined in a single Rotatable Assembly. Such a multi-actuator Rotatable Assembly is generally categorized herein as an X-RA (where X represents some combination of C, B, T, or others). Some examples of such a multi-actuator Rotatable Assembly are described below in the section entitled “X-RAs: The Rotatable Assembly as a Compound Actuator,” such as, for instance, a combined clutch-actuating/brake-actuating Rotatable Assembly, and a combined throttle-actuating/brake-actuating Rotatable Assembly.

An additional class of X-RAs, the X-RA Hybrids, incorporates conventional lever-actuated mechanisms (the X and Hybrid designation represents some combination of C, B, T, and other controls such as levers). Some examples of such a hybrid multi-actuator Rotatable Assembly are described below in the section entitled “X-RA Hybrids”, such as, for instance, a combination of a conventional lever-operated brake master cylinder with a C-RA in a custom rotatable housing. These X-RA Hybrids can be designed to completely replace the stock lever controls, or work with them by mounting the stock lever controls to a pivot clamp component (described below) which uses the radial length of a stock lever and perch to provide additional leverage and torque for rotating actuation. Other devices for increasing leverage and torque for the RAs are also described below.

An alternative class of rotatable assemblies includes the integration of ratcheting assemblies with the RAs, so that the RA devices may be used for directional drive applications, such as, for example, a winch, or socket wrench, or other tensioning tools.

II. The Biomechanics of The Hand, Wrist, Forearm

In order to fully appreciate the advantageous characteristics of a Rotatable Assembly according to the invention, it is useful to review some of the capabilities and limitations of the human arm. A conventional handlebar-mounted lever-actuated control (e.g., conventional lever-actuated clutch or brake control for a motorcycle) is operated by the flexion of one or more fingers, while the thumb and remaining fingers grip the handlebar. One finger can be used to pull the lever if that finger is strong enough, or as many as four fingers may contribute to the pull. However, each finger which leaves the handlebar to pull the lever results in a weaker hold by the rider on the handlebar. As demands on (e.g., the strength of) a rider's forearm muscles increase (e.g., because the terrain roughens), his weak grip can become a liability.

The C-RHA can be rotated with a constant five-fingered grip. The rotatable RHA handgrip is operated by flexing and extending the wrist joint, often in concert with some forearm movement over the top of the handlebar to provide extra range of motion and extra leverage. While the C-RHA can easily be manufactured to operate with a rearward rotation (top surface of grip moving towards the rear of the vehicle), or with a forward rotation (top surface of grip moving towards the front of the vehicle), or, in some cases, both forward and rearward rotation, it is the forward rotation which helps create the cognitive symmetry of the control with the existing t-rha (throttle) paradigm: forward rotation for deceleration when stopping, rearward rotation for acceleration and speed. With a significant portion of the population facing the challenges of dyslexia and “sided-ness” issues, favoring physical and cognitive symmetry for controls is a significant improvement.

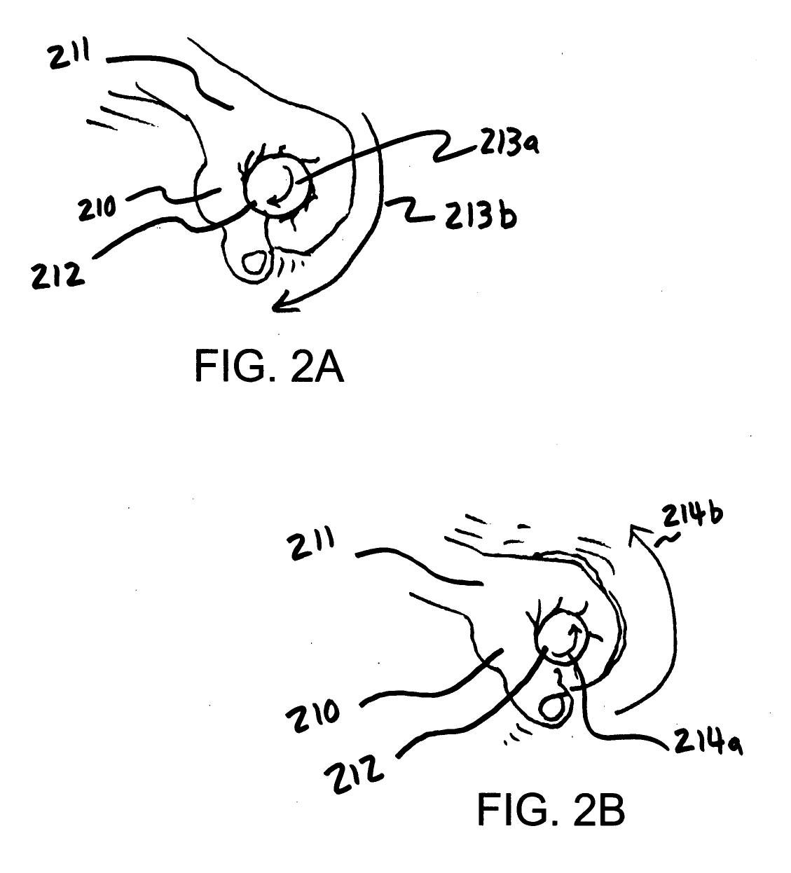

As shown in FIG. 2A, forward rotation (indicated by the clockwise rotational arrows 213a and 213b) results from muscular flexion of a left hand 210 and wrist 211 on a rotatable bar 212. As shown in FIG. 2B, rearward rotation (indicated by the counterclockwise rotational arrows 214a and 214b) results from muscular extension of the left hand 210 and wrist 211 on the rotatable bar 212. Both flexion and extension of the hand and wrist may be aided with a “leveraging” forearm movement over the rotatable bar to provide extra range of motion and extra leverage.

For proper operation of the Rotatable Assembly, it can be desirable that the Rotatable Assembly be constructed in view of the average maximum range of rotation (flexion or extension) of a rider's wrist. While an extremely agile hand/wrist may rotate the grip as much as 100 degrees (about one quarter revolution of the grip/tube around the handlebar), a more practical maximum average is around 75 degrees (about one fifth of a revolution of the grip/tube around the handlebar). Some riders may prefer an even shorter rotation, as little as 30 to 40 degrees, which can be achieved in various configurations. Consideration of these parameters can be important in the implementation of the C-RHA.

The hand/wrist/forearm of a rider operates the C-RHA similarly to the t-rha (throttle control). However, in the embodiment of the C-RHA described above, the rider encounters resistance in the form of clutch spring forces as he rotates the grip forward, whereas in the t-rha, the rider encounters resistance in the form of throttle spring forces as he rotates the grip rearward. This is due to the different internal spring mechanisms of the carburetor versus the clutch. This is fortunate since the resistive spring forces for clutch actuation are typically greater than those for throttle actuation. The fortune lies in the fact that when the elbows are raised, such as is recommended for the proper “elbows-up-and-out” off-road riding position, the flexion musculature of the forearm typically becomes stronger than the extension musculature of the forearm due to the relative angular positioning of the forearm to the wrist. Consequently, the extra resistance encountered by the rider through the C-RHA is matched by a stronger set of muscles. This feature of the anatomy of the human arm, combined with the upright seating configuration of the off-road motorcycle and frequent use of the standing position by the off-road rider, makes forward actuation both practical and desirable.

An additional advantage to the C-RHA's forward rotation surfaces when actuating the control is considered in relation to actuating the t-rha simultaneously. With conventional controls, the left grip remains anchored at all times. For most motorcycles, it is literally glued to the handlebar. Consequently, the rider can operate the t-rha with his right hand while anchoring his upper body through the left hand's grasp on the left handlebar's grip. When an articulated Rotatable Handgrip Assembly is substituted for the conventional fixed left grip, the equation changes. While a rearward-actuating design seems logical at first, the logic fades as each of the controls is considered in relation to the other. Having two rearwardly-actuated rotatable handgrip controls, one on the right and one on the left, will create a rearward longitudinal torque on the motorcycle when the two controls are actuated together. This may upset the rider's control of the machine. In addition, the parallel rearward actuation may create a loose, disconnected sensation in the arms of the rider, further diminishing his sense of control.

With simultaneous forward rotation of the C-RHA and rearward rotation of the t-rha, any longitudinal torque created by the rider's hand and wrist forces on the handgrips is largely neutralized through counter-rotation. The result is a static balance of forces. Furthermore, the stop block component of the C-RHA restores the “fixed” sensation of a non-articulated left grip when the rider is not actuating the C-RHA. When any rearward torque is applied, the RHA handgrip will not move.

As mentioned previously, the device can be manufactured for rearward actuation with minimal internal changes. Some riders may have preferences or physical limitations which require rearward rotation. Also, some riders may prefer the convention of rearward-rotating handgrips over the cognitive symmetry of rearward actuation for acceleration.

Beyond forward-only and rearward-only actuation, it may also be desirable to use an internal hydraulic switch mechanism described later to enable both forward and rearward actuation of a hydraulic system.

As the forces required to actuate clutch and brake systems increase, it may be desirable to provide the rider with devices to increase his leverage and torque. These devices can offset the extended travel which would be required to actuate the control given nothing but a standard RHA grip & tube rotated with a constant muscle force.

Leverage devices for the rotatable RHA tube are detailed in the tube lever section below. Leverage devices for the rotatable housing and RHA grip are detailed in the accessories section below.

The final biomechanical issue to examine is grip strength (a.k.a grasp force). While the conventions for grip and tube size have already been defined by the motorcycle industry, their impact on finger strength for lever actuation needs to be examined more carefully. According to research done by Li and O'Driscoll, finger strength diminishes drastically as the wrist and thumb deviate from their respective optimal grip positions. For the wrist, the optimal position to achieve maximum finger contraction force is around 25 degrees of extension. The thumb's corresponding position should be around 5 degrees of ulnar deviation. Fortunately, this corresponds very closely to the wrist and thumb positions which result from grasping the standard motorcycle grip. However, as either wrist or thumb is forced out of its optimal position, finger flexion weakens markedly.

This trait of the human hand and forearm is consistent for both men and women with almost no differences. It becomes especially important when the Rotatable Handgrip Assembly is partnered with a conventional lever control on the left handlebar. Since the wrist and fingers are going to be rotating around the bar regularly, actuating a stationary lever with those fingers below maximum finger strength presents a problem. A stationary lever will only be pulled with maximum finger strength at one point in the rotating range of the RHA. As the grip is turned and one or more fingers attempt to pull the lever, the weakness surfaces. This irregularity is non-optimal and unacceptable from a design standpoint.

However, if the lever were to rotate with the RHA handgrip, an ideal wrist and thumb relationship would be maintained, and finger strength would not vary as the hand rotated around the bar with the RHA handgrip and lever. Furthermore, this presents the rider with an opportunity to utilize a conventional lever for two different forms of leverage: the conventional finger pull on the lever, and the unconventional finger press down on the lever in order to apply more rotating force (torque) through an RHA with a rotatable housing (see FIG. 36).

The result is dual-axis leverage with a conventional lever, where the radial length of the lever out from the center of the bar and perch provides anywhere from a 1.5× to 2× increase in torque on the RHA with a rotatable housing. Deriving the range and amount of this increase is non-obvious. With the index and middle fingers pressing down on the top of the lever while the thumb and smaller fingers remain gripping and twisting the RHA, a straddled application of force results where the median torque represents a weighted combination of the two forces (the lever press and the RHA grip twist). The weighting is a function of the unequal amount of force each finger contributes to the total torque.

Measurements were derived with the use of a torque jig. A torque wrench calibrated in inch pounds was mounted vertically with proper geometry into a wooden base. The ratcheting axis of the torque wrench was mounted to a short section of ⅞″ handlebar with a fixed left grip and left hand lever and perch mounted at typical spacing. Measurements were taken with fingers and torque applied to the grip only, then with index and middle fingers pressing down on the top of the lever while the remaining fingers simultaneously grasped and twisted the grip fixed on the handlebar. The results are detailed above, but the increase in torque with the addition of the lever force is undeniable as the torque setting on the wrench increases. For example, one tester achieved a maximum grip-only torque of 70 to 85 inch pounds, but jumped to 130 to 145 inch pounds maximum with the addition of the use of the lever.

The dual-axis leverage design makes short-throw RHA rotation ranges of 3° to 40 degrees feasible, even for heavier clutch springs and brakes.

III. Overview of RAs

A. General Description of Some Embodiments of the Invention

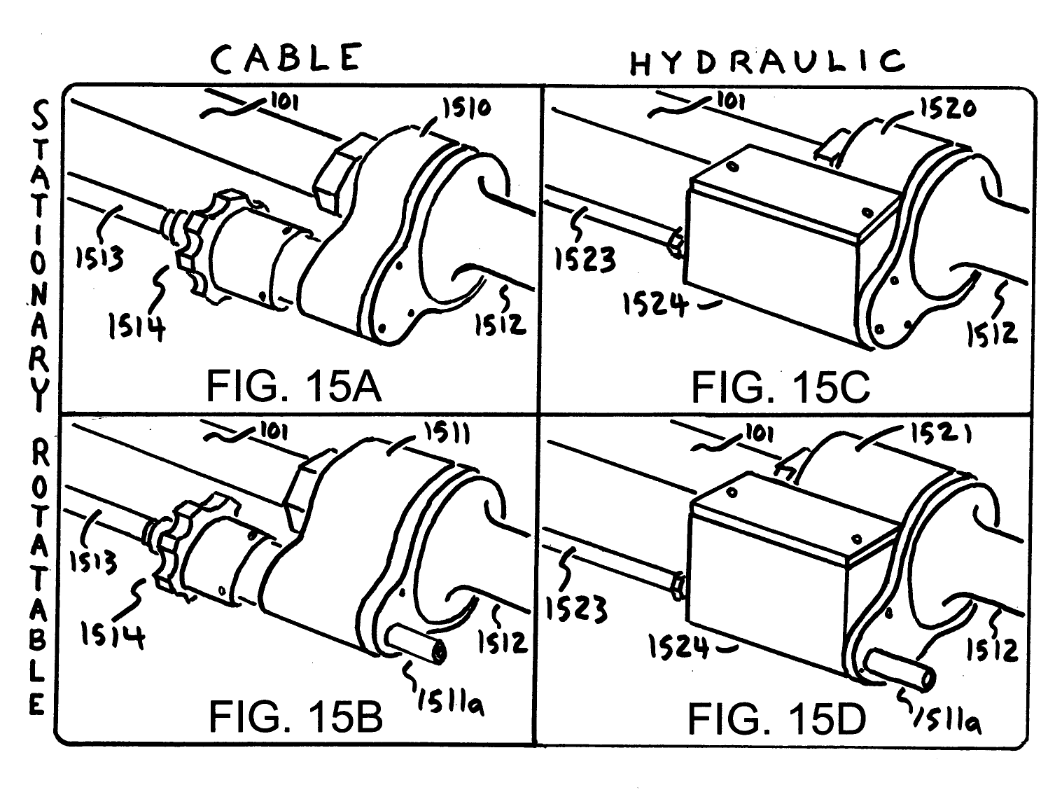

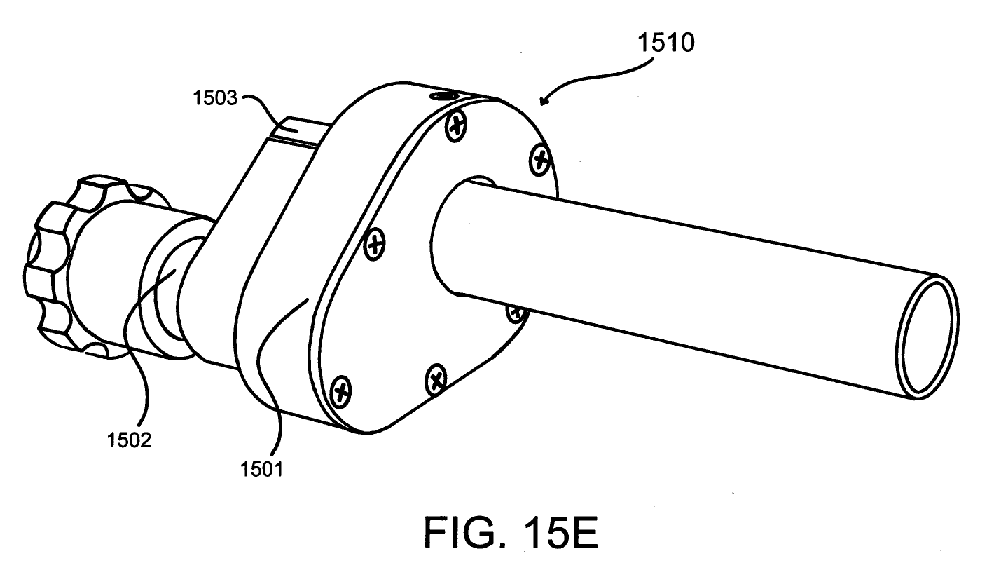

In general, an RA in accordance with the invention converts a rotational control input from an operator (e.g., a rider, such as a rider of, for example, a motorcycle or other two-wheeled vehicle, or an all-terrain vehicle) of a vehicle of which the RA is part to a translational output that can be used to actuate a controlled assembly (such as, for example, a clutch assembly or a brake assembly, embodiments of both of which are described in more detail below) which can be actuated in any appropriate manner (such as, for example, by cable-actuation or hydraulic actuation, embodiments of both of which are described in more detail below). The rotational control input can be applied to, for example, a rotatably-mounted handgrip of a handlebar of the vehicle. This can be accomplished, for example, by attaching a grip in a fixed position on a tube which can be rotated in its mount on the handlebar. In response to the rotational control input, a rack assembly is rotated to produce corresponding rotation of a mating pinion gear, or the pinion gear is rotated around a rack assembly to produce rotation of the pinion gear. Rotation of the pinion gear results in rotation of a screw which, in turn, produces translational movement of a coupler or piston into which the screw is threaded. The translational movement of the coupler or piston produces cable actuation or hydraulic actuation of the controlled assembly. Particular embodiments of the invention in accordance with the foregoing description are discussed in more detail below (e.g., FIGS. 15A through 15D, discussed below, are perspective views of the exterior of RAs according to embodiments of the invention that are constructed and operate in accordance with the foregoing description). However, those skilled in the art can appreciate that the invention can be implemented using apparatus other than the particular apparatus of those embodiments and, moreover, can be implemented in a manner other than the general approach described above, in accordance with the principles of the invention.

B. Hand-Actuated Control Apparatus Components

The following describes aspects of components that can be used in the implementation of hand-actuated control apparatus in accordance with the invention. In particular, most of the discussion concerns components that can be used in implementing rotatable-handgrip-actuated control apparatus, such as an RHA (Rotatable Handgrip Assembly) in accordance with the invention.

1. Conventional Throttle Tube Flanges: the Cable Flange and the Stop Flange

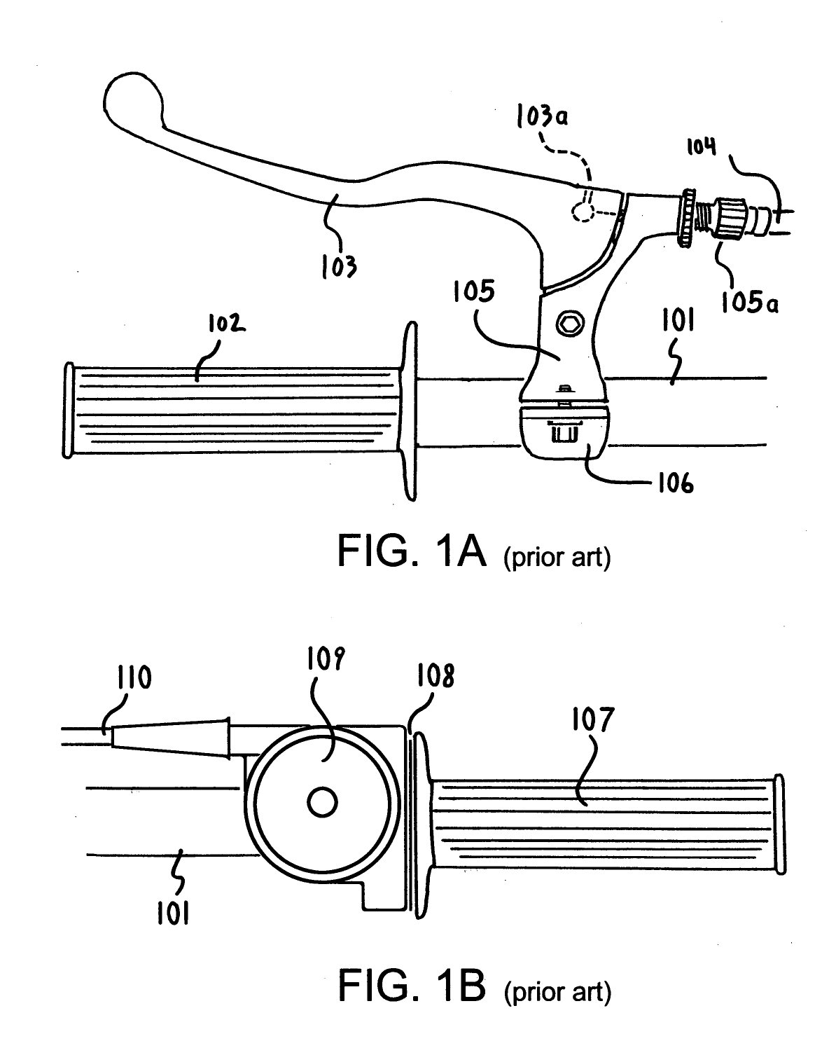

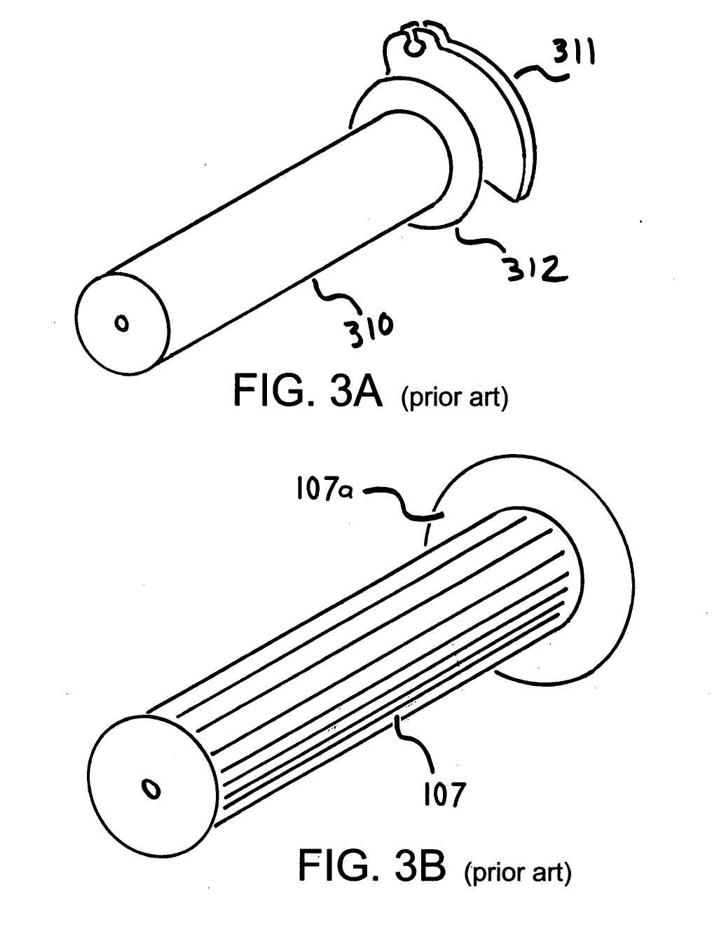

To provide context for the description of tube flanges that can be used with an RHA according to the invention, conventional motorcycle throttle flanges are described. There are two types of flanges commonly found on modern motorcycle throttle control tubes: the cable flange and the stop flange. The most significant of the two is the cable flange, since the cable flange acts as a guide and anchor for the throttle cable. The cable flange is a sheaved flange that is covered by the throttle control housing (see FIG. 1B) and usually only forms part of a circle (often an arc quadrant) instead of extending to form an entire radial rim. FIG. 3A is a perspective view of a conventional throttle control tube 310 on which is formed a cable flange 311 and a stop flange 312. In modern straight-pull throttle control housings, the throttle cable makes a 90 degree turn inside the housing to align with the center channel and anchor point of the cable flange. This turn can be formed into the housing itself, but, preferably, the cable will be curved around an internal routing pulley which rotates as the throttle is opened and closed.

The stop flange 312 is less common. The stop flange is positioned outside of the throttle control housing and is plainly visible. The stop flange forms an entire ring or rim which is similar to the grip flange found on one end of most grips. The stop flange acts as a stop for the grip flange as the grip slides onto the tube during assembly. FIG. 3B is a perspective view of a conventional right-hand throttle grip 107, including a grip flange 107a. The stop flange prevents the sticky rubber grip flange from contacting the throttle control housing during operation (otherwise the rubber grip flange would rub on the housing and prevent the throttle control tube from turning freely). The stop flange is molded with the tube and the plastic (often nylon) of the stop flange rotates smoothly even when contacting the throttle control housing. Unfortunately, the stop flange can make the throttle control housing/tube/cable assembly process more difficult; this may be why the stop flange is becoming less common. The stop flange also makes the plastic molding process more difficult since the stop flange is a second extrusion of the tube and therefore may not form correctly, thus cutting down on production yields.

As indicated above, the stop flange may be fading out of modern motorcycle designs and could be replaced by a plastic grip washer. A grip washer is basically the same shape as a stop flange, but is assembled separately as either a one piece washer which slips onto the throttle control tube before the grip, or a split-ring washer which can be positioned around the tube after assembly of the grip onto the tube. Unlike a stop flange, a grip washer cannot prevent a grip from sliding too far onto a tube, but a grip washer can reduce friction between a grip flange and a throttle control housing that would otherwise occur if the grip washer were not present, thus keeping the throttle control tube rotating smoothly (see 108 of FIG. 1B). Most grip washers are also easy to bend out of the way or remove, as necessary or desirable, during assembly, thus facilitating assembly.

Below, the description of RHAs in accordance with the invention is generally made with respect to tubes including a stop flange, or around which a grip washer is positioned.

2. The RHA Handgrip: The Grip and Tube

Fundamentally, the RHA handgrip, as defined and used in this document, is composed of two parts: the grip itself (usually made of thermoplastic elastomers, synthetic rubbers, or rubber-like compounds), which provides comfort and traction for the fingers, and the underlying skeletal tube (often made of plastic, such as nylon or Delrin, but also made of carbon-fiber composites, or of aluminum, typically 6061 grade) which provides structure for the grip and facilitates the smooth rotation of the grip around the metal handlebar over which the tube fits. (Examples of materials that can be used for a grip and a tube, applicable to any embodiment of the invention, are described in more detail below.) The tube fits inside of the grip (and can be held in place by glue and/or friction between the two) and the result is a comfortable, tractive, cylindrical RHA handgrip component. This tube and grip component can be closed at the lateral end, opposite that which fits over the handlebar, or can be open-ended to allow for other equipment to mount within the outer end of the metal handlebar (bar-ends or handguard fasteners, for example). In general, any embodiment of the invention can be constructed to include, or be compatible with, a closed-end or open-end RHA grip/tube assembly.

It may be desirable to supplement the strength of a rider's forearm for grip rotation by providing additional leverage to the rider in the form of modified RHA handgrip components. This can be done by increasing the diameters of the outer tube surface and grip so that more torque is created when the handgrip is rotated. However, while effective at creating more torque, this may weaken the rider's grasp by forcing the fingers and thumb further apart. According to a study by the United Kingdom Department of Trade and Industry (“Strength Data For Consumer Safety”, United Kingdom Department of Trade and Industry), good thumbtip/fingertip contact may help create the perception of a “strong grip” for most humans. Further, their research suggests that as the diameter of a grip exceeds approximately 40 mm, contact between the average thumb and fingers begins to be lost, creating at least the perception—and, perhaps, the reality—of a weaker grasp. Thus, increasing the diameters of the outer tube surface and grip beyond a certain point may be counterproductive and undesirable.

By extending only the leading edges of the RHA grip and tube, a rotatable lever can be created which provides the hand and forearm additional leverage and increased ability to produce torque when rotating the RHA handgrip. In other words, the radius of the grip/tube cylinder is “extruded” over a relatively small area rather than around the entire handlebar. In general, such modified grips and tubes are constructed to provide a leading edge extension which provides leverage at the most effective point for gaining mechanical advantage. The rest of the RHA handgrip component is left unchanged: this can advantageously provide the rider with a familiar ergonomic surface over most of the grip while still providing the desired increased leverage.

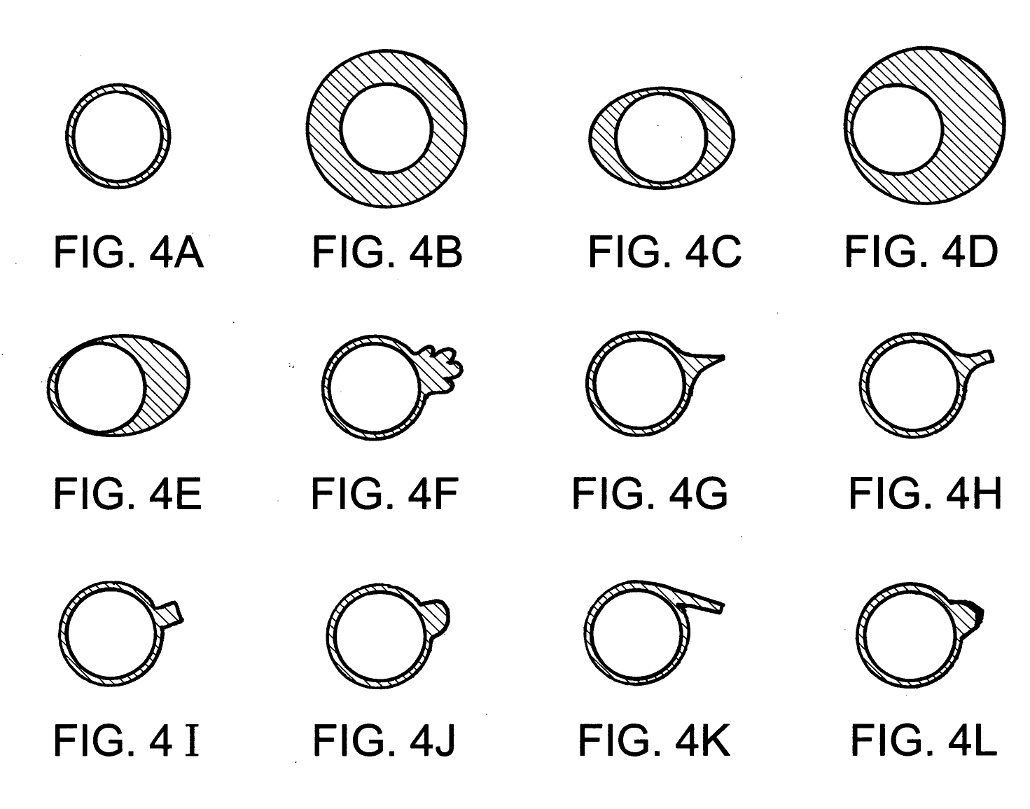

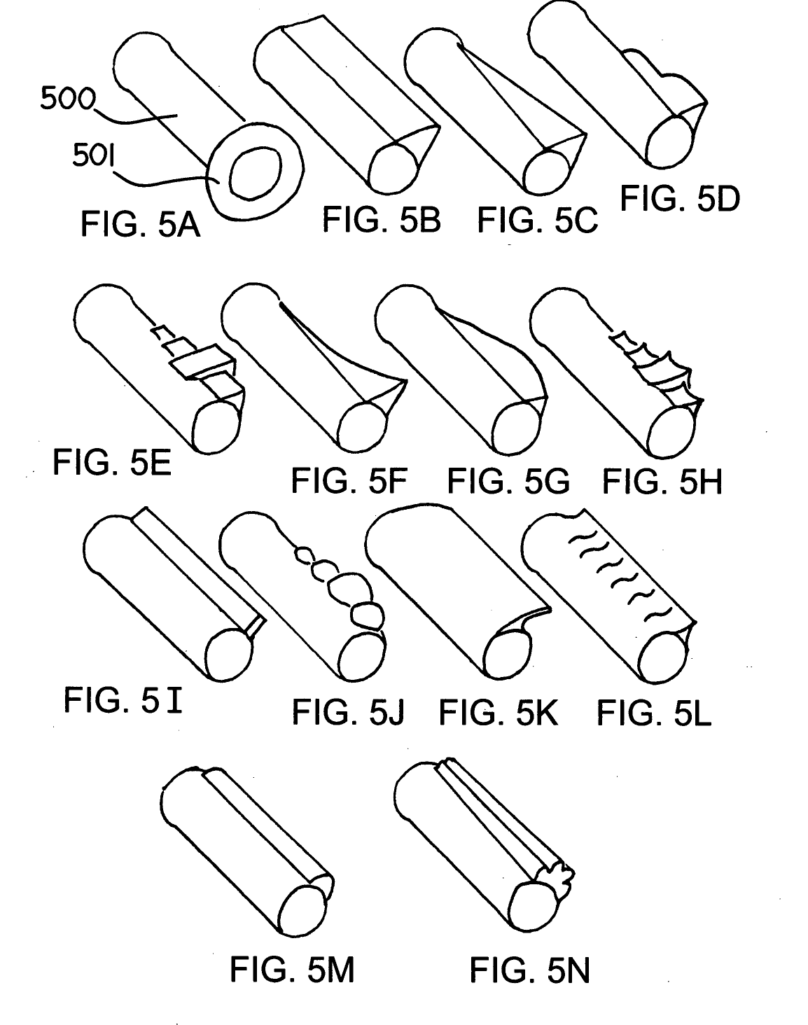

These extensions can be manifested in any of a variety of ways. FIGS. 4A through 4L are each a cross-sectional view of an RHA tube, illustrating a variety of tube shapes that can be used with embodiments of the invention. FIG. 4A illustrates a cross-section of a circular left-hand RHA tube. FIGS. 4B through 4L illustrate cross-sections of modified RHA tubes having non-circular shapes. Similarly, FIGS. 5A through 5N are each a perspective view of a left-hand RHA grip (501 indicates that all RHA grips shown but FIG. 5A have had the grip flange removed to increase the clarity of the view of the RHA grip for illustrative purposes) that can be used with embodiments of the invention. FIG. 5A illustrates a circular RHA grip 500. FIGS. 5B through 5N illustrate modified RHA grips having a shape other than that of a conventional circular grip. The modified grips enable a hand to apply increased torque when rotating the grip and the tube on which the grip is fixed. (In FIGS. 4A through 4L, and 5A through 5N, forward rotation is clockwise. In FIGS. 5A through 5N, the lateral end of the grip is toward the top.)

The shapes of the cores (hollow interior regions) of the RHA grips may be molded to match the tube cross-sections shown in FIGS. 4A-4L (circular core RHA grips are shown in FIGS. 5A-5N). The shape of the core of the RHA grip chosen is matched with its corresponding RHA tube profile. In FIGS. 5A-5N, a circular core profile is shown, but mounting a non-circular-core RHA grip to its corresponding non-circular RHA tube may provide a more secure RHA grip to RHA tube connection with less chance of slippage occurring when strong twisting forces are applied by the rider's hand.

As can be seen, several characteristics occur consistently in the modified RHA grips and tubes. The cross section of most of the extensions can be described as a wedge shape, with the wide section of the wedge proximate to the tube, and the narrow section or pointed end distal from the tube. The cross section can range from a narrow fin to a round bubble. Many of the extensions in FIGS. 5B through 5N are shaped so that the extension fits nicely within the curled fingers of a gripping hand. The profile of many of the extensions in FIGS. 5B through 5N tends to taper inwardly towards the handlebar as the extension proceeds toward the lateral end of the grip. In general, the largest increase to grip (and, if applicable, tube) radius tends to occur beneath the rider's index and middle fingers where the leverage for downforce is greatest and where the thumb can help maintain a good grip. A rider's comfort preferences can determine which manifestation is best for the rider. In fact, some riders may prefer to stick to a traditional circular handgrip shape and forego the leading edge extensions altogether due simply to the preference for, and availability of, traditional round grips.

3. RHA Tube Flanges: The Stop Flange, Grip Washers, the Rack Flange, and the Locking Flange

As indicated above, the description of RHAs in accordance with the invention is generally made with respect to tubes including a stop flange, or around which a grip washer is positioned. A stop flange is useful for guaranteeing that a grip will not slide too far onto the RHA tube and interfere with rotation by rubbing on the RHA housing. A grip washer (or washers) can also be used to ensure that friction between the grip and the RHA housing will not interfere with rotation.

A rack flange can be used in an RHA according to the invention to mesh with and drive a pinion gear. A rack flange can be viewed as a modified version of a throttle tube's cable flange. A rack flange is a flange with gear teeth formed around a part of the periphery of the flange, e.g., gear teeth formed around a quarter of the periphery of the flange. Where the cable flange pulls a cable to actuate the throttle, the rack flange utilizes gear teeth to turn the pinion gear. When a rack flange is used in an RHA according to the invention, several steps can be taken to ensure satisfactory actuation. First, the tube must be made from materials strong enough to serve as gear teeth. Typically, this means metals such as aluminum or stainless steel. Second, the bore of the tube should be formed so as to accommodate all of the diameter variations among handlebar manufacturers. This can be accomplished by making the tube bore large enough to fit the largest typical diameter, and then taking steps to reduce gaps when trying to fit smaller diameters. For example, cylindrical bushing-like shims used at each end of the tube bore can improve a sloppy fit. The fit of the handlebar in the tube can be important since a poor fit may allow movement of the tube on the handlebar, which may cause the rack flange's teeth to not engage the pinion smoothly.

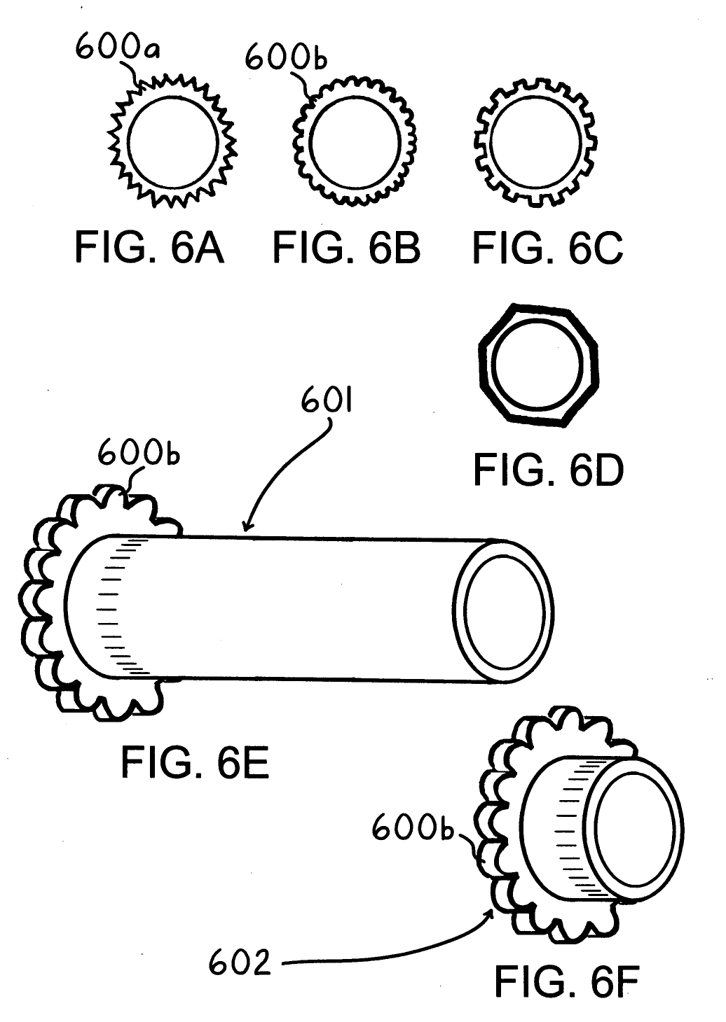

A locking flange and rack wheel (or thick inset side plate) can be used instead of a rack-flanged tube in implementing an RHA according to the invention. The locking flange enables the tube to lock into the rack wheel to transmit handgrip rotation to rotation of the rack wheel (and, consequently, actuation of the rest of an RHA, according to the invention, and the apparatus which the RHA is used to actuate), while remaining easy to disassemble or re-position. The use of a locking flange and rack wheel can provide good performance (e.g., by avoiding the potential problem with a rack flange discussed above), and the description herein of an RHA according to the invention is generally made with respect to use of a locking flange with a corresponding rack wheel (or thick inset side plate, described below). A locking flange can be constructed so that the perimeter of the locking flange has a regular pattern (some examples of which are illustrated in FIGS. 6A through 6D) which interlocks with a corresponding pattern inside the rack wheel. For example, a locking flange can be formed with a perimeter having a pattern of regularly spaced gear-like teeth (as illustrated in FIG. 6A), small petal shapes resembling hemispheric fingers (as illustrated in FIG. 6B), or square teeth (as illustrated in FIG. 6C). Or, for example, a locking flange can be formed with a perimeter having any number of flat sides of equal length, e.g., a pentagonal, hexagonal, or octagonal shape (illustrated in FIG. 6D). A locking flange having a high “resolution” pattern (larger numbers of regular shapes along the perimeter) provides a high degree of rotational positionability of the tube (In FIG. 6E, one example of a locking flange 600b is shown on tube 601) relative to the rack wheel and housing, which may be desirable for grip/tube embodiments featuring an extended leading edge, since different hands will undoubtedly prefer slightly different positions for the leading edge (different positions can be achieved by rotating the locking flange into different relative positions with respect to the rack wheel).

4. RHA Tube Options: The Tube Levers and the Thumb Paddle

As described above, leading edge extensions on the RHA grip (and, perhaps, the RHA tube) may provide extra leverage when the rider rotates the RHA grip. However, some riders may prefer to stick to a traditional handgrip shape and forego the leading edge extensions altogether. For these riders, there are other options for creating increased torque for a given rotation of the RHA handgrip.

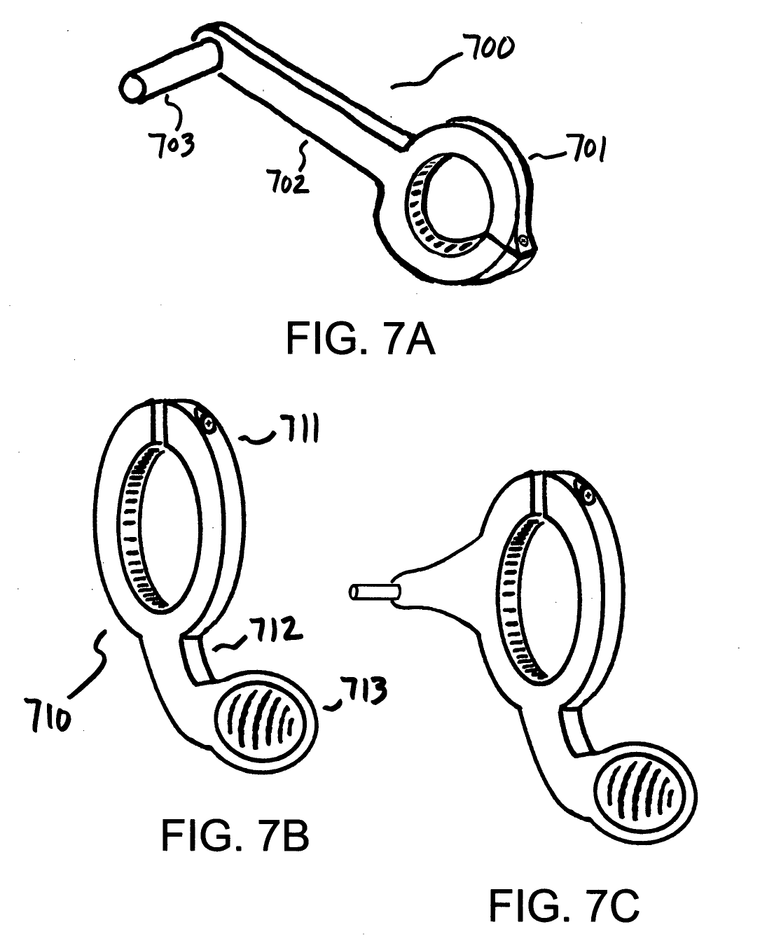

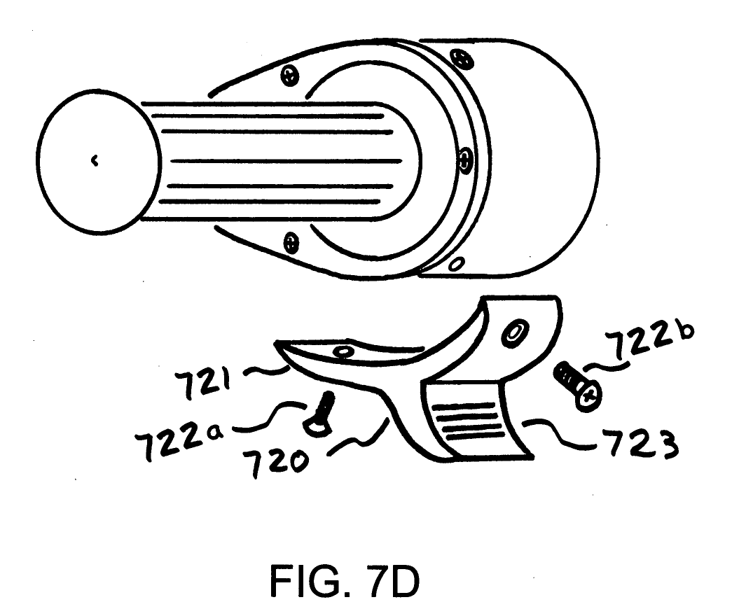

FIG. 7A is a perspective view of a forward-rotating tube lever 700. The tube lever 700 is an accessory that can be locked onto a tube in any appropriate manner. The clamp 701 of the tube lever 700 encircles the tube (see 601 of FIG. 6E) and is locked into place on the tube with an appropriate fastening mechanism, such as one or more pinch bolts. Additionally, an exterior section of the tube and the interior of the clamp 701 can be molded or machined with light scoring or matching spline teeth or other interlocking shapes such as hexagonal or octagonal sides. Light scoring is shown in FIGS. 6E, 6F, 7A, 7B, and 7C. For certain tube designs, a tube lever requires a split two-piece clamp design with semi-circular clamp components. For example, a tube lever with a two-piece clamp can be locked onto the section of the tube between a locking flange and a stop flange for tubes that have both flanges. The clamp 701 of the tube lever 700 may be flanked on the right with either a grip washer or a stop flange to prevent the clamp 701 from rubbing on the housing.

An extension section 702 of the tube lever 700 protrudes from the clamp 701 of the tube lever 700. The tube lever 700 can be positioned on the tube so that the extension section 702 protrudes forward in the same direction that leading edge extensions of the RHA handgrip would. An appendage 703 (tube lever activator) intersects the extension section 702 at the end of the extension section 702 opposite the clamp 701 of the tube lever 700. The appendage 703 is generally parallel with the tube when the tube lever 700 is positioned on the tube and provides a place for the index and middle fingers of a rider to push during rotation of the RHA handgrip. The appendage 703 can be attached to the extension section 702 with a hinge and spring, in a manner similar to a folding shift lever, to prevent bending and breaking of the appendage 703 as a result of unintended impact (e.g., such as may occur during a crash).

The extension section 702 can be made long enough to provide more leverage than the RHA grip/tube extensions discussed above. The extension section 702 can also be made short enough so that the extension section 702 does not interfere with a control lever being pulled toward the handlebar. The location of the extension section 702 near the RHA housing can also ensure that such interference does not occur, since such location will typically be nearer the hinged part of the lever than the free end of the lever, the former undergoing less travel during actuation of the lever than the latter. When a rider requires extra leverage for rotating the grip, the index finger and/or middle fingers can be extended to the top of the appendage 703 and force the appendage 703 downward, thereby imparting rotation to the tube lever 700 and, thus, the tube.

The forward-rotating tube lever is adapted to enhance leverage for forward rotation of the handgrip. To enhance leverage for rearward rotation of the handgrip, a rearward-rotating tube lever can be mounted on the tube. FIG. 7B is a perspective view of a rearward-rotating tube lever 710 that can be used with an RHA according to the invention. The rearward-rotating tube lever 710 shown in FIG. 7B has a construction and operates in a manner similar to that of the forward-rotating tube lever 700. The rearward-rotating tube lever 710 includes a clamp 711, an extension section 712 and a thumb rest 713. A hole in the clamp 711 enables the rearward-rotating tube lever 710 to be mounted on the tube: the mounting can be done in the same manner as described above for mounting the forward-rotating tube lever 700 on the tube. The rearward-rotating tube lever 710 can be used with RHAs having a stationary housing.

For RHAs which feature both forward and rearward actuation (described below), a forward-rotating tube lever design, such as FIG. 7A, can be merged with a rearward-rotating design, such as FIG. 7B, to form a single tube lever, shown in FIG. 7C, having appendages for finger (forward) and thumb (rearward) actuation.

The thumb paddle 720 of FIG. 7D can be used with RHAs having a rearward-rotating housing. The thumb paddle 720 of FIG. 7D includes a base 721 that is attached to the rotatable housing with screws 722a and 722b. A thumb rest 723 is provided on the base 721. For both devices 710 and 720, the rider pushes down and forward with the thumb on the thumb rest while twisting the RHA handgrip to produce additional leverage in effecting rearward rotation of the tube, or tube and housing, respectively.

Finally, the forward-and-rearward-rotating tube levers, the thumb paddle, and a finger paddle appendage described below can all be used with RAs which do not feature any form of articulated handgrip or tube.

Instead of a locking flange tube, stationary housing RAs may incorporate a scored locking flange collar, shown in FIG. 6F, which extends out of the RA housing just far enough to provide a tube lever a scored surface to clamp onto. The scored collar 602 includes a locking flange 600b. Friction between the grip (fixed directly to the handlebar) and the rotatable collar/tube lever is prevented with a grip washer.

Rotatable housing RAs which do not feature any form of articulated handgrip or tube will be outfitted with a thumb paddle and/or a finger paddle in order to provide surfaces for the fingers to press on. Just as with the tube levers, friction with the fixed grip is prevented with a grip washer.

5. Cylindrical Rack Assemblies: The Rack Wheel and the Rack Hub

Embodiments of an RA according to the invention can make use of a cylindrical rack assembly, such as a rack wheel or rack hub, described in more detail below, to transmit the rotational control input imparted to the RHA handgrip, tube levers, or appendages to mechanisms that convert the rotational motion to translational motion. The term “cylindrical rack assembly” includes both the rack wheel and the rack hub. The terms “rack wheel” and “rack hub” have been used because those apparatus combine the rack from “rack and pinion” with a rotating wheel or stationary hub. A rack wheel or rack hub is differentiated from a full toothed gear since the rack wheel or rack hub only has teeth along a short section of its perimeter. While these partial-perimeter gears are commonly referred to as sector gears in industry, the other features of the cylindrical rack assembly, described below, warrant a differentiating name.

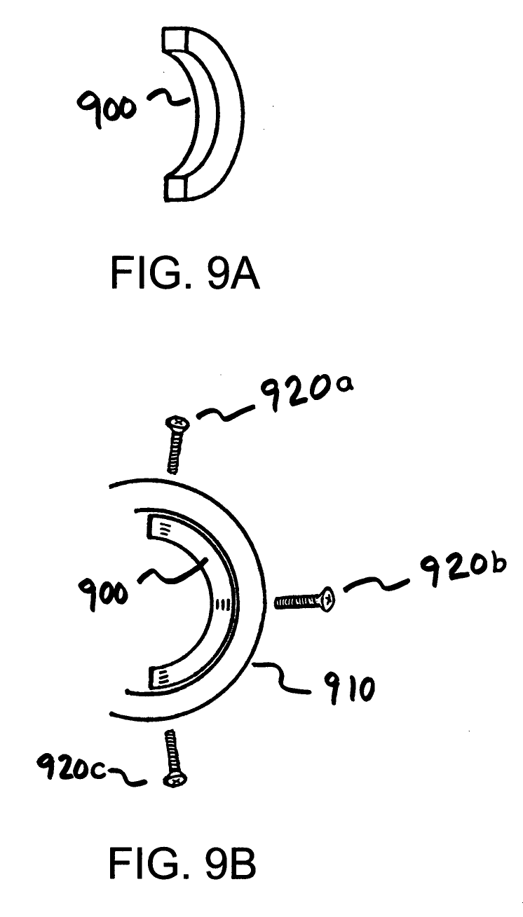

It is anticipated that the rack (gear teeth) of a cylindrical rack assembly (e.g., rack wheel or rack hub) will likely occupy about a quarter of a circle (e.g., about 90-100 degrees) maximum since that corresponds directly to the average maximum flexion/extension range of the human wrist. The flat ends of the rack serve as stops which limit the rotating range of the cylindrical rack assembly as the flat ends of the rack contact a stop block in the housing. FIG. 9A is a perspective view of a stop block 900 and FIG. 9B is an open side view of the stop block 900 positioned in a generic RA housing 910 of an RA according to the invention. The stop block 900 is held in place in the housing 910 by screws 920 a, 920b, and 920c. A recess in the rack wheel is provided with a regular pattern of tooth-like shapes or angles in order to interlock with a corresponding pattern formed around the locking flange of the tube.

A rack wheel or rack hub can be made of rust-proof materials such as suitable gear-grade alloys of aluminum, bronze, or stainless steel; the material choice should follow the basic industry practice of being equal to or slightly softer than the pinion material. In addition, external sealed, shielded, and in some cases needle bearings will be used for a rack wheel or rack hub. The bearings encircle the exterior of the hub (as opposed to mounting inside the hub) and press-fit into the RA housing.

Tooth sizing and rack-to-pinion gear ratios can be based on well-known industry practices for a given application's load and displacement requirements. Exemplary implementations are described in more detail below in the gear ratio section.

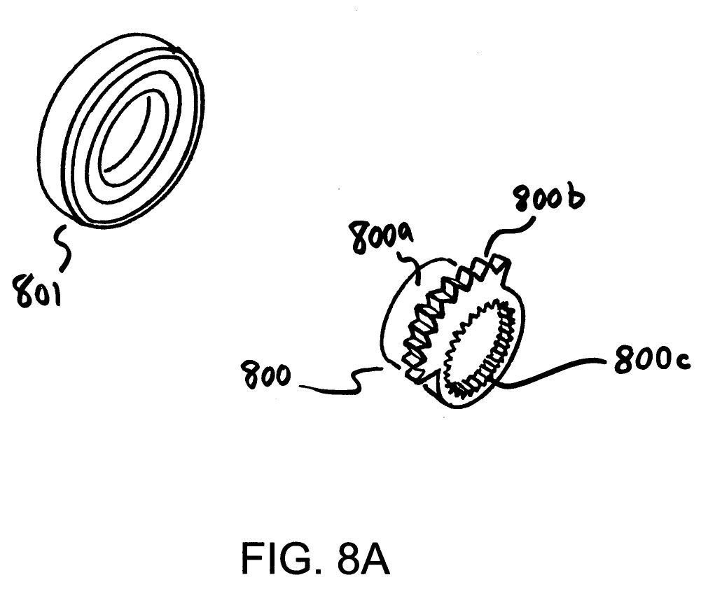

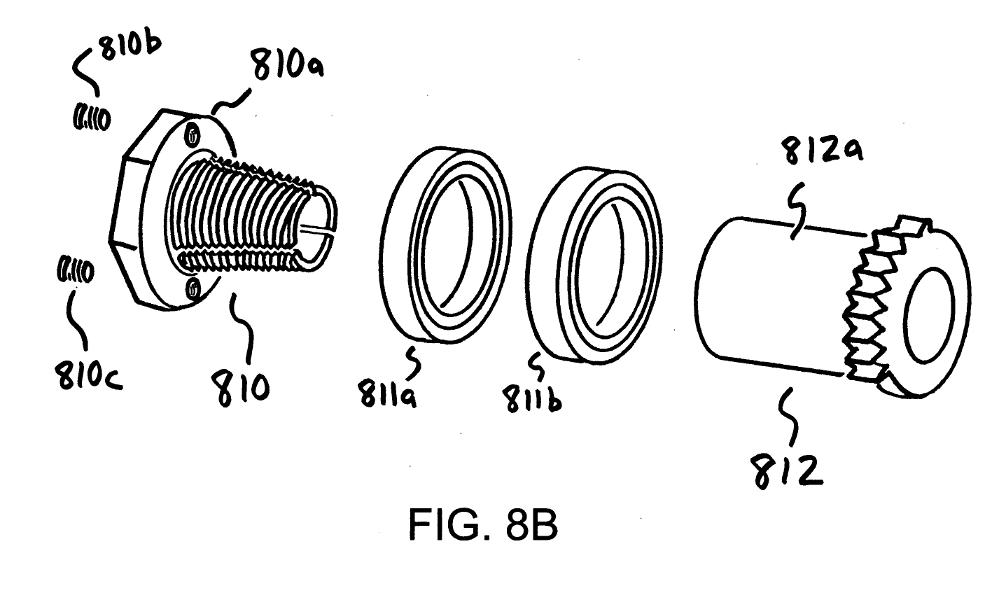

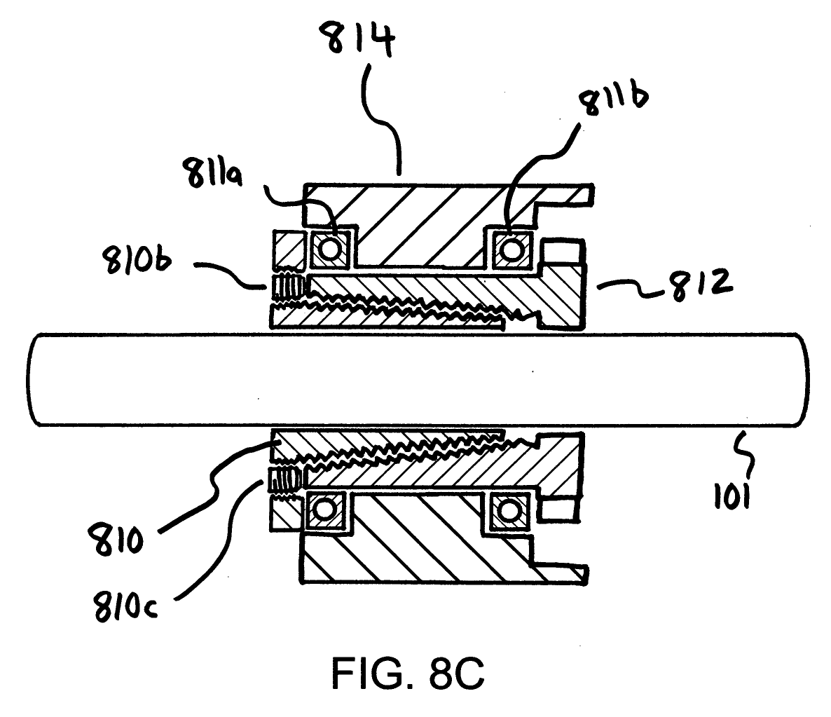

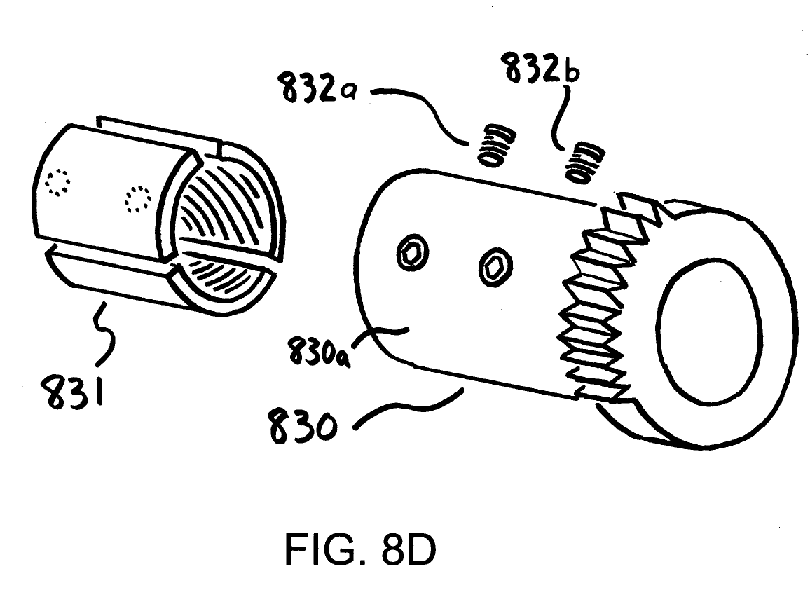

FIG. 8A is a perspective view of a rack wheel 800 and an associated rack wheel hub bearing 801 that can be used in embodiments of an RA according to the invention that include a stationary housing. The rack wheel 800 includes a rack 800b and a hub 800a over which the bearing 801 fits. In addition, the rack wheel 800 features a locking flange recess 800c which may be manufactured with a series of shapes such as teeth or petals which interlock with a corresponding series of shapes formed around the locking flange of the tube (FIG. 6E) or collar (FIG. 6F).

In the RHAs illustrated in FIGS. 15A and 15C (stationary housings), the configuration allows the rack wheel to “float” in its bearing around the circumference of the handlebar (the rack wheel does not contact the handlebar) and thus accommodate the slight variations in diameter from different handlebar manufacturers. The finished diameter of these handlebars can vary by as much as 1.75 mm or 0.069″ due to finishes, coatings and stampings. The “float” allows the rack wheel to remain centered concentrically on the main axis of the handlebar for best rotating action with the tube.

In the RAs illustrated in FIGS. 15B and 15D (rotatable housings), a rack hub is used. A rack hub is similar to a rack wheel, but a rack hub does not move; instead, the other components move around the stationary rack hub. The rack hub has a longer hub which runs the full width of the rotatable housing. The hub is fitted externally with either two sealed bearings, one recessed into each side of the rotatable housing, or one open needle bearing. The rack hub anchors the rotatable housing to the handlebar.

In one embodiment of a rack hub, the elongated hub of the rack hub is threaded internally with a tapered tap. A collet lock, a collet-like locking insert with tapered external threads, screws into the threaded bore of the elongated hub and locks the collet lock and collet-locked rack hub onto the handlebar as the collet lock is tightened into the bore of the elongated hub. FIG. 8B is an exploded perspective view of a collet lock 810, bearings for the elongated hub 811a and 811b, and collet-locked rack hub 812, illustrating the foregoing assembly. The collet lock 810 is threaded into the interior of the elongated hub 812a of the collet-locked rack hub 812 and clamps onto a handlebar (not shown in FIG. 8B). The bearings 811a and 811b are positioned around the exterior of the elongated hub 812a of the collet-locked rack hub 812. Set screws 810b and 810c run axially thru the head 810a of the collet lock 810 in order to prevent loosening of the collet lock 810. FIG. 8C is a cross-sectional view of the collet lock 810, collet-locked rack hub 812 and bearings 811a and 811b attached to a handlebar 101 within a generic rotatable housing 814. The generic rotatable housing 814 is secured in between, and rotates on, the two sealed bearings 811a and 811b. Set screws 810b and 810c prevent the collet lock from loosening.

FIG. 8D is an exploded perspective view of a plate lock and plate-locked rack hub that can be used in embodiments of an RA according to the invention that include a rotatable housing. The plate lock includes knurled plate sections 831 that fit inside the elongated hub 830a of a plate-locked rack hub 830. Inside the plate-locked rack hub 830, multiple radial set screws, such as 832a and 832b, press inwardly on the knurled plate sections 831 to lock the plate-locked rack hub 830 onto the handlebar. This “flush” design features a narrower profile than the collet lock, and affords an option for the housing known as a pivot clamp.

The set screws, such as 832a and 832b, will likely range in the 4 mm to 6 mm range, be rust-resistant, and be coated with a thread locking compound. The hub can be drilled or machined such that the screws mount only from the top down to prevent loss in the case of loosening. The knurled plates can be made from harder rust-resistant alloys, and can employ a cross-hatched knurling pattern. While not automatically centering itself concentrically like the collet lock, the plate lock can be adjusted very precisely and may accommodate a wider range of handlebar diameters.

6. The Pinion

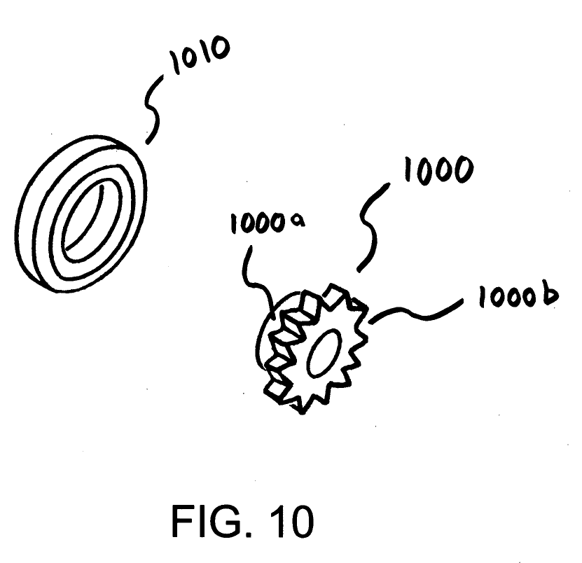

FIG. 10 is a perspective view of a pinion 1000 and an associated pinion hub bearing 1010 that can be used in embodiments of an RA according to the invention. The pinion 1000 includes a pinion gear 1000b and a hub 1000a over which the pinion hub bearing 1010 fits. The pinion can be made from relatively strong rust-proof gear-grade alloys such as stainless steel (and, possibly, relatively strong alloys of aluminum for light-duty applications). It may be necessary or desirable for the pinion alloy to match the alloy used for the axial screw (described below) since the two will mate in the pinion hub.

External sealed or shielded bearings are used for the pinion hub bearing(s). The pinion hub bearing(s) must have a combination of radial and thrust load capability to bear the rotary forces from the rack wheel, and linear push and pull forces from the screw.

Tooth sizing and rack-to-pinion gear ratios can be based on well-known industry practices for a given application's load and displacement requirements. Exemplary implementations are described in more detail below in the gear ratio section.

7. Rack and Pinion Gear Ratios

An RA according to the invention can be implemented to enable “tuning” for light, medium, and heavy actuation loads, e.g., clutch spring loads. Such tuning can be achieved by changing the rack to pinion gear ratio. In practice, this means altering the diameter (or effective diameter, in the case of the rack) of the gears, along with the total number of teeth on each gear.

For example, a large rack diameter combined with a small pinion diameter means that a relatively small RHA handgrip rotation will produce a relatively large total push or pull displacement. However, this increased output per unit input comes at the cost of greater muscle force required for actuation. Conversely, a small rack diameter combined with a large pinion diameter means that a relatively large handgrip rotation will produce a relatively small total push or pull displacement. However, this decreased output per unit input comes with the benefit of less muscle force required for actuation. The balance (i.e., the rack to pinion gear ratio) that is chosen for this tradeoff for a particular vehicle (e.g., motorcycle) can be chosen in view of the total actuation (e.g., clutch spring) force to be overcome, and the total displacement required to fully actuate a particular apparatus (e.g., engage and disengage a clutch).

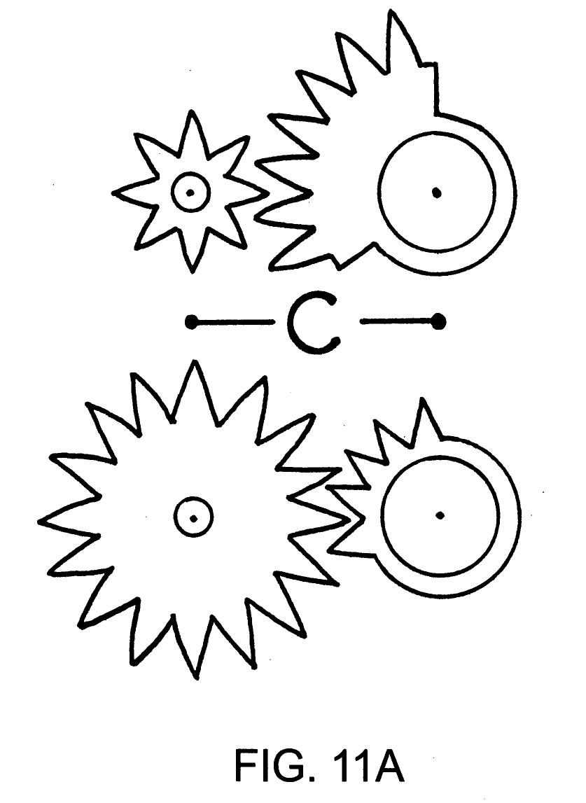

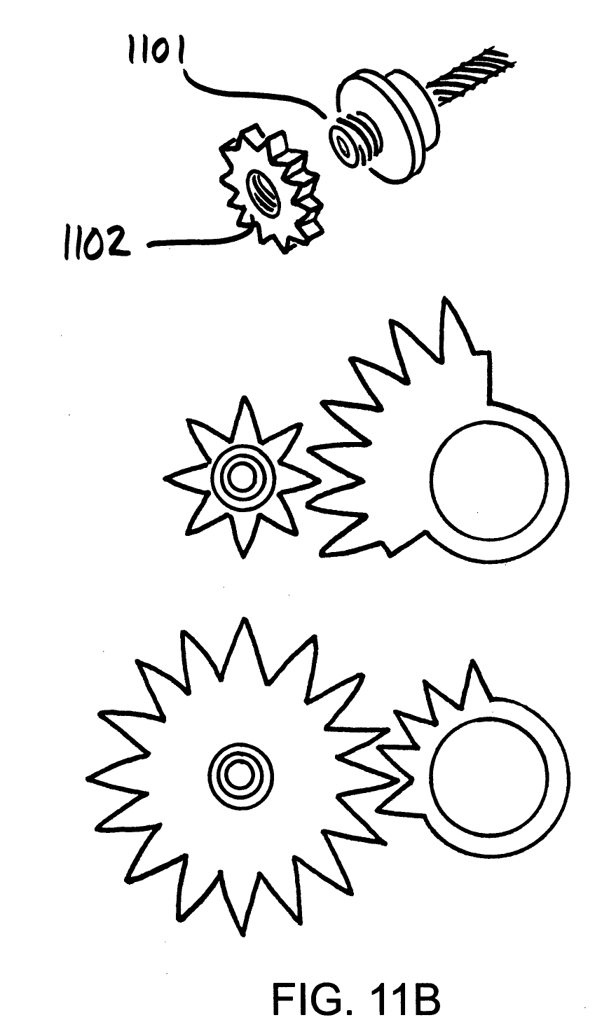

Ideally, changes in the rack to pinion gear ratio would not affect the housing, but, in practice, such ratio changes can result in a change of the center distance between the gears' axes. This can necessitate a change to the housing: the housing barrel axis to handlebar axis distance must change. However, for certain prime combinations of diameters and teeth numbers, the center distance will not change, but will remain constant. (FIG. 11A illustrates two different rack to pinion gear ratios with a constant center distance “C” between gear axes, which is paralleled by the side view of “prime” gear pairs in FIG. 11B.) Use of such a prime combination can be desirable if the prime combination meets the clutch force and displacement requirements, since such a prime combination does not necessitate housing changes.

The housing gear section can be recessed for the largest practical pinion diameter and largest practical rack wheel diameter. This allows the same housing to accommodate different prime gear ratios while using the same side plate. However, if the center distance needs to be altered, a different housing is required. The pinion axis (housing barrel axis) can be moved away from or toward the handlebar axis, since the pinion axis change will not usually affect side plate specifications.

An RA according to the invention can be implemented so that the choice of which prime rack and pinion combination to use need not necessarily be made at the time of manufacture of the RA. By employing a threaded pinion hub 1101 and threaded pinion bore 1102, as shown in FIG. 11B, and a lightly press-fit rack wheel/rack hub, a rider can easily choose between prime rack and pinion combinations until he finds a torque magnitude to rotation distance tradeoff which suits him (without needing to modify his housing). In general, 3 to 5 or more prime pairs can be used with the same housing. Exchanging rack and pinion pairs to produce a new prime combination requires some assembly, but common hand tools can do the job easily.

8. The Screw

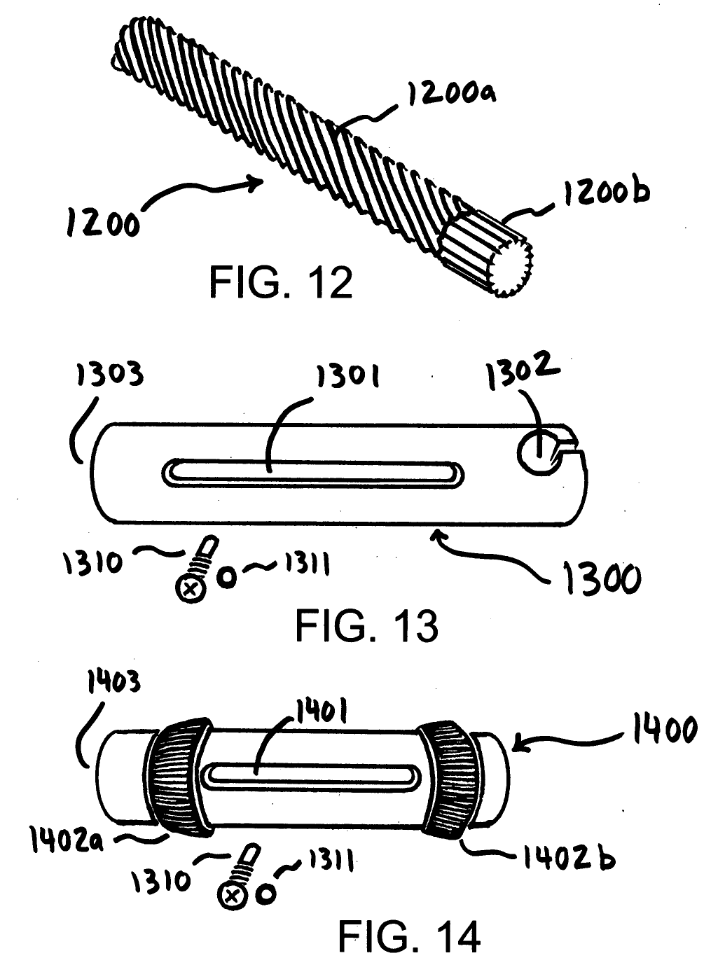

FIG. 12 is a perspective view of a screw 1200 that can be used in an RA according to the invention. The screw 1200 includes a threaded section 1200a that threads into a coupler or piston (depending on the particular embodiment of the invention) to effect translational movement of the coupler or piston, as described elsewhere herein, and a splined section 1200b that fits into a splined hub of a pinion and is attached by using an industrial adhesive, by soldering, by welding, or using any other appropriate technique. The screw is actually a precision rolled lead screw with multiple threads, not a common bolt. The threads of the screw must be matched precisely by the female threads of the cable coupler or hydraulic piston. Like the pinion, the screw can be made from relatively strong rust-proof gear-grade alloys such as stainless steel (and, possibly, relatively strong alloys of aluminum for light-duty applications). It may be necessary or desirable for the screw alloy to match the alloy used for the pinion since the two will mate in the pinion hub to form a stem gear.

The screw's threads have two primary requirements: the threads must be strong enough to withstand the clutch spring forces for long-term use, while the thread pitch must fall into the “overhauling” or “backdriving” class. Whether under a load or not, a normal bolt threaded into a nut won't spontaneously unscrew after being turned with a tool. “Overhauling” or “backdriving” pitch means that a load on the nut or the screw which approaches the line of the screw's axis will cause the nut and screw to rotate spontaneously with respect to each other. In other words, the axial load doesn't stop and lock into place after being turned like a normal nut and bolt. Implementing the screw so that the thread pitch is an overhauling or backdriving pitch allows clutch spring forces to return the RHA grip back to the starting position when the grip is released. After the threads are formed, the screw may be machined or drilled to create a hollow core running lengthwise through the shaft. The tubular core may be desirable for weight savings, lubrication, air flow, cooling, and other reasons.

9. The Coupler and the Piston

An RA according to the invention can be implemented to make use of either a coupler or a piston. The coupler is for use with RAs for cable-actuation and the piston is for use with RAs for hydraulic actuation. In both cases, a screw is threaded into a core of the coupler or piston (depending on the particular embodiment of the invention) to effect translational movement of the coupler or piston, as described elsewhere herein.

As indicated above, the female threads of the coupler or piston must match those of the screw precisely. Both the coupler and piston can be made from relatively strong rust-proof gear-grade alloys such as stainless steel or silicon bronze (and, possibly, relatively strong alloys of aluminum for light-duty applications). It may be necessary or desirable for the coupler/piston alloy to match or be softer than the alloy used for the screw since the two will mate in the coupler/piston core.

FIG. 13 is a side view of a coupler 1300 that can be used with an RA for cable actuation according to the invention. A screw-hole 1303, guide pin channel 1301, and a slotted cable tip recess 1302 are formed in the coupler 1300. FIG. 13 also shows a guide pin 1310 and associated o-ring 1311.

FIG. 14 is a side view of a piston 1400 that can be used with an RA for hydraulic actuation according to the invention. A screw-hole 1403 and guide pin channel 1401 is formed in the piston 1400. Two conventional expanding skirt seals 1402a (secondary) and 1402b (primary) are formed at either end of the piston 1400. FIG. 14 also shows a guide pin 1310 and associated o-ring 1311.

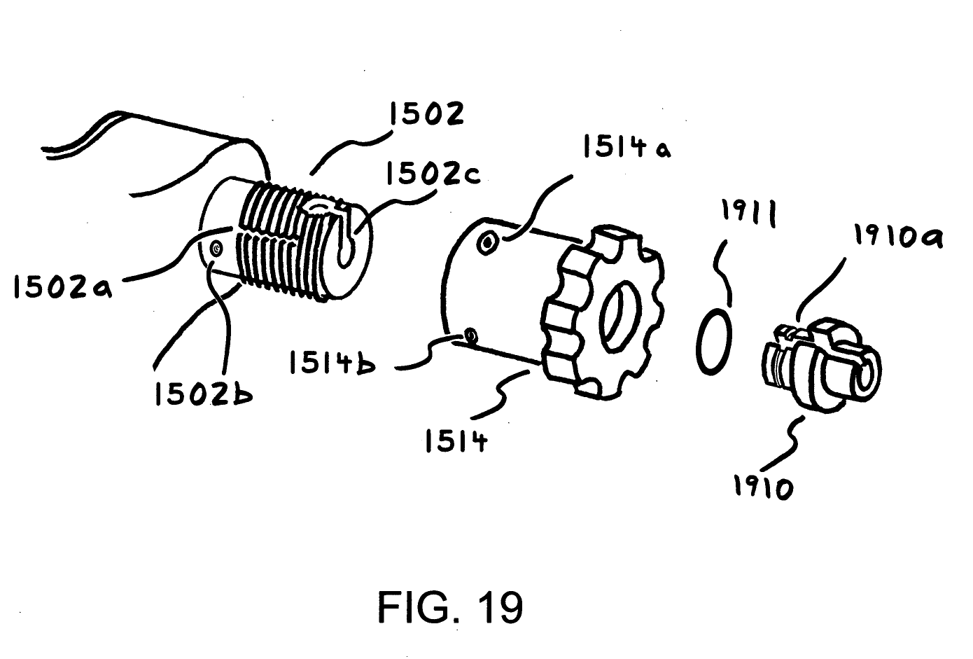

Both the coupler and piston have a guide pin channel. A guide pin threads into the barrel section of an RA housing at a right angle to the coupler/piston axis of travel (see 1502b of FIG. 19). The guide pin tip extends into the coupler/piston's guide pin channel. The head of the guide pin may include an o-ring and o-ring groove for sealing its entrance through the housing. The guide pin channel is cast or machined down the long axis of the coupler/piston's exterior and prevents the coupler/piston from spinning when the screw rotates into the coupler/piston core.

The cable tip recess in the coupler is used to position and retain the tip of a cable (see 1906a in FIG. 19). The cable tip fits into the large round opening (1906a) while the cable fits into the slot. The cable tip is then held in place by the surrounding material of the coupler.

The seals of the piston manage hydraulic fluid forces and are discussed in more detail below.

10. The Housing

The particular implementation of the housing can depend on the particular implementation of the RA. Below, four embodiments of the housing are described: two for cable-actuation (stationary and rotatable housings, illustrated in FIG. 15A and FIG. 15B, respectively) and two for hydraulic-actuation (stationary and rotatable housings, illustrated in FIG. 15C and FIG. 15D, respectively, each of which includes hydraulic fluid reservoirs). FIG. 15E is a full perspective view (shown with grip removed to reveal the underlying tube) of the housing shown in FIG. 15A, illustrating the various sections of a housing, such as the gear section 1501, the barrel section 1502, and the clamp section 1503. The gear section 1501, and the barrel section 1502, are common to all of the housings, although each section may be modified to match a particular housing type. The clamp section 1503 is found only in stationary housings. (FIG. 15E also shows a cable tension adjuster and an open-ended tube exiting the side plate of the housing.) The housing can be made from, for example, alloys of aluminum (other rust-proof metals may also be used) and can be formed by, for example, machining from billet or casting in a mold and refining with CNC machining.

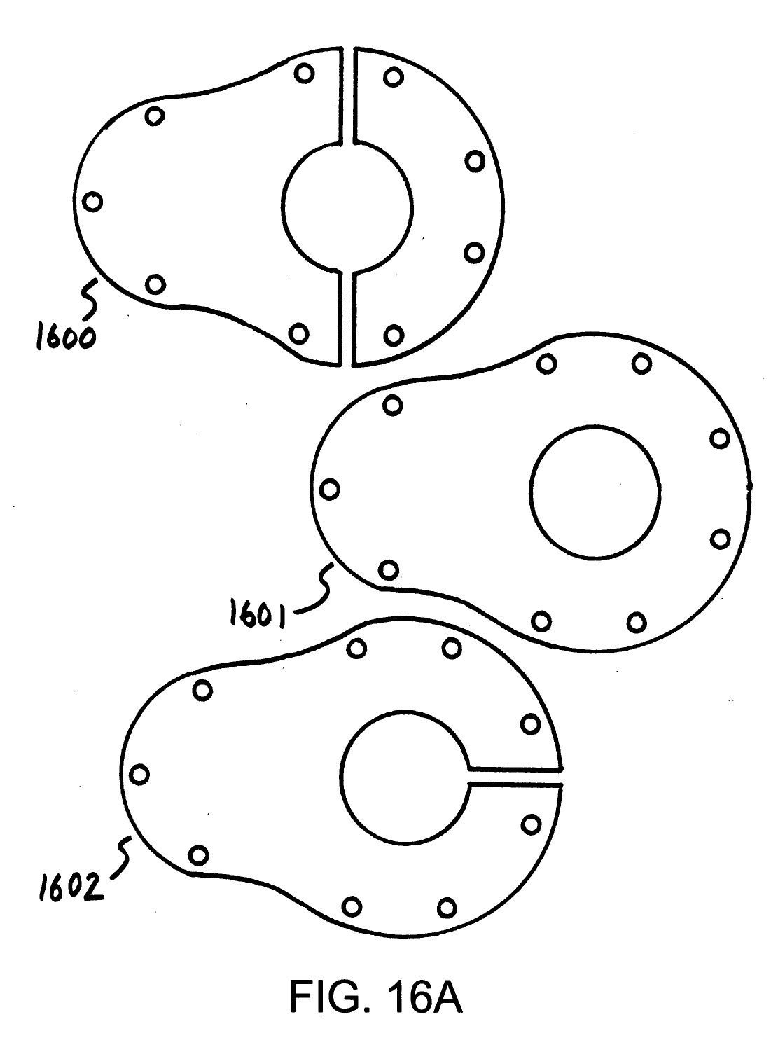

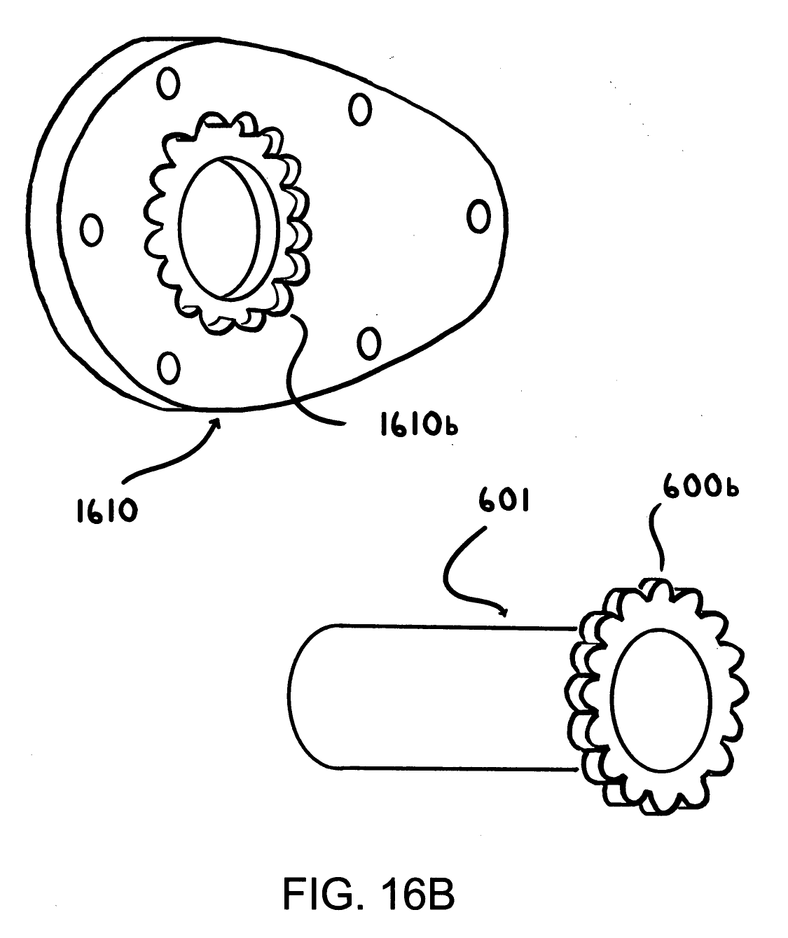

Each of the four described embodiments of the housing includes a separate side plate which seals the rack wheel/pinion area. In the RHAs illustrated in FIGS. 15A and 15C, the side plate locks the tube's locking flange into the core of the rack wheel. In the RHAs illustrated in FIGS. 15B and 15D, the side plate locks the tube's locking flange into itself (see FIG. 16B). The side plate can be of one-piece construction (which can enhance sealing) or multi-piece (e.g., two-piece) construction (which can facilitate assembly). The side plate can include PTFE (Teflon) coating for contact with any articulating surfaces, or a self-lubricating plastic gasket as an alternative. The junction of the side plate with the rest of the housing junction can include an integrated ring gasket or separate rubber gasket for weatherproofing. FIG. 16 is a side view of a two-piece side plate 1600, one-piece side plate 1601, and an associated one-piece gasket 1602 that is positioned between the side plate and the rest of the housing.

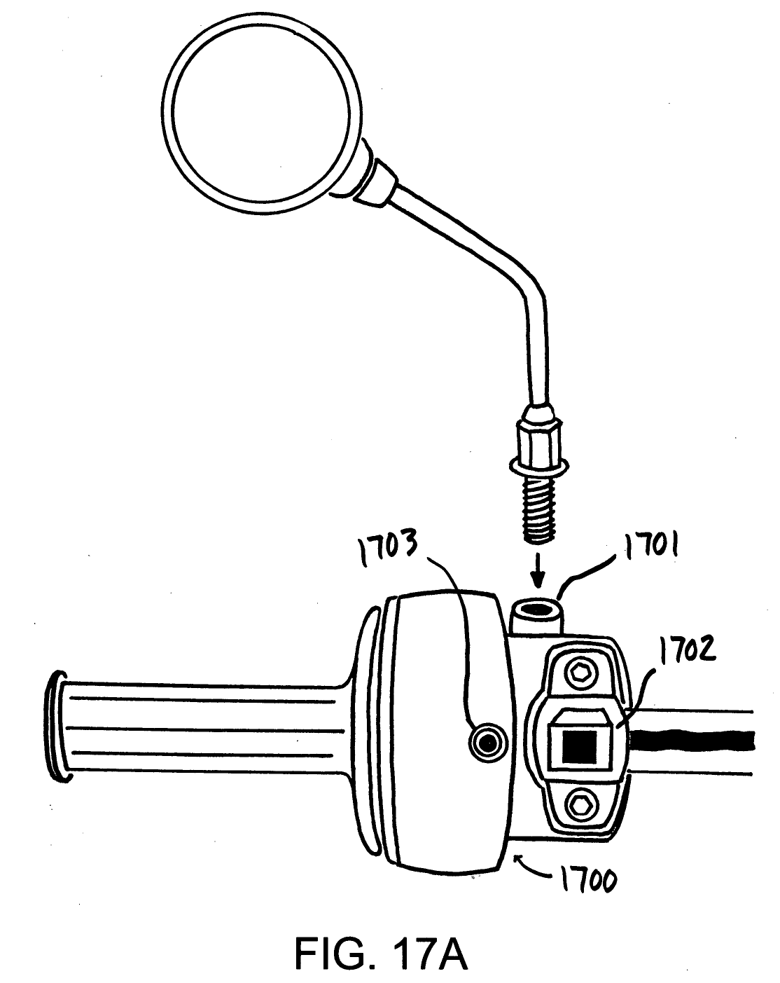

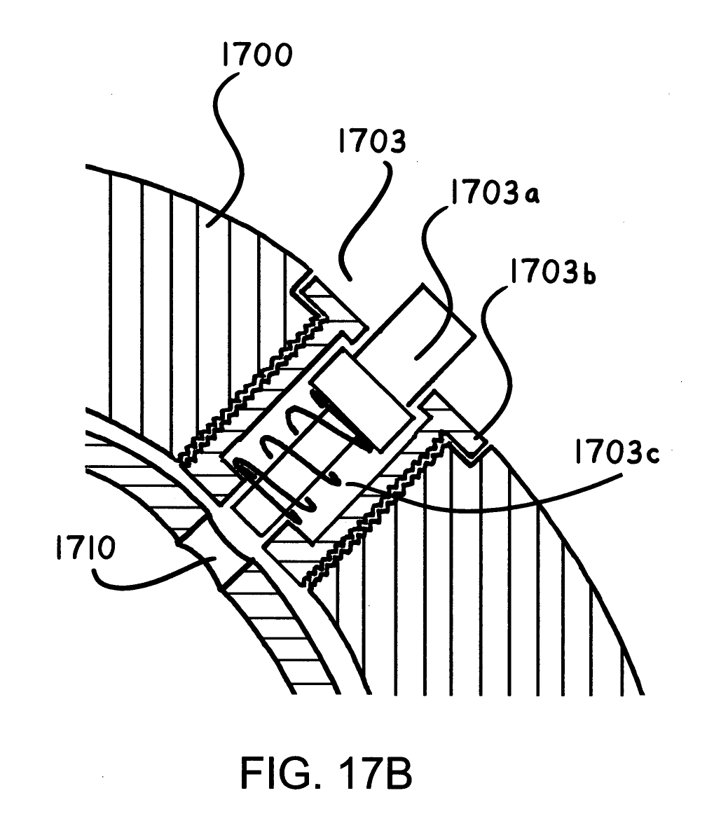

Each of the four described embodiments of the housing can also include one or more options which suit different riding environments and rider preferences. Options for all of the housings include tapped holes for motorcycle mirrors and/or compression release levers. Other options include ignition kill switch mounts machined into the rear of the housing or integrated with the two-bolt clamp. Other electronics, such as position sensors and brake light switches, may also be incorporated. FIG. 17A is a rear view of a custom housing 1700 of an RA according to the invention, the custom housing 1700 including a mirror mount 1701, kill switch 1702, and push-button lock assembly 1703.

The gear section of the housing (1700 in cross-section FIG. 17B) may include an optional push-button lock assembly (1703 in FIG. 17B) which mates with corresponding hole(s) in the hub of the custom cylindrical rack assembly 1710. The push-button lock is spring-loaded and can only be pushed in when the handgrip and/or housing has been fully rotated so that the corresponding hole(s) in the hub of the custom cylindrical rack assembly are aligned with the push-button lock. The push-button lock assembly 1703 includes a push-button 1703a, fitting 1703b, and spring 1703c. For a C-RHA, the push-button lock can be used to fix the clutch in a fully-disengaged position. The push-button lock can be implemented so that the lock disengages automatically when the grip or housing is slightly over-rotated. For a B-RHA, the push-button lock can be used to lock the brake like a parking brake. For an X-RHA, the push-button lock can have one of multiple uses, depending on the type of apparatus that is being controlled.

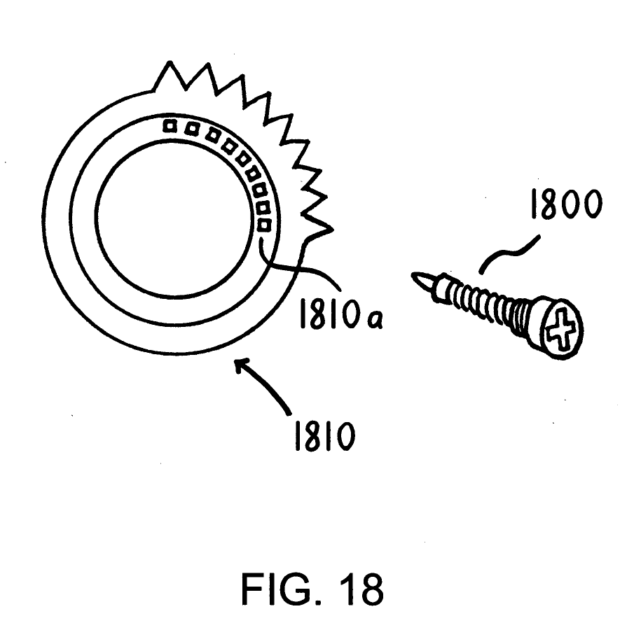

Any embodiment of the housing can be implemented to include haptic feedback. FIG. 18 is a perspective view of a spring-loaded detent 1800 and a cylindrical rack assembly 1810 having a surface 1810a that has a scored or stamped gradation pattern of indentations formed thereon to enable the provision of haptic feedback when rotating the handgrip and/or housing. The spring-loaded detent 1800 is positioned within the housing so that the detent 1800 is forced against the surface 1810a of the cylindrical rack assembly 1810. As the cylindrical rack assembly is rotated relative to the housing, the detent passes over the scored surface, providing haptic feedback during rotation of the handgrip and/or housing. The gradation pattern can be intermittent, regular, or logarithmic to indicate when the extremes of rotation have been reached.

For housings with a coupler for cable actuation, a cable slack adjuster is required. FIG. 19 is an exploded perspective view of a cable tension adjuster 1514 with slotted centering insert 1910 and associated o-ring 1911 which fits in channel 1910a that can be used in embodiments of the invention. The cable tension adjuster 1514 threads onto the barrel section of the housing 1502 (see also 1502 of FIG. 15E). The cable tension adjuster 1514 simply moves the jacket of the cable forward or backward in relation to the steel leader inside in order to remove excess cable slack. The cable tension adjuster 1514 may also utilize spring-loaded detents 1514a and 1514b contacting grooves 1502a in the outside of the housing barrel to create an indexed feel and positive locking action as the rider turns the cable tension adjuster 1514. Note that the barrel section 1502 of the housing is also equipped with the guide pin tap 1502b and cable tip slot 1502c.

11. The Accessories

The housing may accommodate several types of accessories depending on the types of controls to be actuated and the type of vehicle with which the RA is used. Any of a variety of accessories can also be provided; the following are merely exemplary.

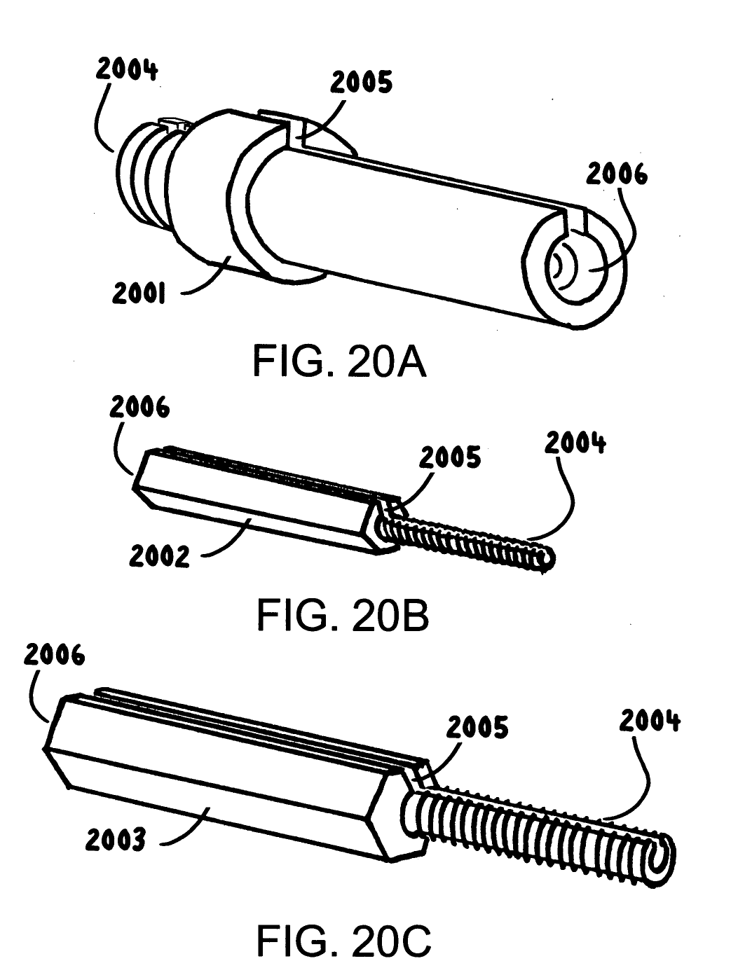

First, for cable actuation, in order to properly fit stock clutch cables, the housing's adjuster needs a component to take up the excess slack (anywhere from 25 mm to 40 mm) in the steel leader of the cable. FIGS. 20A, 20B, and 20C are perspective views of three types of cable spacers (jacket lengtheners): a split long-nosed adjuster insert (2001), a split mid-cable insert (2002) and a split tail addition (2003). Common to all of these cable spacers are three features: a male section 2004, a female section 2006, and the split for cable insertion 2005. Each of these cable spacers can be covered with a fitted mudguard for off-road use, if necessary or desirable. Instead of adjustment with a cable spacer, a custom clutch cable (1513 in FIG. 15A) can be purchased to replace the stock cable.

For many motorcycles, special fittings for small choke levers are desirable. These can be mounted on the top of the housing for easy thumb or finger access.

For motorcycles with four-stroke engines, special fittings for additional small levers are common. Again, these can be mounted on the housing. Such levers can be used as, for example, compression releases.

For motorcycles with hydraulic controls, special fittings for remote fluid reservoirs may be preferred over the reservoirs which are cast or machined into the housing.

There are three types of leveraging accessories that can be used with a rotatable housing. Two are for forward rotation housings: the finger paddle and the pivot clamp. One is for rearward rotation housings: the thumb paddle. Each is described in more detail elsewhere herein.

12. The Mudguard

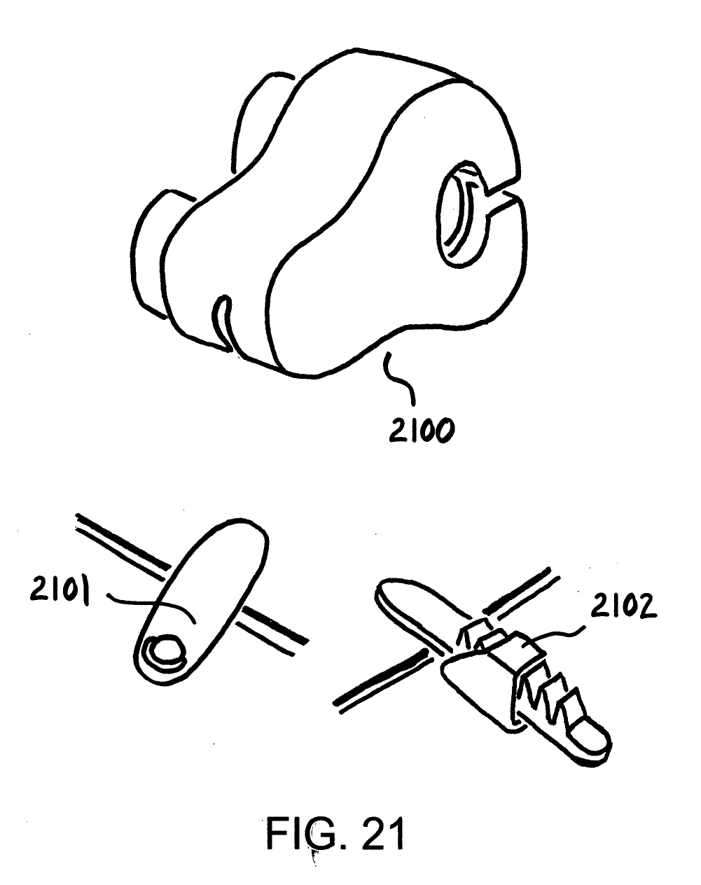

A mudguard can be used to cover an RA according to the invention. The particular implementation of the mudguard can depend on the particular implementation of the RA. Below, four embodiments of a mudguard are described: two for cable-actuation housings (one for a stationary housing and one for a rotatable housing) and two for hydraulic-actuation housings (one for a stationary housing and one for a rotatable housing). In each of the embodiments, the mudguard is split to wrap over and under the housing at the handlebar. The split is closed on the back side of the housing to secure the mudguard on the handlebar. This can be done using, for example, a built-in rubber fastener. FIG. 21 is a perspective view of a mudguard 2100 and two examples of integrated fasteners: the snap type 2101, and the zip-type 2102. The mudguard 2100 is for use with the RHA illustrated in FIG. 15A, i.e., a stationary housing RHA for cable actuation. In the hydraulic version of the housing, an enlarged mudguard is provided (relative to the size of the mudguard for a stationary housing), with a second split at the bottom of the reservoir/barrel section which can also fasten with a built-in rubber fastener. Rotatable housings may require a slightly-enlarged hole for the collet lock or pivot clamp, if used. Materials used for the mudguard can be automotive-grade chemical-resistant and UV light-resistant thermoplastic elastomers and synthetic rubber compounds. The mudguard can also be modified as required to accommodate the accessories discussed above.

IV. Particular Embodiments of RA Controls

A. RAs for Cable Actuation

1. Stationary Housing

a. Overview of Construction and Operation

FIG. 15A is a perspective view of a handlebar 101 on which is mounted an RHA, according to an embodiment of the invention, that can be used with cable-actuated apparatus (e.g., a cable-actuated clutch, in which case the RHA is a C-RHA) and that is housed in a stationary housing 1510 (for convenience, sometimes referred to herein as a “stationary housing RHA for cable actuation”). As explained briefly below and in more detail elsewhere herein, the RHA converts the rotational motion of a hand twisting a grip and tube 1512 (RHA handgrip) into the linear pull of a clutch cable (not visible in FIG. 15A, but within the custom clutch cable 1513). A grip and tube 1512 (RHA handgrip) are rotated around the handlebar 101 by hand. As discussed above, a locking flange of the tube locks into the core of a large diameter rack wheel (as discussed above, a quarter-gear composed of a toothed arc on a cylindrical hub) so that rotation of the grip and tube (RHA handgrip) rotate the rack wheel. Rotation of the rack wheel rotates a corresponding small-diameter pinion gear that mates with the rack wheel. A threaded lead screw extends from the hub of the pinion into the “barrel” of the housing 1510. Within the barrel, the screw threads into a female coupler. A guide pin channel is provided on the long axis of the coupler into which a guide pin is inserted to prevent the coupler from spinning in the barrel, as discussed in more detail above, and a hole is formed in the end of the coupler opposite that into which the screw is threaded to receive the clutch cable tip. Rotation of the pinion gear (and, thus, the screw) by the rack wheel pulls the coupler down the barrel with the clutch cable in tow. The outside of the housing around the barrel is threaded and grooved to mate with a large-diameter cable tension adjuster 1514 (see, e.g., FIG. 19). The entire housing can be covered with a removable mudguard (see FIG. 21).

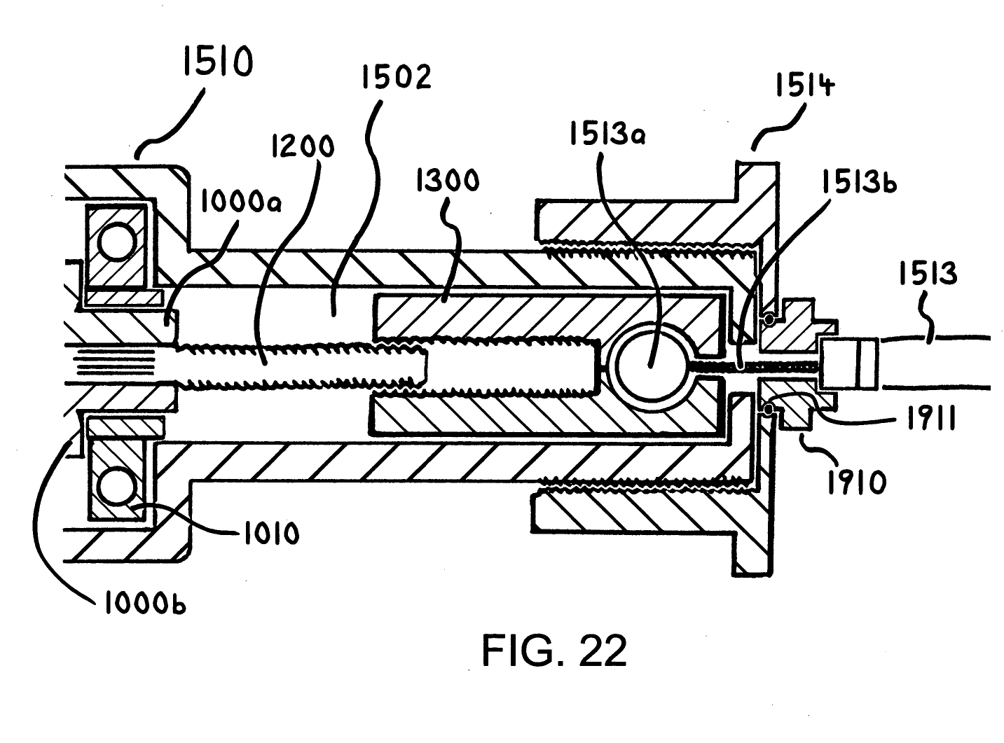

FIG. 22 is a latitudinal cross-sectional view of part of an RA (the barrel section 1502) for cable actuation, according to an embodiment of the invention, illustrating construction and assembly of parts of an RA for cable actuation that are enclosed within a housing 1510. (The mechanisms of FIG. 22 can be implemented in a stationary or rotatable housing.)

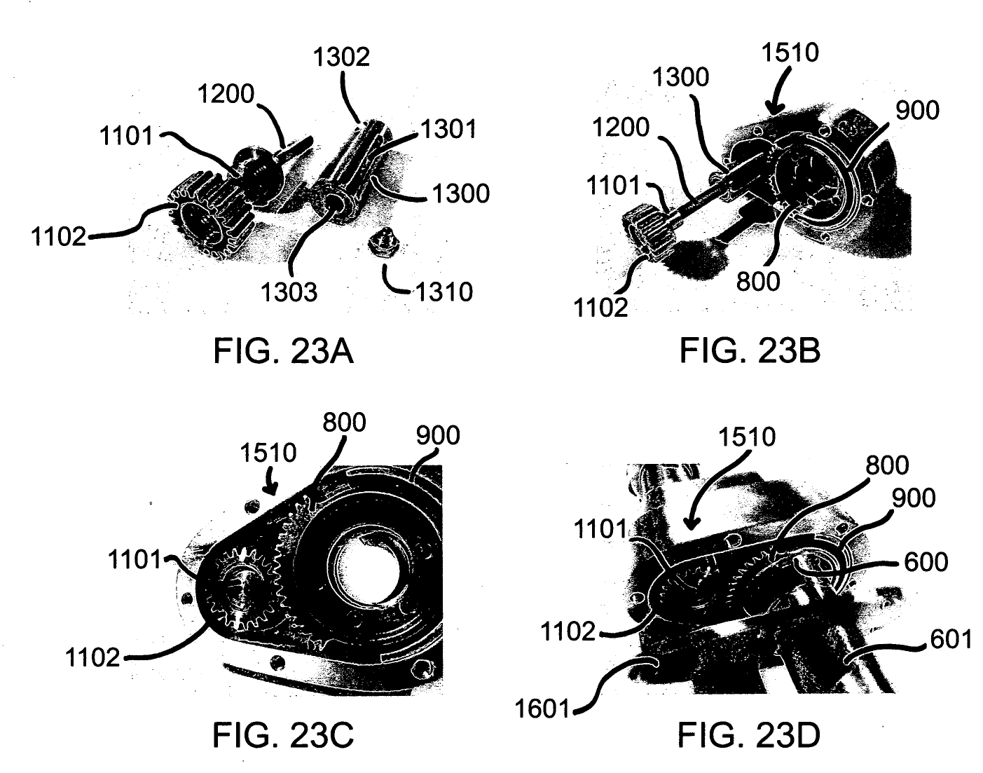

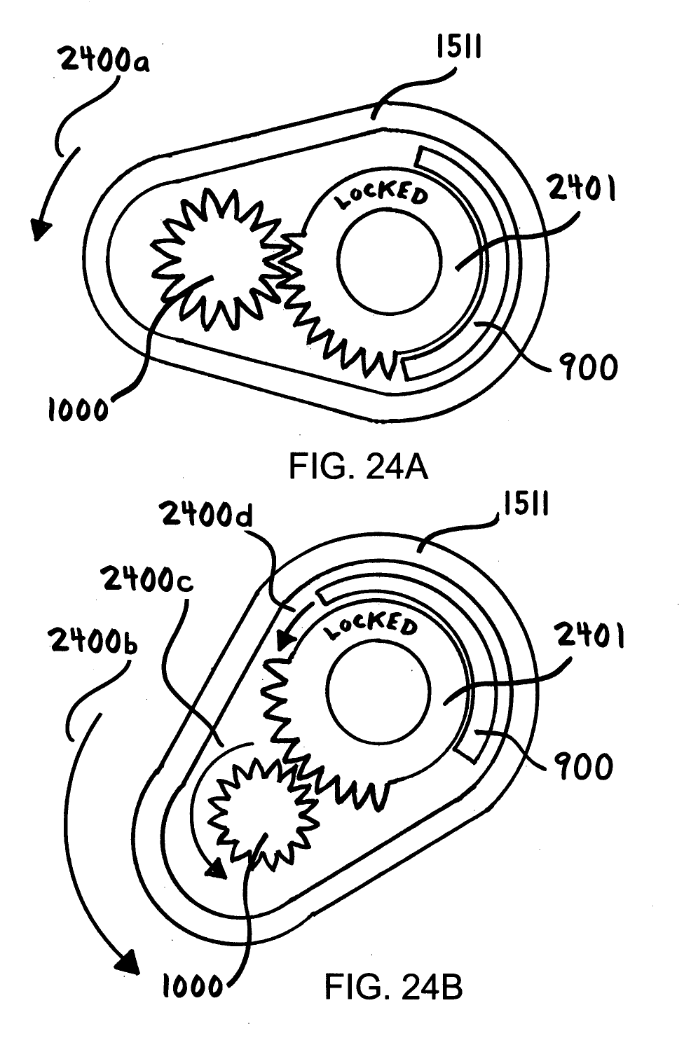

FIG. 22 shows a pinion gear 1000b from which extends a hub 1001a. A screw 1200 extends from the hub 1001a. A bearing 1010 is positioned around the hub 1001a to rotatably mount the pinion gear 1000b, hub 1000a and screw 1200 in the housing 1510. (A rack wheel which is also positioned within the housing 1510 and mates with the pinion gear 1000b is not located in the cross-sectional plane of FIG. 22. Also not located in the cross-sectional plane of FIG. 22 is the locking flange of the tube; however, one or more of these components are visible in FIGS. 23B, 23C and 23D described below.) The screw 1200 extends into the barrel section 1502 of the housing 1510 where the screw 1200 is threaded into the screw hole 1303 of the coupler 1300 positioned within the barrel section 1502. A receptor hole (a.k.a. slotted cable tip recess) is formed in the end of the coupler 1300 opposite that into which the screw 1200 is threaded. A cable 1513b extends into the receptor hole via a slot formed in the coupler 1300 so that a cable tip 1513a is positioned in the receptor hole formed in the coupler 1300. The outside of the barrel section 1502 is threaded and grooved to mate with a large-diameter cable tension adjuster 1514. Slotted centering insert 1910 is positioned inside the cable tension adjuster 1514, and the joint is sealed with an o-ring 1911. The cable extends through coaxial holes in the coupler 1300, housing 1510 and cable adjuster 1514 to become a custom clutch cable 1513 through which the cable connects to further apparatus to enable actuation of the apparatus being controlled with the RA.

FIGS. 23A through 23D are photographs showing perspective views and a side view of part of a stationary housing RHA for cable actuation, according to an embodiment of the invention, illustrating construction and assembly of the RHA. In FIG. 23A, a threaded pinion gear 1102 having a threaded hole formed therethrough is shown prior to being threaded onto a threaded hub 1101 from which a screw 1200 extends. Also in FIG. 23A, a coupler 1300 and guide pin 1310 are shown. During assembly of the RHA according to this embodiment of the invention, the screw 1200 is threaded part way into the threaded hole 1303 formed in the coupler 1300, and the tip of the guide pin 1310 is fitted into the guide pin channel 1301 formed in the coupler 1300. (The guide pin 1310 is fitted through the barrel section of the housing as described above.) A slotted cable tip recess 1302 is also just visible in FIG. 23A at the end of the coupler 1300 opposite that into which the screw 1200 is threaded. In FIG. 23B, the threaded pinion gear 1102 has been threaded onto the threaded section of the hub 1101, the screw 1200 has been threaded into the coupler 1300, and coupler 1300 is partly inserted into the barrel section 1502 of the housing. (A bearing that fits around the section of the hub 1101 extending from the threaded pinion 1102—see, e.g., the similar bearing 1010 in FIG. 22—is not shown.) A rack wheel 800 is inserted into the gear section of the housing 1510. A stop block 900 is also attached to the housing 1510 in that recess. The stop block 900 limits the rotation of the rack wheel 800 via contact between ends of the stop block 900 and corresponding ends of the gear-toothed section of the rack wheel 800. The open side view of FIG. 23C shows the assembled threaded pinion 1102 and hub 1101 (with screw 1200, and coupler 1300 already fully inserted into the barrel section 1502 of the housing 1510). Similarly, the rack wheel 800 is shown fully inserted into the gear section (1501) of the housing 1510. As can be seen, the teeth of the pinion gear 1102 mesh with the teeth of the rack wheel 800. Finally, FIG. 23D shows a tube 601 and a locking flange 600 inserted into the rack wheel 800 prior to attaching a side plate 1601 to the remainder of the housing 1510 to enclose the above-described components.

b. Components

i. RHA Grip and Tube

The RHA grip can be manufactured from any of several grades or combinations of thermoplastic elastomers or synthetic rubbers as is common for grips produced by companies such as Scott, Renthal, and Pro-Grip. The grip can be manufactured closed or open-ended to suit different handlebar configurations. The grip can also be manufactured in different shapes and sizes: oversized diameters give the hand extra leverage for rotation, as do extruded leading edges as described above. The grip can also include core shapes, internal grooves, or molding which assist in preventing the grip from slipping on the tube and also direct how the grip and tube align longitudinally and rotationally.

The RHA tube can be manufactured from any of several grades of suitable high-strength plastics, composites, or metals as is common for tubes produced by companies such as Pro-Grip, Motion Pro, Moose Racing, and Pro Circuit. The tube can be manufactured closed or open-ended to suit different handlebar configurations. The tube can also be manufactured in different shapes and sizes: lengths can be varied for different applications and extruded leading edges can be molded or machined-in for extra leverage as described above. The tube may also include external shapes, grooves, or molding which assist in preventing the grip from slipping on the tube and also direct how the grip and tube align longitudinally and rotationally.

Embodiments of the tube can include stop flanges or require grip washers to prevent grip/housing friction. Many embodiments of the tube include a locking flange. The locking flange allows the grip and tube to lock into the rack wheel (for a stationary housing) or side plate (for a rotatable housing) to effect the desired actuation while remaining easy to disassemble or re-position. The perimeter of the locking flange can be fabricated with a regular pattern of shapes which interlock with a corresponding pattern inside the rack wheel or side plate.

Finally, the RHA grip and tube may be molded together permanently as in the Pro-Grip SCS design. However, ease of grip replacement has kept grip and tube separate for most manufacturers.

ii. Tube Levers

As described above, tube levers for increasing leverage can be applied to, for example, forward-actuating or rearward-actuating embodiments of the RHA illustrated in FIGS. 15A and 15C.

The forward-and-rearward-rotating tube levers can be used with RAs which do not feature any form of articulated handgrip or tube. Instead of a locking flange tube, stationary housing RAs may incorporate a locking flange collar (see 602 of FIG. 6F) which extends out of the RA housing just far enough to provide a tube lever a surface to clamp onto. Friction with the fixed grip is prevented with a grip washer.

iii. Rack Wheel

The rack wheel includes a curved rack occupying about one quarter of its perimeter. The hub of the rack wheel can be overbored to slip over a variety of handles and handlebars of a given diameter (e.g. ⅞″ or 22 mm; there are slight variations among manufacturers). The hub's exterior is machined as a cylinder to mate with a corresponding large-bore bearing. The bearing fits around the hub directly beside the curved rack. The assembly is press-fit into its bearing recess in the gear section of the housing.

The rack wheel fits into the specially-recessed gear section of the housing. This section protects the rack and pinion as well as limits the rotational travel of the rack wheel to a maximum of 90 to 100 degrees with a stop block. Other maximum amounts of rotation can be used: some embodiments may include maximum rotations of as little as 30 to 40 degrees of travel.

The rack includes teeth which mesh with matching teeth on the pinion gear. While it is anticipated that straight-cut spur gear teeth are most likely to be used for the rack wheel and pinion gear, bevel cuts and other cuts can be used for applications requiring non-orthogonal fits. Tooth width can range between, for example, 5 mm (or about 5 mm) to 10 mm (or about 10 mm) with, for example, an average module of 1.0 (or diametral pitch of around 24) and a 20 degree pressure angle. Variations in pitch circle diameter, width, cut, module/diametral pitch, and materials will arise as a function of load and displacement requirements. (Note that certain tooth cuts—e.g., bevel cuts—for rack wheel/pinion gear combinations may create axial thrust forces which will require securing mechanisms such as internal or external snap rings or circlips; these are described elsewhere herein.)

As described above, the rack wheel may be part of a prime pinion/rack gear pair, and may also be machined on an inner face with a pattern of grooves for haptic feedback.

iv. Pinion

The pinion can be a small, fully-formed gear with a machined bore and a solid hub band or perimeter. During operation of the RA, the pinion is turned by the rack wheel. The pinion fits into the specially-recessed gear section of the housing which protects the pinion and rack wheel. The pinion hub extends further into the barrel section of the housing. The pinion hub's exterior can be machined as a cylinder to mate with a corresponding sealed bearing. The bearing, which can be selected for ability to handle both radial and thrust loads, fits around the hub directly beside the toothed pinion. The assembly is press-fit into the barrel section of the housing. The bore of the hub can be machined to match the tip of the screw shaft (see, e.g., FIG. 12): the machining can mean tapping the bore to match the screw's threads or both the hub and screw shaft can be machined with traditional straight splines. The hub/screw joint can be joined with industrial adhesive, soldered, or welded for maximum strength. Alternatively, the pinion and screw can be machined from one solid piece of metal; however, the expense and waste involved may make this undesirable.

The pinion includes teeth which mesh with matching teeth on the rack wheel. While it is anticipated that straight-cut spur gear teeth are most likely to be used for the rack wheel and pinion gear, bevel cuts and other cuts can be used for applications requiring non-orthogonal fits. Tooth width can range between, for example, 5 mm (or about 5 mm) to 10 mm (or about 10 mm) with, for example, an average module of 1.0 (or diametral pitch of around 24) and a 20 degree pressure angle. Variations in pitch circle diameter, width, cut, module/diametral pitch, and materials will arise as a function of load and displacement requirements. (Note that certain tooth cuts—e.g., bevel cuts—for rack wheel/pinion combinations may create axial thrust forces which will require securing mechanisms such as internal or external snap rings or circlips; these are described elsewhere herein.)

As described above, the pinion may be part of a prime pinion/rack gear pair.

An alternative version of the pinion and hub includes a threaded pinion bore with a matching threaded hub extension. (This is illustrated in FIGS. 11B and 23A.) Use of a threaded hub extension enables a variety of pinions to be used with the hub and, in particular, pinions that are from a set of “prime” pinion/rack gear pairs with a constant center distance “C” (FIG. 11A)

v. Screw

The screw is an important part of an RA according to the invention, since the screw is where rotary and linear forces intersect. As indicated above, the screw is actually a precision lead screw.

As discussed in the pinion section, the hub of the pinion can be machined to match the inserted section of the screw (see, e.g., FIG. 12). Machining can be straight splines, or just the matched threading of the screw itself. The pinion hub/screw joint can be joined with industrial adhesive, soldered or welded for maximum strength.

An important aspect of the screw is the screw's thread specifications. The threads must be strong enough to withstand axial forces associated with the actuation (cable or hydraulic). In addition, the thread pitch must fall into the overhauling or backdriving class. As described above, overhauling means that the forces of the load will cause the screw to rotate spontaneously. For clutch controls, this means that the spring forces of the clutch will cause a C-RHA grip to return to its start position when released.

As thread pitch increases for a given screw, space is created for additional threads or “starts.” Screws with overhauling or backdriving specifications usually have multiple starts: thread pitch, thread size, and screw diameter combine to determine the maximum number of starts. It is anticipated that total starts for a C-RA according to the invention will range between 4 and 20. For a C-RA, the “lead” of the screw must also be defined. The lead is the displacement, distance, or travel resulting from one revolution of the screw. On average, the length of cable pull required to move a clutch from fully engaged to fully disengaged is about 8 mm to 10 mm. Note that this distance is significantly less than the total pull of a typical clutch lever on the cable: the typical clutch lever will move a cable 16 mm to 20 mm. This is roughly a 2× difference. The difference is to allow for freeplay and overpull. For a conventional clutch lever control, freeplay is the slack that gets taken up as the lever first starts to move (before significant resistance is felt). Overpull is the movement of the lever towards the handlebar that is felt well after the clutch has been fully disengaged. Freeplay and overpull are critical to proper adjustment of the clutch. Together, freeplay and overpull provide a margin of safety to account for factors such as cable stretch, clutch plate expansion due to heat, clutch plate wear, and misadjustment of the clutch by the rider. However, given several millimeters of both freeplay and overpull buffer, the total cable travel still does not add up to the 16 to 20 mm provided by the typical clutch lever: there is extra freeplay and extra overpull designed into the typical lever pull.

The extra freeplay is given for finger contraction to reach a point where maximum muscle forces can begin to act on the lever. This is especially important for smaller hands with shorter fingers. However extra freeplay is not a factor for C-RA mechanisms as the finger position is fixed on the grip. There is also extra overpull. Presumably, extra overpull is provided to account for extra-thick grips or lever damage due to a crash which would shorten the total travel of the normal lever. This is not a factor for C-RA mechanisms, either. The “extras” can be traded for additional mechanical advantage. Consequently, the average screw pull for C-RA mechanisms is about 12 mm (one turn of the grip will move the coupler and cable about 12 mm).

vi. Coupler

As described above, the female coupler is machined internally to match the threads of a precision lead screw. The coupler can be made from relatively strong rust-proof gear-grade alloys such as stainless steel, silicon bronze, (and, possibly, relatively strong alloys of aluminum for light-duty applications). It may be necessary or desirable for the coupler alloy to match or be softer than the alloy used for the screw since the two will mate in the coupler core.

The coupler links the cable to the RA. The coupler is threaded internally with threads which match the screw. This threaded bore of the coupler may include an oil-hole at its blind end. To prevent rotation of the coupler in the housing barrel, the external surface of the coupler can be machined along the long axis of the coupler to form a guide pin channel into which a guide pin is inserted. The coupler has a diameter (about 17 mm minimum for motorcycle clutch cables) which precisely fits the housing barrel with allowances for lubrication. The length of the coupler is determined by the total screw travel required for a given cable pull. The tip of the coupler can be machined with a receptor hole (e.g., an 8 mm×10 mm receptor hole, a.k.a slotted cable tip recess) to house the cable tip.

vii. Stationary Control Housing and Options

As described above, the housing can be made from alloys of aluminum (other rust-proof alloys like magnesium could also be used) and may be machined from billet or cast in a mold and refined with CNC machining. Possible finishes for the housing include anodizing, clear-coating, powder coating, paint, and combinations of these.

The housing for the RHA illustrated in FIG. 15E includes two main sections: the gear section 1501 and the barrel section 1502. These two sections are common to all of the RAs, whether stationary or rotatable, cable-actuating or hydraulic-actuating. There is also a clamp section 1503 for stationary housings. The gear section 1501, which can also be referred to as the rack wheel/pinion section, mounts on the handlebar so that the gears' planes are perpendicular to the handlebar. The barrel section 1502 extends parallel to the handlebar. A separate clutch cable adjuster, which is oversized for on-the-fly adjustment, is attached to the end of the barrel section opposite the end that is adjacent the gear section. The adjuster can also include spring-loaded detents which snap into grooves machined across the barrel's exterior threads. The adjuster includes a removable core which pops out to allow the clutch cable tip to insert through the adjuster and into the barrel and coupler (see FIG. 19).

The housing can be secured to the handlebar by, for example, a traditional, two-bolt clamp for stationary housings or a locked cylindrical rack assembly, such as a collet lock or plate lock, for rotatable housings. The clamp is traditional and inexpensive, but cannot center the housing concentrically on the center axis of many handlebars due to slight variations in handlebar diameter. For rotatable housings, the collet lock can center the housing mechanism, but is slightly more expensive to produce.

Each of the described embodiments of the housing includes a separate side plate which seals the gear section. The plate locks the tube's locking flange into the core of the rack wheel. The side plate can be of one-piece construction (which can enhance sealing) or multi-piece (e.g., two-piece) construction (which can facilitate assembly). The side plate can include PTFE (Teflon) coating for contact with any articulating surfaces, or a self-lubricating plastic gasket as an alternative. The side plate/housing junction can include an integrated gasket for weatherproofing.

As indicated above, each of the embodiments of the housing can also include one or more options which suit different riding environments and rider preferences, such as tapped holes for motorcycle mirrors and compression release levers, or switches (such as ignition kill switches) machined into the top or rear of the housing or integrated with the two-bolt clamp.

Finally, custom housings may include an optional spring-loaded detent for haptic feedback and an optional push-button lock which mates with corresponding hole(s) in the hub of the cylindrical rack assembly. The push-button lock is spring-loaded and can only be pushed in when the grip (or housing) has been fully rotated so that the corresponding hole(s) in the hub of the cylindrical rack assembly are aligned with the push-button lock. For a C-RA, the push-button lock can be used to fix the clutch in a fully-disengaged position. The push-button lock can be implemented so that the lock disengages automatically when the grip is slightly over-rotated.

viii. Mudguard

The mudguard can be slipped onto the housing from the barrel side of the housing. The mudguard can be split to wrap over and under the housing at the handlebar. The split can be closed on the back side of the housing with a built-in rubber fastener. The cable adjuster screws onto the housing barrel after the mudguard is in place and mates with an accordion-like boot which protects the adjuster/housing joint even as the adjuster is turned in or out. A separate mud-boot (much smaller than the mudguard) can be used to protect the clutch cable/adjuster joint. Materials used for the mudguard can be automotive-grade chemical-resistant and UV light-resistant thermoplastic elastomers and synthetic rubber compounds. The mudguard can also be modified as required to accommodate the accessories discussed above.

2. Rotatable Housing

a. Overview of Construction and Operation

FIG. 15B is a perspective view of a handlebar 101 on which is mounted an RA, according to an embodiment of the invention, that can be used with cable-actuated apparatus (e.g., a cable-actuated clutch, in which case the RA is a C-RA) and that is housed in a rotatable housing 1511 (for convenience, sometimes referred to herein as a “rotatable housing RA for cable actuation”). As explained previously and in more detail elsewhere herein, the C-RHA converts the rotational motion of a hand twisting a grip and tube 1512 into the linear pull of a clutch cable (not visible in FIG. 15A, but within the custom clutch cable 1513). As will be appreciated from the following description, many aspects of the construction and assembly of a rotatable housing RHA for cable actuation are the same as, or similar to, those of a stationary housing RHA for cable actuation. A grip and tube 1512 and the rotatable housing 1511 are rotated around the handlebar 101 by hand. As shown in FIG. 15B, an appendage or “finger paddle” 1511a extends from the side plate to enable the index and middle fingers of the hand to apply additional rotational force to the housing. A locking flange of the tube locks into a recessed cutout in a side plate (see FIG. 16B) of the housing 1511 (instead of the core of a rack wheel as in the RHA of FIG. 23D), so that rotation of the grip and tube 1512 produces corresponding rotation of the housing 1511. A large-diameter locked cylindrical rack assembly (a.k.a. locked rack hub, as discussed above, a quarter-gear composed of a toothed arc on a cylindrical hub that is longer than the hub of the rack wheel) is positioned within the housing and locked to the handlebar (e.g., with a collet lock or a plate lock) so that the rack remains stationary relative to the rotatable housing 1511. A small diameter pinion that mates with the locked cylindrical rack assembly is positioned in the housing 1511, so that when the housing 1511 rotates, the pinion gear is rotated about the rack, thereby causing rotation of the pinion. A threaded lead screw extends from the hub of the pinion into the “barrel” section 1502 of the housing 1511. Within the barrel, the screw threads into a female coupler. A guide pin channel is provided on the long axis of the coupler into which a guide pin is inserted to prevent the coupler from spinning in the barrel, as discussed in more detail above, and a receptor hole (a.k.a slotted cable tip recess) is formed in the end of the coupler opposite that into which the screw is threaded to receive the clutch cable tip. Rotation of the pinion (and, thus, the screw) by the rack hub pulls the coupler down the barrel with the clutch cable in tow. The outside of the housing around the barrel is threaded and grooved to mate with a large-diameter cable tension adjuster 1514 (see FIG. 19). The entire housing can be covered with a removable mudguard (similar to FIG. 21).

FIGS. 24A and 24B are open side views of part of a rotatable housing RA for cable actuation according to the invention, illustrating rotation of a housing around a locked cylindrical rack assembly 2401 (e.g. a collet-locked or plate-locked rack) during operation of the RA. A locked cylindrical rack assembly 2401 is positioned adjacent a stop block 900 within a housing 1511 such that the rack of the locked cylindrical rack assembly 2401 meshes with a pinion 1000 In FIG. 24A, the housing 1511 is pictured before rotation of the housing. In FIG. 24B, the housing 1511 has been rotated in a counterclockwise direction. As can be seen, the locked cylindrical rack assembly 2401 is fixed and does not rotate. The stop block 900 rotates with the housing 1511, as does the pinion 1000. As the pinion 1000 moves about the locked cylindrical rack assembly 2401 as a result of rotation of the housing 1511, the pinion 1000 rotates on its axis, in turn rotating a screw (not shown in FIGS. 24A and 24B) that is attached to the pinion 1000.

A rotatable housing that rotates with the RHA handgrip can advantageously enable greater torque to be applied when rotating the handgrip, which can be useful in ensuring that adequate actuation force is applied (e.g., adequate force is applied to disengage a clutch). However, some vehicle operators (e.g., motorcycle riders) may prefer that the grip remain stationary, rather than be allowed to rotate. The RHA according to this embodiment of the invention can be implemented so that the grip is attached directly to the handlebar with no tube underneath, such that the grip is not attached to the rotatable housing. Consequently, the housing can be rotated to produce clutch actuation as described above without rotation of the grip. Such an assembly falls into the superclass of Rotatable Assembly or RA (as compared to a Rotatable Handgrip Assembly or RHA which always features a handgrip on an articulated tube).

b. Modified Components

The following describes aspects of the components of the RA illustrated in FIG. 15B which differ from the corresponding components of the RHA illustrated in FIG. 15A.

i. Rack Hub

In a rotatable housing RA for cable actuation, the rack hub is constructed with a longer hub which runs the full width of the housing. The hub is fitted externally with two sealed bearings which are recessed into each side of the housing, or one wider needle bearing. In one version of the rack hub, the hub is threaded internally with a tapered tap. A collet lock, a collet-like locking insert with tapered external threads, screws into the rack's elongated hub and locks the collet lock and rack hub onto the handlebar as the two are tightened. The collet lock's threads may be left or right-handed to suit the forces present on the left or right side of the handlebar. The collet head is fitted with axial set screws to prevent loosening. The housing is secured in between the rack hub and collet lock, and rotates on the two sealed bearings or wider needle bearings of the rack's elongated hub. Another version of the rack hub incorporates a plate lock design. Inside the rack's elongated hub, multiple radial set screws press inwardly on the plate lock's knurled plate sections to lock the rack hub onto the handlebar. This “flush” design features a narrower profile than the collet lock, and affords an option for the housing known as a pivot clamp. Tooth sizing and rack-to-pinion gear ratios can be implemented as described above for a stationary housing RHA for cable actuation.

As detailed above, the rack hub may be part of a prime pinion/rack hub gear pair, and may also be machined on its inner face with a pattern of grooves for haptic feedback.

ii. Rotatable Control Housing and Options

The rotatable housing includes several changes from the stationary housing. First, the side plate is thickened, e.g., by about 3 mm-4 mm, to house the locking flange of the grip tube. A self-lubricating plastic gasket may be used to separate the side plate and locking flange from the rack hub, and may decrease friction between them. The gasket also seals the gear section from the elements. The side plate may also include a metal appendage (or “finger paddle”) which acts as a leverage point for the index and middle fingers. This leverage point greatly increases finger torque on the housing, and with re-gearing may decrease the amount of rotation required to actuate clutch mechanisms with heavier cable pulls (higher clutch spring forces). In rearward-actuating housings, an optional exterior thumb paddle may be added to the bottom of the housing to provide extra leverage for the rearward actuation.

The housing is widened to accommodate the rack's elongated hub. The bore in the housing for the rack hub may be enlarged to accommodate an increase in rack hub diameter. An additional recess is made on the opposite side of the gear section's bearing recess (from the stationary housing described above). This second recess accommodates the second sealed bearing recommended for a rotatable housing. Alternatively, the housing may utilize cylindrical needle bearings for articulation.

While the advantages of having the grip rotate with the rotatable housing are significant in adding torque, some riders may prefer a stationary grip with no tube. In this case, rotatable housing RAs (i.e., the RAs shown in FIGS. 15B and 15D) can be made without accommodating a rotatable tube and grip at the side plate. The housing and grip are separate, with the grip being attached directly to the handlebar with no tube underneath. When the housing is rotated, the grip does not move. Such an assembly falls into the superclass of Rotatable Assembly or RA (as compared to a Rotatable Handgrip Assembly or RHA which always features a handgrip on an articulated tube).

iii. Mudguard

The mudguard is largely the same as that described above for the stationary housing RHA for cable actuation. Some of the measurements of the mudguard are modified so that the mudguard will fit the modified housing required for rotation. Also to accommodate the rotatable housing, the mudguard includes a larger cutout around the head of the collet lock. This ensures rotation without friction or interference from the interaction of the mudguard with the collet lock's head. The mudguard can also be modified as required to accommodate the accessories discussed above.

B. RAs for Hydraulic Actuation

1. Stationary Housing

a. Overview of Construction and Operation

FIG. 15C is a perspective view of a handlebar 101 on which is mounted an RHA, according to an embodiment of the invention, that can be used with hydraulically-actuated apparatus (e.g., a hydraulically-actuated clutch, in which case the RHA is a C-RHA) and that is housed in a stationary housing 1520 (for convenience, sometimes referred to herein as a “stationary housing RHA for hydraulic actuation”). As explained briefly below and in more detail elsewhere herein, the RHA converts the rotational motion of a hand twisting a grip and tube 1512 into the linear push of hydraulic fluid down a hydraulic clutch line 1523. As will be appreciated from the following description, many aspects of the construction and assembly of a stationary housing RHA for hydraulic actuation are the same as, or similar to, those of a stationary housing RHA for cable actuation. A grip and tube 1512 are rotated around the handlebar 101 by hand. A locking flange of the tube locks into the core of a large diameter rack wheel (as discussed above, a quarter-gear composed of a toothed arc on a cylindrical hub) so that rotation of the grip and tube also rotates the rack wheel. Rotation of the rack wheel rotates a corresponding small-diameter pinion that mates with the rack wheel. A threaded lead screw extends from the hub of the pinion into the “barrel” of the housing 1520. Within the barrel, the screw threads into a piston (a.k.a. plunger). A guide pin channel is provided on the long axis of the piston between the primary and secondary seals of the piston, and into which a guide pin is inserted to prevent the piston from spinning in the barrel, as discussed in more detail above. Rotation of the pinion gear (and, thus, the screw) by the rack wheel pushes the piston down the barrel with hydraulic fluid locked in front of the primary seal. The secondary seal prevents leakage and helps circulate fluid through a fluid reservoir 1524. The housing above the barrel can be machined to form a standard hydraulic fluid reservoir (an integrated fluid reservoir) which feeds fluid to the piston and hydraulic clutch line. Alternatively, the fluid reservoir may be located remotely and connected via a hose to a reservoir feed port on the barrel. (FIGS. 15C, 15D, 27, 33, 34, and 35 illustrate an integrated reservoir). The entire housing can be covered with a removable mudguard (similar to FIG. 21).

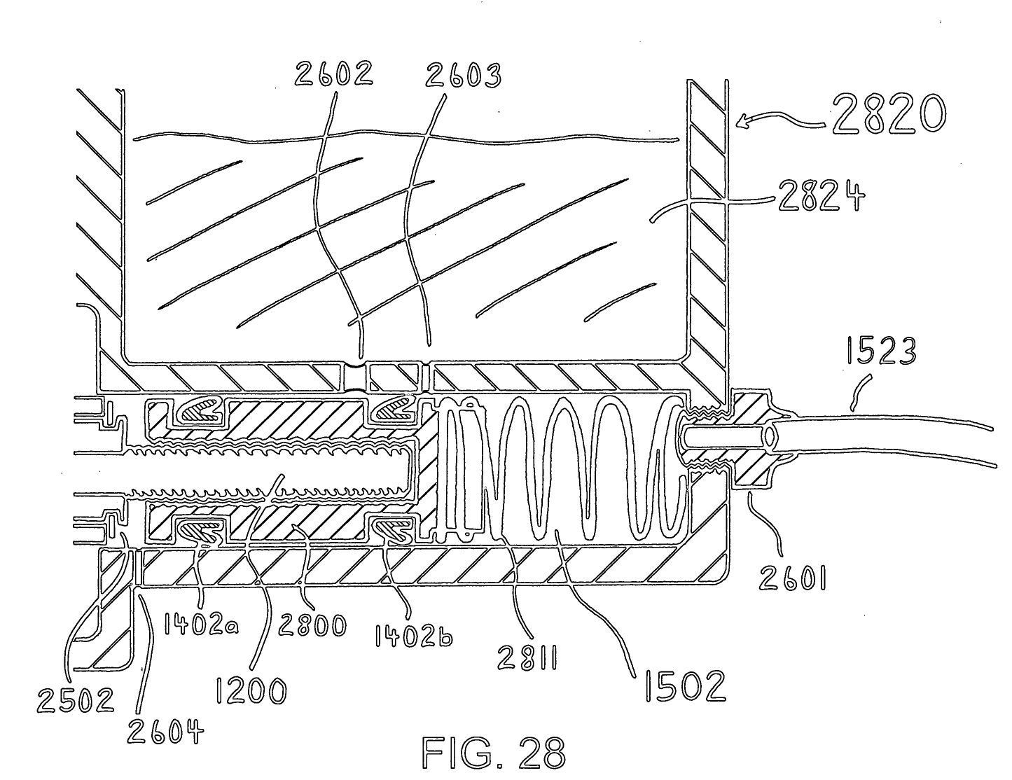

FIG. 28 is a latitudinal cross-sectional view of part of an RA (the barrel section) for hydraulic actuation, according to an embodiment of the invention, illustrating construction and assembly of parts of an RA for hydraulic actuation that are enclosed within a housing 1520. A screw 1200 extends from the pinion hub. An external snap ring 2502 is attached to the pinion hub. The screw 1200 extends into the barrel of the housing 1520 where the screw 1200 is threaded into a piston 1400 positioned within the housing barrel. Hydraulic seals 1402a and 1402b are positioned in corresponding grooves formed in the piston 1400. Fluid inlet port 2602 and compensating port 2603 are formed in the housing barrel to allow exchange of fluid with the fluid reservoir 1524. The piston 1400 pushes hydraulic fluid out of the barrel through a hydraulic line 1523, which is attached to the housing 1520 by a hydraulic fitting 2601, to enable actuation of the apparatus being controlled with the RHA. The drain hole 2604 may be fitted with a filter for off-road use.

b. Modified Components

The following describes aspects of the components of the RHA illustrated in FIG. 15C which differ from the corresponding components of the RHA illustrated in FIG. 15A.

i. Pinion

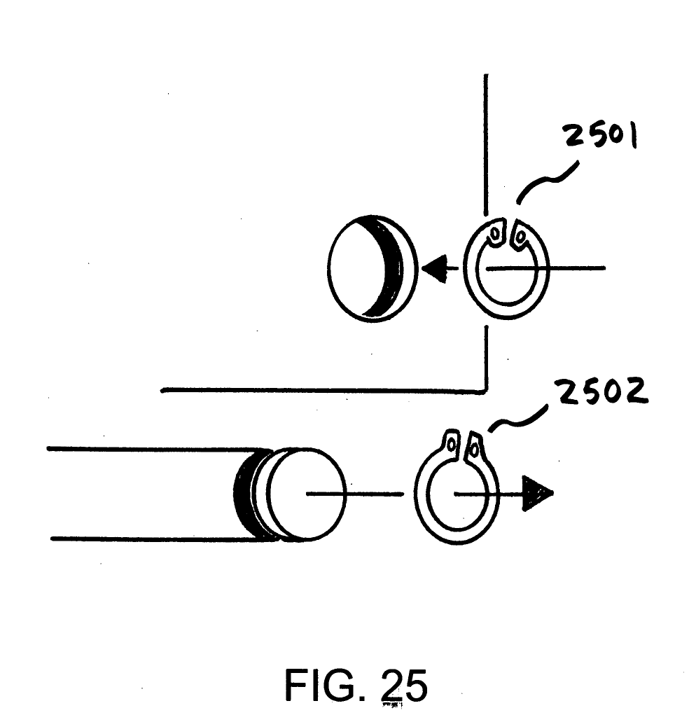

Because of the expansion forces created by pushing a hydraulic piston, the screw, pinion, pinion bearing, and housing need some way of preventing parts from being pushed out of place. For RAs for hydraulic actuation, snap rings (FIG. 25), also known as circlips, can solve the dislocation problem provided that the screw, pinion, and housing are grooved to accept the snap rings. An external snap ring can be used on the innermost rim of the pinion hub to prevent the hub from being pushed through the sealed bearing. An internal snap ring can be used at the outermost rim of the housing's sealed bearing recess to prevent the bearing from being pushed out of the housing. FIG. 25 is a perspective view of an internal snap ring 2501 and an external snap ring 2502 and corresponding grooves that can be used with embodiments of the invention. All other features of the pinion for the stationary housing RHA for hydraulic actuation are as described above for the pinion of the stationary housing RHA for cable actuation. Note that the pinion and hub may be threaded for swapping prime gear sets.

ii. Screw

The screw for the stationary housing RHA for hydraulic actuation may include threads with reversed “handedness” compared to the screw from the stationary housing RHA for cable actuation; this change converts the cable pull into a fluid push. For extra security, the screw may be grooved and fitted with an external snap ring beside the innermost face of the pinion hub. Other than these details, the screw for the stationary housing RHA for hydraulic actuation is as described above for the screw of the stationary housing RHA for cable actuation.

iii. Piston

The piston is the hydraulic equivalent of the coupler. Like the coupler, the bore of the piston can be machined internally with threads which match the screw. However, that's where the similarities end: the coupler is designed to pull a cable, whereas the piston is designed to push hydraulic fluid. The piston includes two grooves which can be machined into the exterior of the piston to accommodate directional hydraulic seals. These seals can be expanding-skirt type synthetic-rubber seals typical of brake master cylinders from Nissin, Magura, and others. The seal materials used need to be compatible with the type of fluid in use (hydraulic mineral oil-compatible for clutch applications, and brake fluid-compatible for brake applications). Some clutch master cylinder designs substitute a conventional o-ring for the secondary seal, presumably for cost and simplicity reasons; the RA piston can be machined for either seal configuration. The o-ring materials used need to be compatible with the type of fluid in use (hydraulic mineral oil-compatible for clutch applications).

Between these seals, the piston includes a similar guide pin channel as described above for the stationary housing RHA for cable actuation. The guide pin prevents the piston from spinning as the screw turns into the piston core. The guide pin channel also limits the range of piston travel so that the primary and secondary seals move in precise relation to the fluid inlet port and compensating port, and may prevent the secondary seal from being pushed past the fluid inlet port. The rest of the piston surface between the seals (and away from the guide pin channel) may be machined with helical or serpentine fluid circulation channels; these channels help move fluid through the barrel and reservoir. Finally, the tip of the piston protrudes just beyond the face of the primary seal and stops the piston as the piston reaches the end of the barrel. The tip does not require a return spring as is typical of lever-operated brake and clutch master cylinders. The spring is not mandatory since the screw makes positioning (pushing or pulling) the piston easy. The lack of a return spring makes the overall barrel length (and thus, the housing width) shorter, and also reduces the total force required to actuate the mechanism.

iv. Stationary Control Housing and Options

As detailed for the pinion of the stationary housing RHA for hydraulic actuation, an internal snap ring can be used at the outermost rim of the housing's grooved bearing recess to prevent the bearing from being pushed out of the housing. Additional changes are required to support the hydraulics: the top of the barrel section of the housing can be machined with a conventional hydraulic fluid reservoir. The reservoir includes a conventional two-screw cap and synthetic rubber gasket insert. The cap may be machined with a bracket to accommodate small levers like those used for compression releases. An exposed face of the reservoir may include a fluid level window. The reservoir drains into the housing barrel through two holes: a large fluid inlet port and a small compensating port. The holes are aligned on the axis of the barrel and are separated by a distance just greater than the length of the piston's primary seal. The pinion end (dry end) of the barrel may include an oil drain hole 2410 or holes near the lowest point of the barrel; these holes may be fitted with filters to prevent dust from entering the barrel. The barrel's other end is drilled above center and tapped with threads to match conventional or quick-release (Staubli) hydraulic line fittings. The exterior of the barrel end is not equipped with a clutch cable adjuster since the hydraulic mechanism is self-adjusting. The gear section of the housing may include a spring-loaded detent for haptic feedback. The clamping options, mounts, switches, locks, and side plate can be the same as those described above for the stationary housing RHA for cable actuation.

v. Mudguard

The mudguard can be slipped onto the housing from the top and covers the reservoir cap and most of the housing. The area over the reservoir cap may include a hole for a compression release lever. The mudguard can be split in two places: along the bottom of the reservoir/barrel section and also at the back of the handlebar section. The barrel split allows the mudguard to wrap over the reservoir and fasten underneath the barrel with a built-in rubber fastener (or other appropriate fastener). The handlebar split allows the mudguard to wrap over and under the housing at the handlebar joint and fasten at the back of the housing with a built-in rubber fastener (or other appropriate fastener). Materials used for the mudguard can be automotive-grade chemical-resistant and UV light-resistant thermoplastic elastomers and synthetic rubber compounds. The mudguard can also be modified as required to accommodate the accessories described above.

2. Rotatable Housing

a. Overview of Construction and Operation

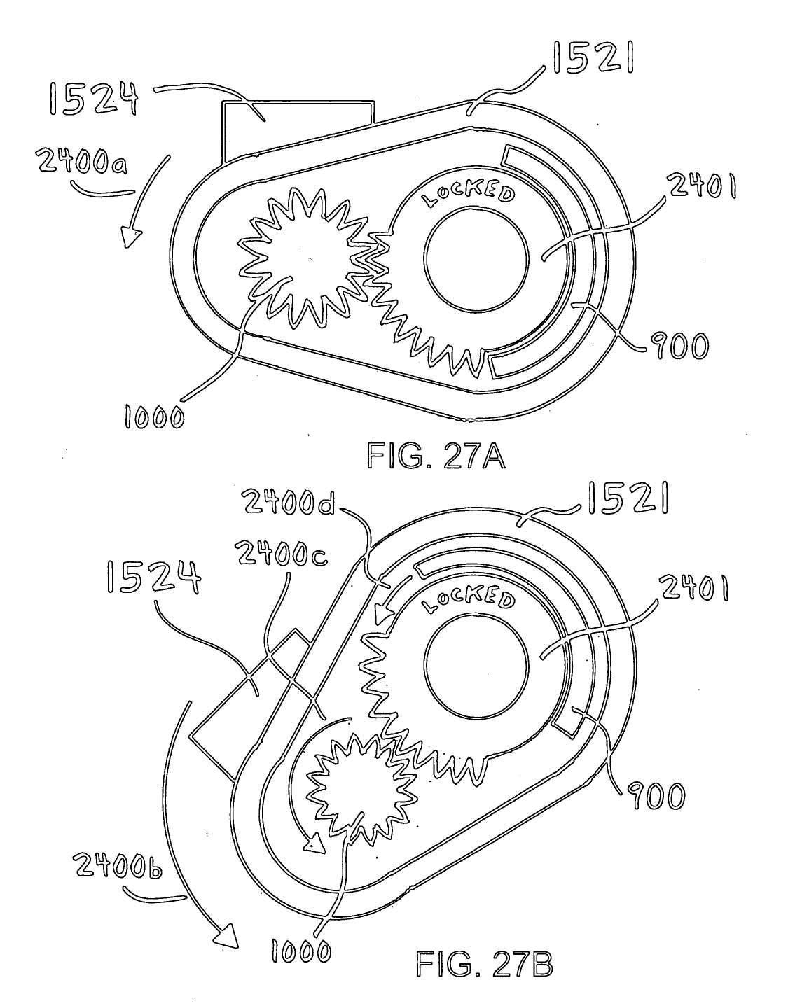

FIG. 15D is a perspective view of a handlebar 101 on which is mounted an RHA, according to an embodiment of the invention, that can be used with hydraulically-actuated apparatus (e.g., a hydraulically-actuated clutch, in which case the RHA is a C-RHA) and that is housed in a rotatable housing 1521 (for convenience, sometimes referred to herein as a “rotatable housing RHA for hydraulic actuation”). As explained briefly below and in more detail elsewhere herein, the RHA converts the rotational motion of a hand twisting a grip and tube 1512 into the linear push of hydraulic fluid down a hydraulic clutch line 1523. As will be appreciated from the following description, many aspects of the construction and assembly of a rotatable housing RHA for hydraulic actuation are the same as, or similar to, those of a rotatable housing RHA for cable actuation and/or a stationary housing RHA for hydraulic actuation. A grip and tube 1512 and the rotatable housing 1521 are rotated around the handlebar 101 by hand (see FIGS. 27A and 27B). As shown in FIG. 15D, an appendage or “finger paddle” 1521a extends from the side plate to enable the index and middle fingers of the hand to apply additional rotational force. A locking flange of the tube locks into a recessed cutout in the side plate (see FIG. 16B) of the housing 1521 (instead of the core of a rack wheel as in the RHAs of FIGS. 15A and 15C), so that rotation of the grip and tube produces corresponding rotation of the housing 1521. A large-diameter locked cylindrical rack assembly (a.k.a locked rack hub, as discussed above, a quarter-gear composed of a toothed arc on a cylindrical hub that is longer than the hub of the rack wheel) is positioned within the housing and locked to the handlebar (e.g., with a collet lock or a plate lock) so that the locked cylindrical rack assembly remains stationary relative to the rotatable housing 1521. A small diameter pinion that mates with the locked cylindrical rack assembly is positioned in the housing 1521, so that when the housing 1521 rotates, the pinion is rotated about the locked cylindrical rack assembly, thereby causing rotation of the pinion (see FIGS. 27A and 27B). A threaded lead screw extends from the hub of the pinion into the “barrel” of the housing 1521. Within the barrel, the screw threads into a piston (a.k.a. plunger). A guide pin channel is provided on the long axis of the piston between primary and secondary seals of the piston, and into which a guide pin is inserted to prevent the piston from spinning in the barrel, as discussed in more detail above. Rotation of the pinion (and, thus, the screw) by the locked cylindrical rack assembly pushes the piston down the barrel with hydraulic fluid locked in front of the primary seal. The secondary seal prevents leakage and helps circulate fluid through a fluid reservoir 1524. The housing above the barrel can be machined to form a standard hydraulic fluid reservoir (an integrated fluid reservoir) which feeds fluid to the piston and hydraulic clutch line 1523. Alternatively, the fluid reservoir may be located remotely and connected via a hose to a reservoir feed port on the barrel. (FIGS. 15D, 27, 33, 34, and 35 illustrate an integrated reservoir). The entire housing can be covered with a removable mudguard (similar to FIG. 21).

FIGS. 27A and 27B are open side views of part of a rotatable housing RA for hydraulic actuation according to the invention, illustrating rotation of a housing around a locked cylindrical rack assembly (e.g. a collet-locked or plate-locked rack) during operation of the RA. A locked cylindrical rack assembly 2401 is positioned adjacent a stop block 900 within a rotatable housing 1521 such that the rack of the locked cylindrical rack assembly 2401 meshes with a pinion 1000. A hydraulic fluid reservoir 1524 is formed as part of the housing 1521. In FIG. 27A, the housing 1521 is pictured before rotation of the housing. In FIG. 27B, the housing 1521 has been rotated in a counterclockwise direction. As can be seen, the locked cylindrical rack assembly 2401 is fixed and does not rotate. The stop block 900 rotates with the housing 1521, as does the pinion 1000 (and hydraulic fluid reservoir 1524). As the pinion 1000 moves about the locked cylindrical rack assembly 2401 as a result of rotation of the housing 1521, the pinion 1000 rotates on its axis, in turn rotating a screw (not shown in FIGS. 27A and 27B) that is attached to the pinion 1000.

A rotatable housing that rotates with the RHA handgrip can advantageously enable greater torque to be applied when rotating the handgrip, which can be useful in ensuring that adequate actuation force is applied (e.g., adequate force is applied to disengage a clutch). However, some vehicle operators (e.g., motorcycle riders) may prefer that the grip remain stationary, rather than be allowed to rotate. The RHA according to this embodiment of the invention can be implemented so that the grip is attached directly to the handlebar with no tube underneath and such that the grip is not attached to the rotatable housing. Consequently, the housing can be rotated to produce clutch actuation as described above without rotation of the grip. Such an assembly falls into the superclass of Rotatable Assembly or RA (as compared to a Rotatable Handgrip Assembly or RHA which always features a handgrip on an articulated tube).

b. Modified Components

Some components of the rotatable housing RA for hydraulic actuation can be produced by combining the aspects of the corresponding components of the rotatable housing RA for cable actuation and the stationary housing RHA for hydraulic actuation, as described above. The housing can be produced by combining the rotatable housing of the rotatable housing RA for cable actuation with the hydraulic section of the stationary housing RHA for hydraulic actuation. The mudguard can also be produced in view of the combination of the rotatable housing of the rotatable housing RA for cable actuation with the hydraulic section of stationary housing RHA for hydraulic actuation.

C. B-RAs: The Rotatable Assembly for Brake Actuation

With the advent of the C-RHA, motorcycle controls design may have evolved to designate levers as stopping controls and rotatable handgrips as acceleration controls (as described above). The use of the C-RHA for clutch control allows a rider to clamp a conventional lever-actuated cable perch (typical for cable-actuated drum brakes) or a conventional lever-actuated master cylinder perch (typical for hydraulic disc brakes) on the left handlebar (or pivot clamp) for rear brake actuation. These lever mounts may work with (dual actuation), or replace (solo actuation), the stock rear brake pedal.

For example, a motorcycle with an automatic clutch mechanism (such as those offered by Rev-Loc and Rekluse) gives a rider the option of using the left hand lever for manual override of the automatic clutch mechanism, or for some other use such as braking. In this situation, the C-RHA may provide additional benefits. Like the lever, the C-RHA may also be used for manual override of the automatic clutch mechanism, but the C-RHA provides the additional benefit of keeping the rider's grasp on the handlebars intact.

However, there may be situations which benefit from using Rotatable Assemblies for stopping. Resuming the previous example, riders who choose not to install a manual override to their automatic clutches may want to use a Rotatable Assembly for braking. With slight modifications, the RAs illustrated and described above with respect to FIGS. 15A through 15D can be applied to brake actuation. Usually, this means rear brake actuation. Most modern motorcycles use hydraulic caliper/disc systems for rear braking, but there are still cable and rod-actuated rear drum brakes in production. The RAs for cable actuation are typically applicable to these drum brakes, while the RAs for hydraulic actuation are typically applicable to hydraulic systems. (Note: there are exceptions, such as Magura's lever-actuated Jack hydraulic master cylinder/slave cylinder replacement for lever-and-cable-actuated controls. Longer S-curved cables can deform and create a spongey feel in the controls. The hose and slave cylinder of the Jack can be mated with the hydraulic B-RHA to improve the feel and response of drum brake systems by adapting the slave cylinder of the Jack to actuate the drum brake).

The shorter stroke required to actuate most hydraulic brakes means that hand and wrist power can be multiplied by “gearing down” the rack wheel or rack hub, pinion, and screw thread pitch. The rack wheel or rack hub's pitch circle diameter may decrease, while the pinion pitch circle diameter may increase to. “amplify” muscle input. The screw's thread pitch may also flatten or decrease (while remaining in the overhauling/backdriving class) for additional mechanical advantage.

Piston seals for braking applications need to be expanding-skirt type for safety and reliability (it is typically un-advisable to use o-ring secondary seals for braking). The seal materials used need to be compatible with the type of fluid in use (DOT-X brake fluid-compatible for brake applications). Brakes lack the built-in springs of the clutch plates; the barrel of the B-RA may be equipped with a return spring to simplify assembly and to ensure a rebound effect when the control is released.

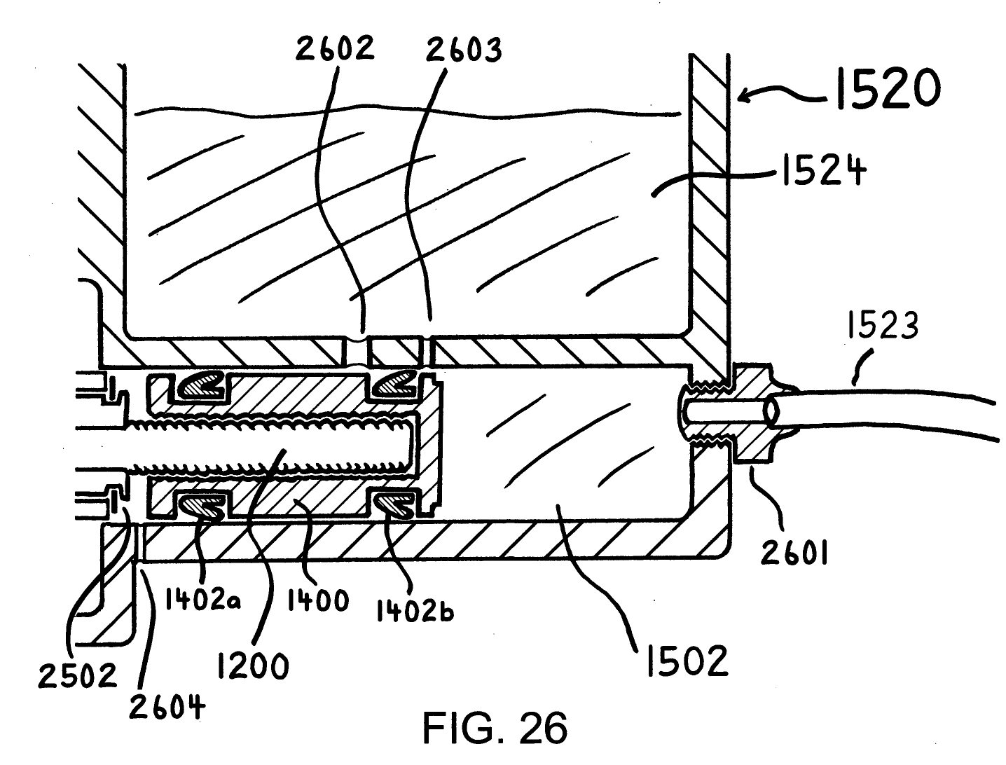

FIG. 28 is a latitudinal cross-sectional view of part of a B-RA for hydraulic actuation, according to an embodiment of the invention, illustrating construction and assembly of parts of a B-RA for hydraulic actuation that are enclosed within the extended housing 2820. In general, the parts of the B-RA are the same as those discussed above with respect to FIG. 26 (note the correlating part numbers), and the interaction of those parts is also generally as described for FIG. 26. Key differences are in the extended reservoir 2824, extended housing 2820, and the extended tip of the piston 2800 in order to accommodate the presence of the return spring 2811 in the barrel section 1502. Also, materials used for seals and O-rings may need to be swapped for brake-fluid-compatible materials.

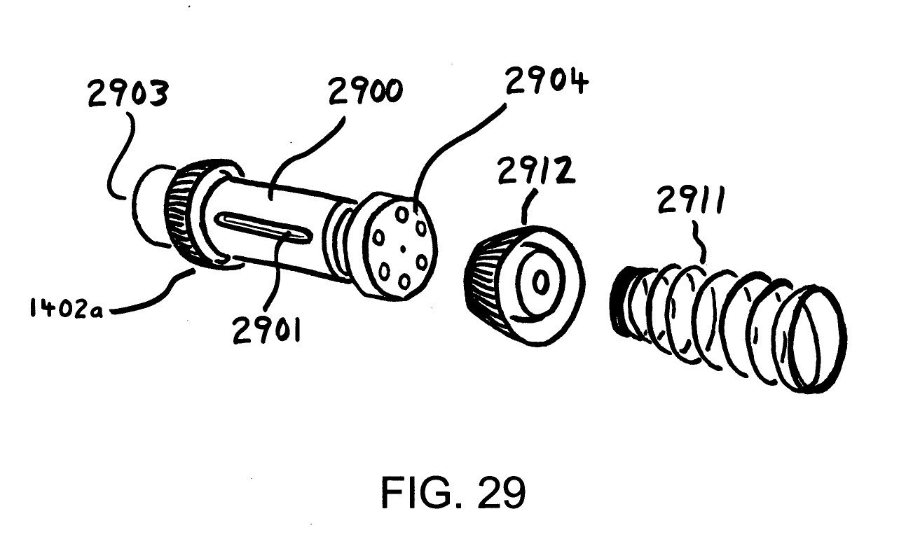

Alternatively, FIG. 29 illustrates that a frontal primary seal 2912 may be attached to the piston end of a tapered return spring 2911 so that the piston's face 2904 can be drilled with tiny flow holes. These flow holes help the B-RA piston 2900 rebound more quickly when the brake is released. Note that the other components shown in FIG. 29, such as the secondary seal 1402a and guide pin channel 2901, are very similar to the parts previously described of the same names.

The stroke of most cable and rod-actuated rear drum brakes is slightly longer than that of rear hydraulic discs. The B-RA for cable actuation is designed to match that stroke while still providing maximum force multiplication. As detailed above, the B-RA for cable actuation may be used in concert with the foot-actuated rear brake pedal. Consequently, the lower end of the B-RA cable may connect to a secondary arm (described below) which forces that rear brake pedal forward to actuate the rear brake. The secondary arm assembly is an auxiliary device that may make use of the stock clutch cable in many applications.

In many cases, the B-RA works as a secondary actuator for dual control. This means that the stock foot-actuated rear brake pedal works normally until conditions may require the rider to extend his or her right leg for extra stability. With the right leg extended, the rider cannot operate the rear brake pedal with the right foot. The B-RA works as a secondary actuator by affording the rider another way to apply the rear brake.

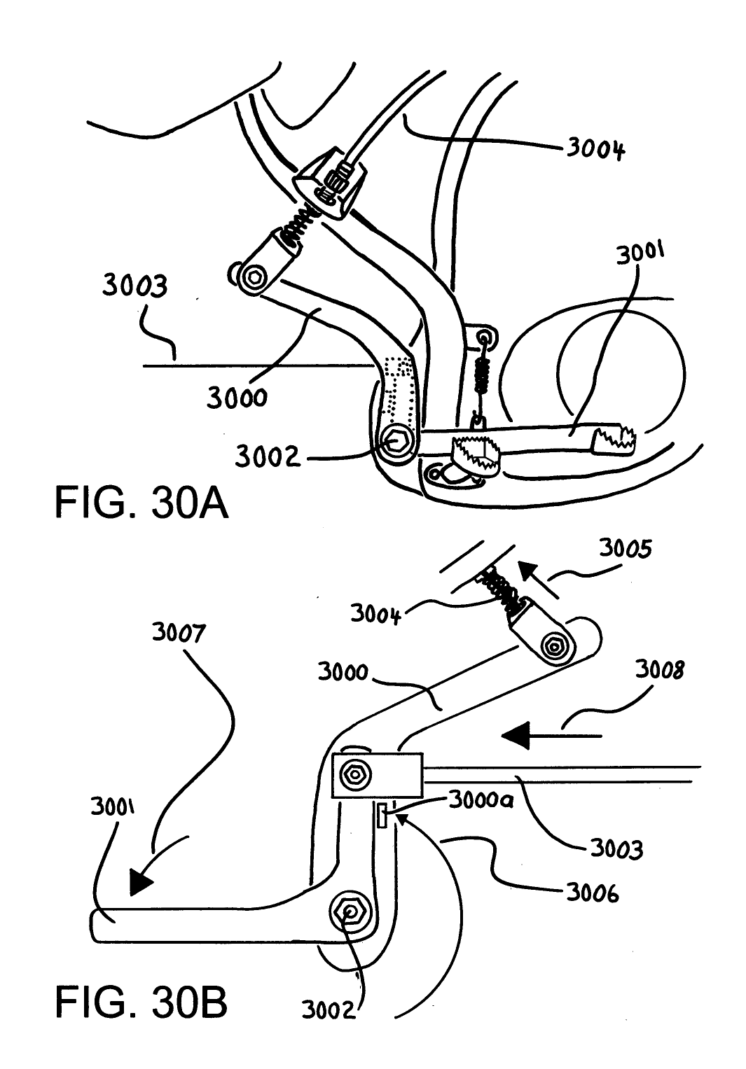

For rear drum systems, the cable-actuating B-RA's coupler pulls a custom cable, 3004 in FIG. 30A, that is connected to an auxiliary device: the secondary arm. The secondary arm 3000 and the rear brake pedal 3001 share a common pivot point 3002. As it moves upward under the force of the cable (see arrow 3005 in FIG. 30B), the secondary arm 3000 rotates (arrow 3006 in FIG. 30B) and contacts the rear brake pedal at the push-point 3000a in FIG. 30B. This forces the rear brake pedal 3001 forward (and downward, see 3007 in FIG. 30B) to actuate (arrow 3008 in FIG. 30B) the rear brake via the rod 3003. When the rider's foot returns to the brake pedal and depresses the brake pedal, the secondary arm remains still; this prevents the secondary arm from feeding cable slack back to the B-RA mechanism. Alternatively, a hydraulic B-RA can be connected to the hose and slave cylinder of Magura's Jack system to eliminate the spongey feel created by longer S-curved cables. The metal tip of the slave cylinder is subsequently adapted to actuate the rear brake, potentially through the use of a secondary arm to actuate the rear brake pedal.

For hydraulic systems, the hydraulic B-RA's output is connected with a hydraulic brake line. The system can be “plumbed” in one of several ways. First, the rider may choose to bypass or remove the rear brake pedal/rear master cylinder entirely and connect the hydraulic B-RA directly to the brake caliper with a new longer brake line. Secondly, the rider may choose dual actuation. In this case, the brake line is routed into a junction valve, such as those offered by Rekluse & GP Tech L.L.C., which replaces the stock rear master cylinder's fluid reservoir fitting (and eliminates the reservoir). Then the hydraulic B-RA reservoir feeds both the B-RA piston and the rear master cylinder's piston through the junction valve. Unfortunately, a different junction valve must be must be offered for each model of rear master cylinder since the fluid reservoir fittings vary significantly between manufacturers, and the tiny fluid inlet holes cause extra resistance when squeezing the secondary brake lever.

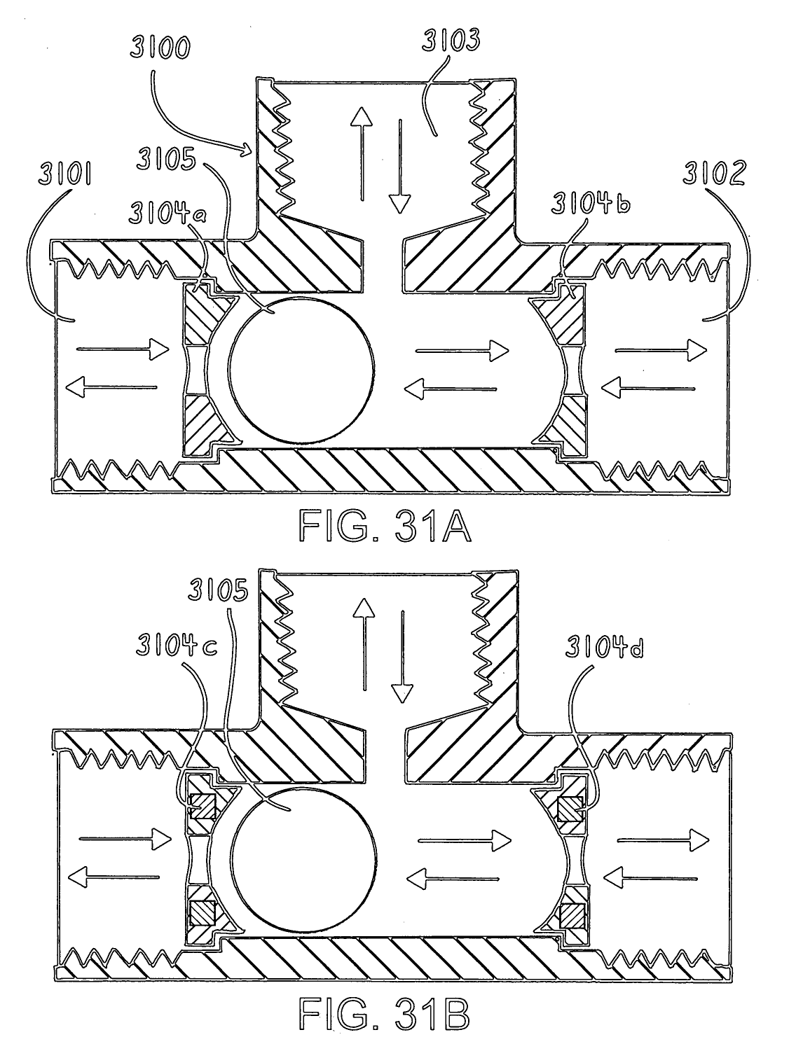

There are other possibilities for dual actuation. The switch valve 3100 in FIG. 31A, and the magnetic switch valve of FIG. 31B, are variations on a common theme: utilize the rear brake pedal master cylinder assembly “as-is” by connecting the hydraulic B-RA to the switch valve assembly using common, off-the-shelf fittings such as 10 mm two-inlet “banjo” bolts with copper or aluminum washers. Both types of switch valve mechanisms route hydraulic forces from either the brake pedal's master cylinder piston, or the B-RA's piston, to the rear brake caliper. Whichever master cylinder is inactive gets sealed off by the switch valve to prevent misdirected fluid forces from flooding the inactive master cylinder's fluid reservoir.

The switch valve and the magnetic switch valve include three ports. The ports are threaded to match standard hydraulic fittings and adaptors such as the 10 mm “banjo” type fittings offered by Goodridge Inc. and others. Port 1 (3101 in FIG. 31A) and port 2 (3102 in FIG. 31A) are co-linear, oppose each other, and share the same bore, while port 3 (3103 in FIG. 31A) is typically above and orthogonal to the common axis of ports 1 and 2. Typically, port 3 will connect to the rear brake caliper using the existing brake line and stock banjo bolt. Port 1 will connect to the B-RA and port 2 will connect to the stock rear brake master cylinder. In both cases, the most convenient/most available fittings and adaptors may be used.

All three of the ports are 2-way: fluid may travel in either direction through the ports. However, the valve is designed to switch the flow of fluid forces between the B-RA and the rear brake master cylinder to the rear brake caliper. Consequently, ports 1 and 3 may be active while port 2 is sealed off, then the switch occurs, and ports 2 and 3 may be active while port 1 is sealed off.

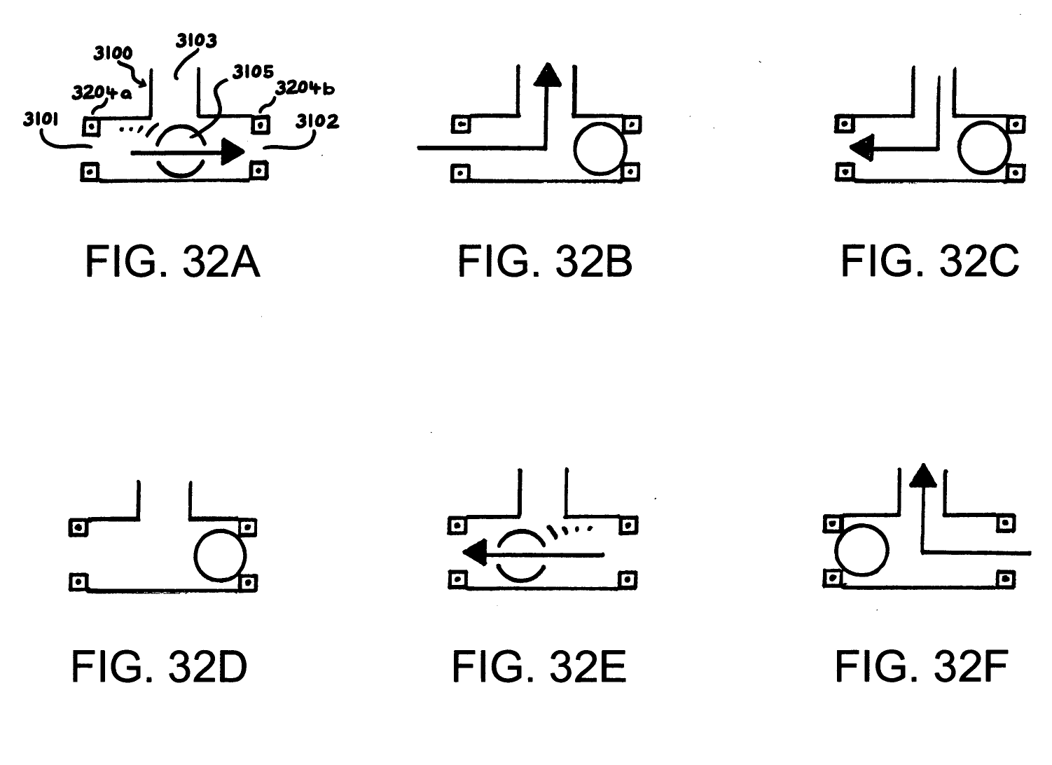

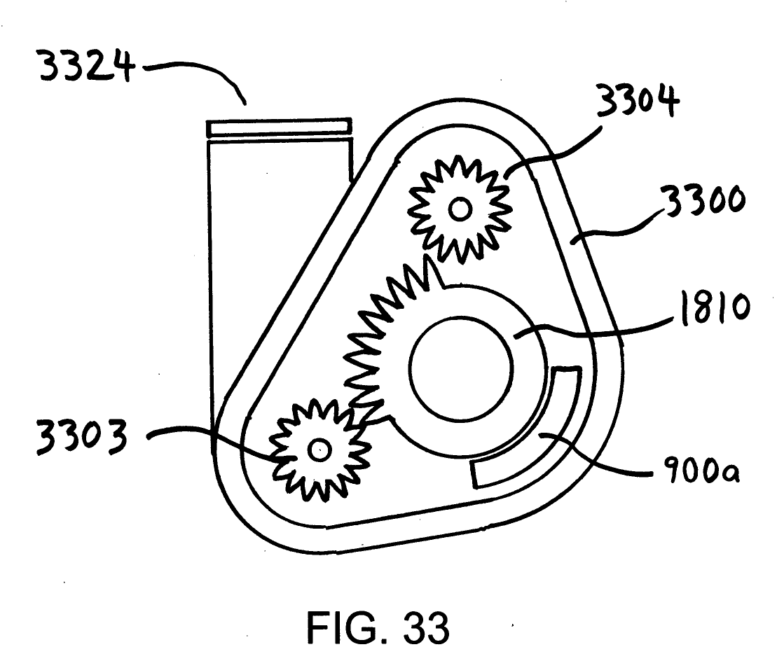

The switch (illustrated in the simplified illustrations of FIGS. 32A through 32F) occurs when the rider alternates between hand actuation (B-RA) and foot actuation (rear brake pedal). Fluid forces from the most recently actuated control force the switch to occur inside the switch valve. In FIG. 32A, a simplified set of the corresponding components from FIGS. 31A and 31B are shown: the switch valve is 3100, port 1 is 3101, port 2 is 3102, and port 3 is 3103. The ball 3105 is contained between two generic retaining seals 3204a and 3204b, which may be interpreted to be non-magnetic or magnetic for this illustration.

In FIG. 32A, the master cylinder connected to port 1 (3101) has just been actuated, and the ball 3105 is being forced toward retainer seal 3004b. In FIG. 32B, the ball has completed the switch, and port 2 (3102) is sealed off while the fluid from port 1 continues out of port 3 (3103) to actuate the slave cylinder connected to port 3. In FIG. 32C, the pressure from the master cylinder connected to port 1 has been released, and fluid from the slave cylinder connected to port 3 is beginning to move backward. In FIG. 32D, equilibrium has been reached, and hydrostatic and/or magnetic forces are holding the ball 3105 in place. In FIG. 32E, the master cylinder connected to port 2 has been actuated, and the ball 3105 is being forced back toward retainer seal 3204a. In FIG. 32F, the ball has completed the switch, and port 1 is sealed off while the fluid from port 2 continues out of port 3 to actuate the slave cylinder connected to port 3.

In the regular switch valve, a precision (grade 3) ball bearing (3105 in FIGS. 31A and 31B), or precision rod segment (both rust-proof; usually metal) is forced from one side of the valve to the other as the alternate control is actuated. The ball 3105 presses against one of two ported retainer seals, 3104a and 3104b, to complete the switch. The connection between that most recently actuated control and the rear brake caliper is held open by hydraulic fluid forces. In the magnetic switch valve (FIG. 31B), ring magnets of matching strength (which may be encased in fluid-proof plastic) are molded into the retainer seals 3104c and 3104d in FIG. 31B, with one regulating each end of the main bore. These magnetic forces help lock the ball or rod segment in place after each switch occurs, and may improve switching performance in extremely rough conditions.

The ring magnets encased in magnetic retainer seals 3104c and 3104d in FIG. 31B will be oriented within their respective moldings and marked or colored such that the magnetic poles of 3104c and 3104d will attract each other when placed into opposite ends of the main bore; this simplifies the assembly process. For example, 3104c may be molded in a red plastic compatible with brake fluid, and 3104d may be molded in blue plastic (also compatible with brake fluid), One blue seal would always be paired with one red seal such that their respective internal magnets would attract each other when properly inserted into ports 1 and 2. The ball 3105 or rod segment for the magnetic switch valve needs to be formed from a metal that is magnetically-attractable and rust-proof. Often this choice will be chrome-plated steel. In addition, the ball 3105 or rod segment and the main bore of the switch valve 3100 (between ports 3101 and 3102) should be formed with a large enough diameter and/or length, relative to the diameter of the bore intersection of port 3, to maintain an occlusion of port 3 as the ball or rod segment passes by port 3 mid-switch.

The switch valve as described above will likely be implemented in a self-contained external enclosure, similar to a conventional hydraulic “T” fitting. This external enclosure will be mounted at the intersection of the rear brake master cylinder and rear brake hydraulic line in order to accommodate the junction with the new B-RA hydraulic line. However, other applications of the switch valve, such as providing for both lever-actuation and B-RA actuation of the rear brake, may require the switch valve to be relocated to the handlebar region, or even to be built into the housings of various controls.

The final option for hydraulic dual actuation should be familiar. The secondary arm from the rod-actuated rear drum system may also be used on hydraulic brakes since the secondary arm/pedal connection is strictly mechanical. The rear brake pedal which actuates the rear master cylinder can be fitted with the secondary arm in the same way used for the rear brake pedal of the rear drum. The connection to the B-RA and the type of B-RA used can be the same as described in the rear drum section above.

This section focused on the B-RA and the accessories required to use it as a secondary actuator for the rear brake. Note that each of these accessories (such as the secondary arm, junction valve, switch valve, etc.) for secondary actuation of the rear brake with a B-RA can alternatively be used with its corresponding conventional lever-actuated cable or lever-actuated hydraulic assembly.

D. X-RAs: The Rotatable Assembly as a Compound Actuator

There is an additional class of RA which can best be described as a compound or multi-actuator. Actuation of multiple systems can be combined into one RA, e.g., a BC-RA (a combination of brake and clutch control), or a TB-RA (a combination of throttle and brake control). This may be deemed desirable by some riders.

The simplest way to describe “compounding” is dual-actuation within a single X-RA. For example, a single rack wheel or rack hub assembly may act on two different pinion/screw mechanisms at different points in the rotary arc of the assembly (FIG. 33). Recall that the cylindrical rack assembly (e.g. rack wheel or rack hub) 1810 is a sector gear which, with precision design, can consistently engage and disengage from non-free-spinning bounded-rotation pinion/screw mechanisms, such as 3303 and 3304. The cylindrical rack assembly 1810 rests at a neutral or center point of its rotational arc. Rotating forward, the rack of the cylindrical rack assembly precisely engages the lower pinion/screw mechanism 3303 for brake actuation. Afterward, the cylindrical rack assembly returns to the neutral point. Rotating backward, the rack precisely engages the upper pinion/screw mechanism 3304 for clutch actuation. Custom X-RA housing 3300, custom reservoir 3324, and custom-length stop block 900a complete FIG. 33. One Rotatable Assembly actuates two systems independently by rotating forward or backward: dual-actuation within a single X-RA.

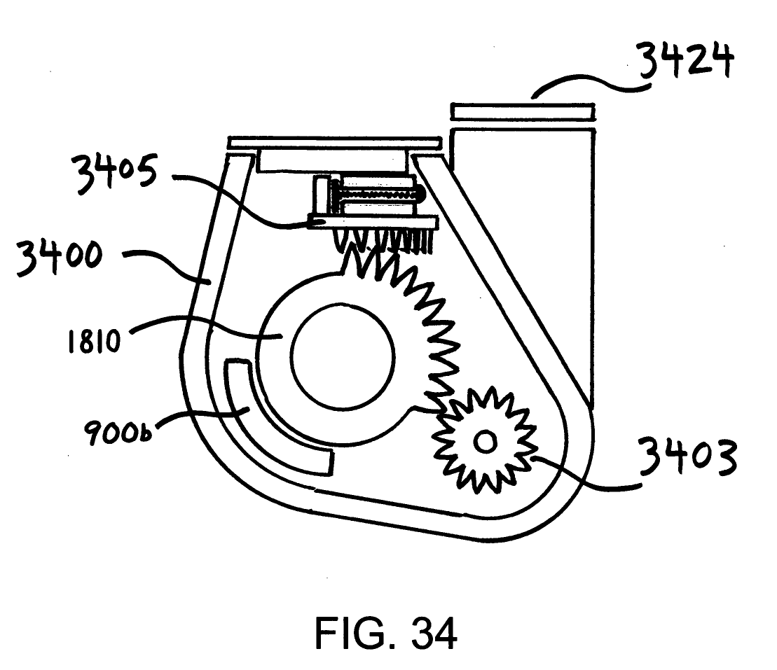

Or, for example, on the right side of the handlebar, a single cylindrical rack assembly (FIG. 34) may act on two different gear mechanisms at different points in the rotary arc of the assembly. The cylindrical rack assembly 1810 rests at a neutral or center point of its rotational arc. Rotating forward, the cylindrical rack assembly 1810 engages the lower pinion/screw mechanism 3403 for brake actuation. Afterward, the cylindrical rack assembly returns to the neutral point. Rotating backward, the cylindrical rack assembly 1810 engages the upper face gear/cable sheave 3405 for throttle actuation. Custom X-RA housing 3400, custom reservoir 3324, and custom-length stop block 900b complete FIG. 34. One Rotatable Assembly actuates two systems independently by rotating forward or backward: once again, dual-actuation within a single X-RA.

Note that while the two previous examples utilized a rotatable cylindrical rack assembly in a stationary housing, other X-RAs may be constructed with rotatable housings and locked cylindrical rack assemblies, such as those illustrated in FIGS. 24A, 24B, 27A, and 27B.

In the two previous examples, the rack assembly alternated between actuating two independent pinions. It may be desirable for some applications to have the rack assembly turn two or more pinions simultaneously or sequentially as it travels through its arc of rotation. For example, if the rack assembly 1810 of FIG. 33 were lengthened (more teeth filling out a longer arc), it could engage both pinion/screw mechanisms 3303 and 3304 either sequentially or simultaneously, depending on the amount the rack assembly was lengthened by. Naturally, the stop block would be shortened by an amount equal to the increase in rack assembly length, or the stop block could be removed altogether in order to increase the rotational travel of the rack assembly.

Any of the above X-RA compound actuators can utilize: 1.) a stationary housing with a rotatable RHA handgrip, 2.) a stationary housing without a rotatable RHA handgrip, instead using a rotatable locking flange collar and tube levers, 3.) a rotatable housing and RHA handgrip with a stationary rack hub and collet lock or plate lock, or 4.) the same rotatable housing without a rotatable RHA handgrip, instead using finger and thumb paddles for actuation. In the next section, an implementation is described that utilizes a rotatable housing and RHA handgrip with a stationary rack hub and collet lock or plate lock.

E. X-RA Hybrids

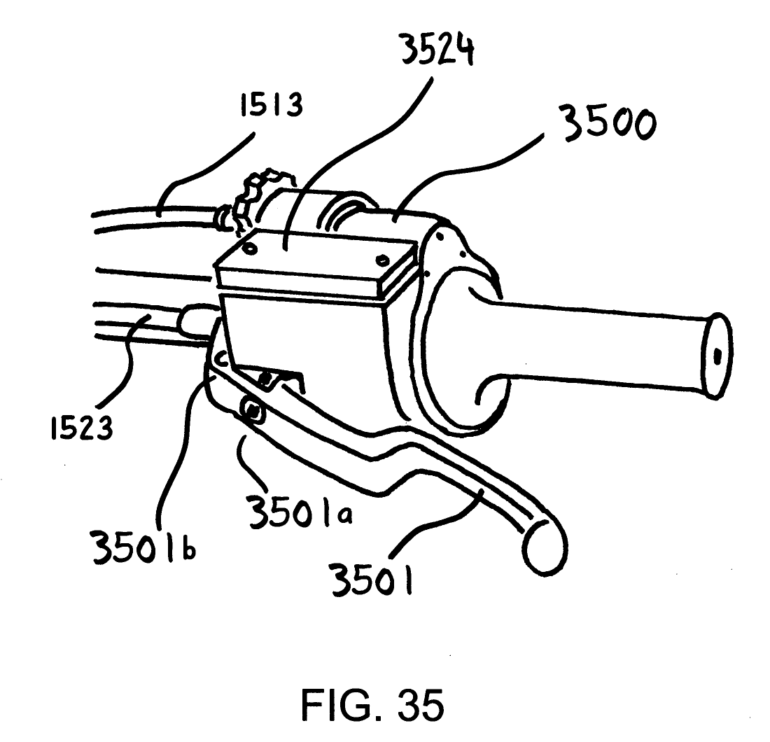

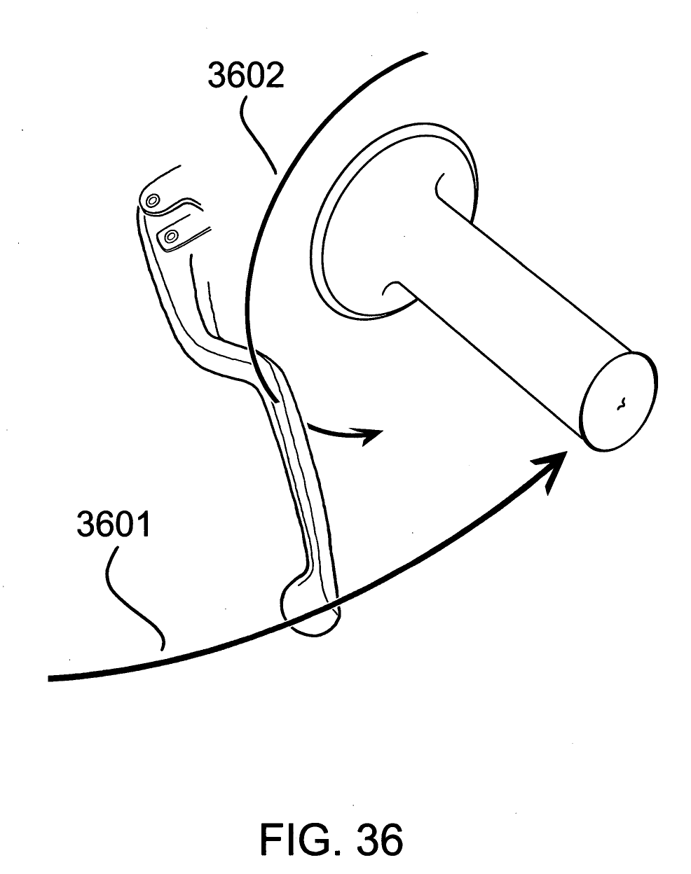

In this implementation, a lever-operated radial master cylinder and reservoir is combined with a C-RHA in a custom rotatable housing (FIG. 35). This X-RHA Hybrid utilizes a custom rotatable housing and RHA handgrip with a stationary rack hub and a collet lock or plate lock. Note that in this example, the master cylinder (behind lever/piston joint 3501a in illustration) is a radial design as opposed to the more conventional axial design. The radial design may integrate more easily with the custom X-RHA housing 3500. The lever/housing joint 3501b, radial master cylinder (inside housing 3500), and custom reservoir 3524 are built into the X-RHA's rotatable housing. Here, the lever 3501 for hydraulic actuation rotates with the X-RHA housing to provide extra torque for the rider's hand when rotating the housing. This is achieved when the rider extends one or more fingers onto the lever's top edge and presses down on the lever as he rotates the RHA handgrip and housing. FIG. 36 illustrates how the lever becomes a dual-axis tool. In the first axis 3601, the lever creates a conventional horizontal arc when it is pulled in toward the RHA handgrip to actuate the lever's control (via hydraulic line 1523 of FIG. 35). In the second axis 3601, the lever creates an unconventional vertical arc as it is pressed down and around the handlebar in sync with rotation of the RHA handgrip to actuate the X-RHA's clutch control (via cable 1513 of FIG. 35). In both cases, the lever provides additional leverage. In addition, the plane defined by the lever's horizontal arc maintains a fixed radial position relative to the rider's hand on the RHA handgrip since the lever, hand, and handgrip rotate together. This feature guarantees the rider will always have an optimal straight pull on the lever. The rotatable lever moves, but remains fixed relative to the rider's hand rotating the RHA handgrip, housing, and lever as the clutch is being engaged and disengaged. This straight pull maximizes finger strength due to the optimal positions of the wrist and thumb on the grip. This feature is possible because of the RHA handgrip's rotation with the lever and housing of the X-RHA. If the RHA handgrip did not rotate with the lever and housing, the rider would experience a decrease in lever finger strength due to the bend created in his wrist as the lever and grip rotated away from each other. In addition, the force of his finger contraction on the lever would convert from an optimal radial force vector to a compromised tangential force vector.

In the foregoing implementation, the force required to rotate the X-RHA is decreased by the radial leverage provided by the integrated lever, and the optimal straight pull of the lever is maintained for the hand during that rotation. While manufacturers such as Magura have combined controls (such as throttle and brake lever) into a single housing for many years, the function and usability of either of those controls has not been improved by the combination. Furthermore, the choice of lever-actuated brake and RHA-actuated clutch provides the most consistency of vertical leverage for clutch actuation since the brake lever's range of motion in the horizontal plane is much smaller than the clutch lever's range of motion in the horizontal plane. This is like having a consistently longer radial lever.

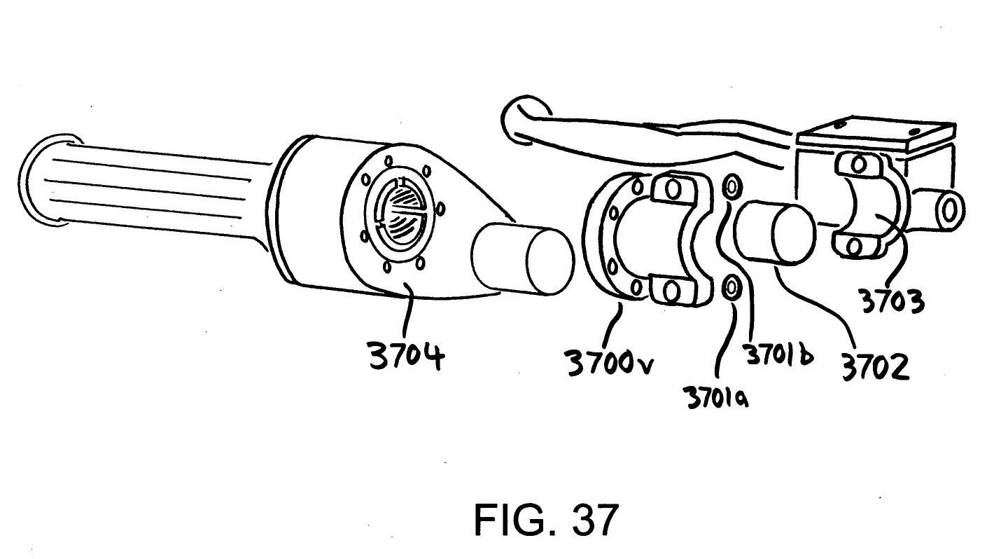

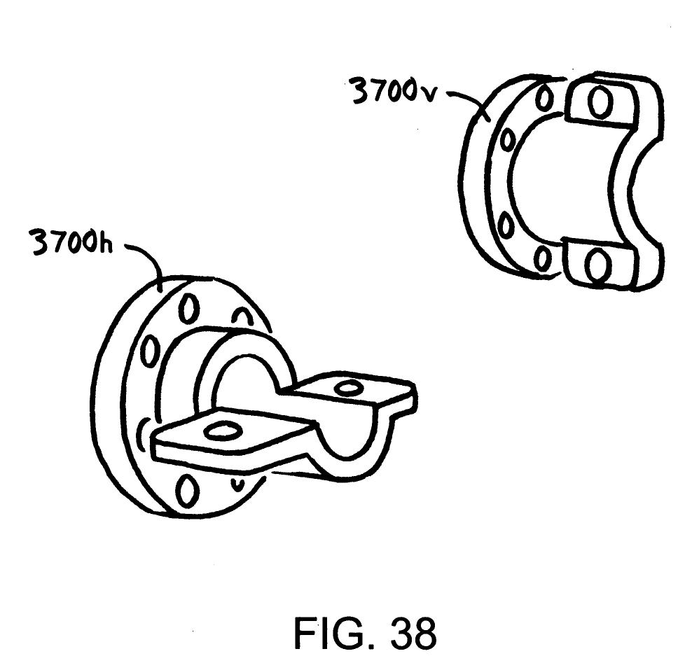

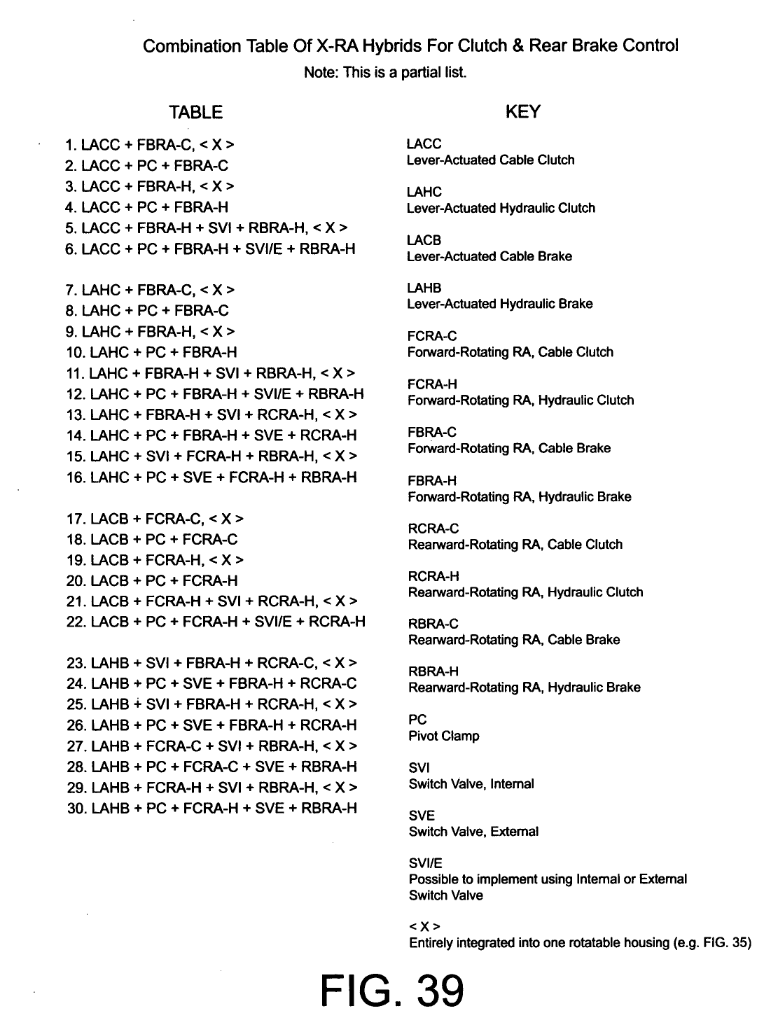

Another implementation of compound actuation with a rotatable housing X-RHA features a pivot clamp addition. (FIG. 37, illustrated without screws for clarity). The pivot clamp 3700v accommodates conventional lever-actuated perches (3703, hydraulic perch assembly shown) by replacing the clamp portion of the perch (see 106 in FIG. 1A). Instead of pinching the handlebar with the stock clamp, the perch is mounted to the pivot clamp 3700v with the 2 stock bolts (not shown). Rather than pinching the handlebar, however, the pivot clamp is designed to provide just enough clearance with its spacer washers 3701a and 3701b to allow the perch to pivot around the handlebar while still remaining securely fastened to the handlebar. The pivoting action can be facilitated with a thin, self-lubricating plastic bushing 3702 which fits around the handlebar. Note that each pivot clamp (FIG. 38) is designed to match a corresponding lever and perch, and can be made to accommodate both vertical 3700v and horizontal 3700h perch clamp designs.

The left end of the pivot clamp mounts to the rotatable housing of a plate-locked X-RHA (3704 of FIG. 37, generic plate-locked X-RHA shown). This connection enables a conventional lever/perch 3703 to provide a significant leverage increase for actuating the X-RHA in the forward direction. This is achieved when the rider extends one or more fingers onto the lever's top edge and presses down on the lever as he rotates the RHA handgrip and housing. The lever becomes a dual-axis tool (as illustrated in FIG. 36). In the first axis, the lever creates a conventional horizontal arc when it is pulled in toward the RHA handgrip to actuate the lever's control. In the second axis, the lever creates an unconventional vertical arc as it is pressed down and around the handlebar in sync with rotation of the RHA handgrip to actuate the X-RHA's control. In both cases, the lever provides additional leverage.

Note that the words “brake” and “clutch” appear nowhere in the description of the controls of FIG. 37. Pivot clamps are designed to match the type of perch to be mounted. This allows riders with preferences for particular lever/perch assemblies to satisfy their preferences and still gain the advantages of a Rotatable Assembly. Just as in the first example of X-RA Hybrids, the choice of lever-actuated brake and RA-actuated clutch provides the most consistency of vertical leverage for clutch actuation since the brake lever's range of motion in the horizontal plane is much smaller than the clutch lever's range of motion in the horizontal plane. This is like having a consistently longer radial lever. However, riders having extensive experience with particular lever-actuated clutch controls may prefer to continue using those lever-actuated clutch controls instead of having to re-master a new control.

For these riders, the pivot clamp can mate their preferred lever and perch to a Brake-Rotatable Assembly (B-RA). This way the rider still gains the benefit of secondary rear brake actuation.

The hydraulic lever and perch assembly (3703) shown in FIG. 37 could just as easily have been a cable-actuating lever and perch (FIG. 1A). The generic plate-locked X-RHA (3704) shown in FIG. 37 could feature a cable or hydraulic internal mechanism. The point is to illustrate the flexibility of combinations of controls which can result from employing the pivot clamp in X-RA Hybrid assemblies. To further that point, a partial spectrum of left-handlebar control combinations that are possible using rotatable housing X-RAs, pivot clamps, switch valves, and conventional lever/perch controls is listed in the table of FIG. 39.

Other combinations of X-RA Hybrid compound actuators are possible and may occupy the right or left side of the handlebars. For example, a rider with right hand weakness or disability may need to combine actuators on his left-hand side. No doubt other situations and special needs will arise for the X-RAs and X-RA Hybrids.

F. RAs for Other Applications

As indicated above, the basic Rotatable Assembly has many uses beyond motorcycle controls. A Rotatable Assembly in accordance with the invention can be mounted on many types of bars, handles, and handlebars. A Rotatable Assembly in accordance with the invention can be useful for actuating linear mechanisms such as cables, rods, arms, hydraulic pistons, plungers, switches, valves, and other linear devices.

The mechanism can be limited to a fixed range which matches one forward and backward movement of the human hand/wrist; this is similar to the range of a doorknob with a spring-loaded latch. This short-stroke application requires few if any modifications to apply to displacing short-stroke linear mechanisms such as cables, rods, arms, hydraulic pistons, plungers, switches, valves, and other linear devices.

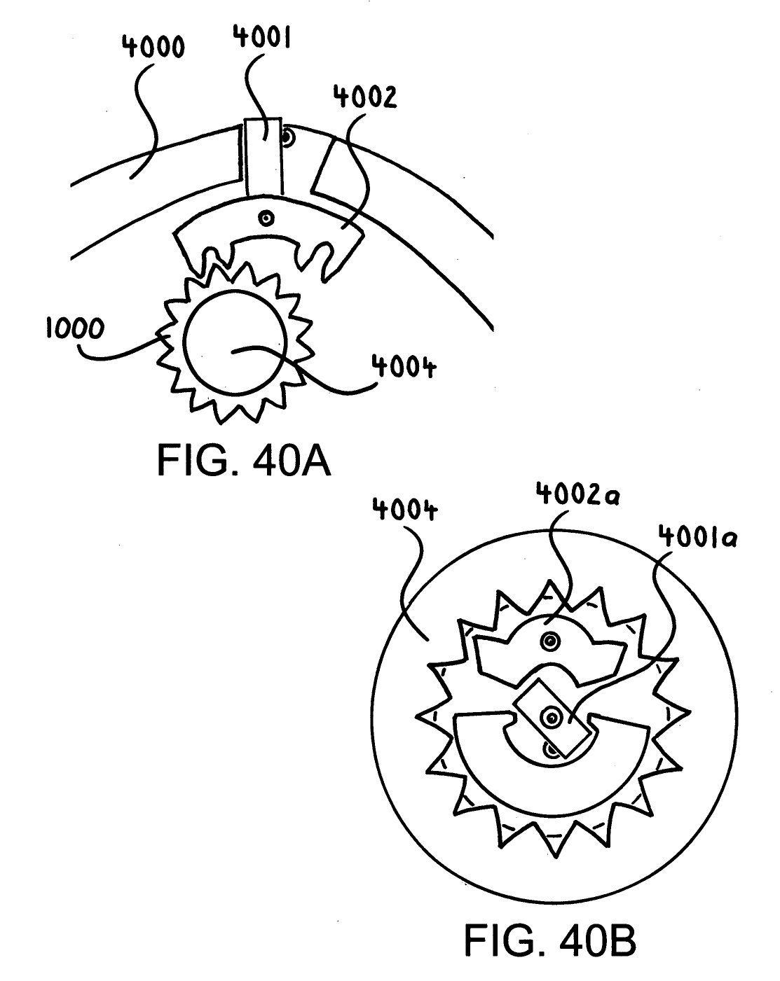

Alternatively, the mechanism can incorporate ratcheting assemblies (FIGS. 40A and 40B) similar to the ratchet of a hand-cranked winch or socket wrench/ratchet drive mechanism. These assemblies may provide a continuous directional drive action by temporarily locking the drive of the mechanism as the hand releases the grip to re-position (re-grip), or as the hand re-positions the handgrip by rotating it backward to continue a forward drive (constant grip).

In FIG. 40A (an open side view), a tangential ratchet mechanism 4002 with a rocking forward and reverse drive selector 4001 is integrated with the pinion 1000 of the ratchet-equipped housing 4000 (housing modified to accommodate ratchet assembly). This drive selector is positioned at the top of the housing for easy access by the thumb or fingers, and may include a spring-loaded detent (shown partially occluded) to secure the drive selector in the chosen drive direction. The circle 4004 marks the center region of the pinion, which may be revised to accommodate an alternative ratchet mechanism detailed below.

An alternative to the tangential ratchet mechanism of FIG. 40A follows. In FIG. 40B (an opposing interior view to FIG. 40A), an axial ratchet mechanism 4002a with a shaft-mounted forward and reverse drive selector 4001a is made for the revised core 4004 of the pinion (see 4004 in FIG. 40A). The pinion may be manufactured with a larger diameter and core, and both external and internal teeth. The axial ratchet mechanism fits into the revised core 4004 of the pinion, and may include its own washers, bushings, or bearing(s). The shaft-mounted forward-and-reverse drive selector exits the side plate for easy access by the fingers, and may include a spring-loaded detent (shown partially occluded) to secure the selector in the chosen drive direction. The configuration shown in FIG. 40B can be implemented in a conventional housing without making modifications to the housing for the drive selector. The axial ratchet assembly is incorporated with the side plate, and the axial drive selector exits a matching hole in the side plate of the housing.

The differentiator for ratcheting applications is whether the user's hand maintains a constant grip or re-grips the RA for each turn. In the two previous examples, the ratcheting assemblies and housings were configured for re-grip applications. For some uses, re-grip applications may be deemed more practical for ratchet-equipped RAs and may require stationary housings. However, rotatable housings may apply to special cases such as winding applications.

In the previous two examples of ratchet-equipped housings, the ratchet mechanisms were integrated with the pinion of the gear section. Both of these examples require their cylindrical rack assemblies (e.g. rack wheels) to be replaced with cylindrical gear assemblies (the rack section is extended to form a full circular gear). This modification affords a continuous directional drive, and will typically be matched with a tube and grip having a conventional circular profile. The stop block is removed from the housing to make room for the full circular gear.

Note that the tangential ratchet mechanism 4002 can alternatively be integrated with the gear of a cylindrical gear assembly; the full gear permits constant contact with the ratchet mechanism. Integration with the cylindrical gear assembly may provide easier access to the tangential drive selector for the operator's thumb. In addition, depending on the mounting configuration, clamp, and bar chosen, it may be possible to integrate an axial ratchet mechanism with the core of a revised cylindrical gear assembly. In such a configuration, the housing would be clamped at or near the lateral end of a bar or handlebar so that the bar or handlebar would not penetrate through the revised core of a cylindrical gear assembly, but only the clamping section of the housing. The axial ratchet would be incorporated into the housing; and the axial drive selector may exit a hole at the end of the grip and tube.

Constant-grip applications only require a separate axial ratcheting mechanism to be integrated with a revised core of the pinion. Constant-grip applications require no changes to the housings or racks; only the side plate, pinion, pinion hub, and the associated bearings are changed to accommodate the ratchet mechanism. The RA housings can be stationary or rotatable for constant-grip applications. Non-cylindrical tubes and grips having extruded leading edges may be used for the constant-grip RHA.

The pinion for constant-grip applications has two hubs, one inside the other, each with its own respective bearing. As described above for FIG. 40B, the pinion may be manufactured with a larger diameter and core, and both external and internal teeth. The pinion gear is formed with an enlarged hub having its own external bearing. This enlarged hub accommodates a second hub which fits inside the pinion's hub and connects to the drive section of the mechanism. This second hub is provided with its own external bearing deeper in the extended pinion bearing recess (hub bearing number two), and most importantly, this second hub houses the axial ratchet assembly shown in FIG. 40B. This two-hub pinion, along with the associated axial ratcheting assembly, enables constant-grip applications in both stationary and rotatable housings with cylindrical rack assemblies. The hole in the side plate for the axial drive selector is the only external feature of this constant-grip configuration.

For both constant-grip and re-grip applications, the screw, coupler, and piston may be exchanged for other components more appropriate for continuous directional drive mechanisms (such as tensioning tools). When appropriate, the screw, coupler/piston, and housing specifications for ratcheting applications can be determined by the total load and total linear displacement required for a particular application. Total load can also determine the gear tooth size and pinion bearing specifications.

Various embodiments of the invention have been described. The descriptions are intended to be illustrative, not limiting. Thus, it will be apparent to one skilled in the art that certain modifications may be made to the invention as described herein without departing from the scope of the claims set out below.

I claim:

1. Apparatus for effecting control of the operation of a machine that comprises a bar and a power-transmitting assembly, comprising a rotatable assembly for receiving a rotational input from an operator, wherein:
the rotatable assembly is adapted to be mounted on or to the bar; and
the rotatable assembly is adapted to be operably connected to the power-transmitting assembly to enable actuation of the power-transmitting assembly.

2. Apparatus as in claim 1, wherein the rotatable assembly comprises a rotatable handgrip.

3. Apparatus as in claim 1, wherein the rotatable assembly is adapted to effect movement of a cable of the power-transmitting assembly, thereby actuating the power-transmitting assembly.

4. Apparatus as in claim 3, wherein the rotatable assembly further comprises a stationary housing in which one or more components of the rotatable assembly are positioned.

5. Apparatus as in claim 3, wherein the rotatable assembly further comprises a rotatable housing in which one or more components of the rotatable assembly are positioned.

6. Apparatus as in claim 1, wherein the rotatable assembly is adapted to effect movement of hydraulic fluid through a hydraulic line of the power-transmitting assembly, thereby actuating the power-transmitting assembly.

7. Apparatus as in claim 6, wherein the rotatable assembly further comprises a stationary housing in which one or more components of the rotatable assembly are positioned.

8. Apparatus as in claim 6, wherein the rotatable assembly further comprises a rotatable housing in which one or more components of the rotatable assembly are positioned.

9. Apparatus as in claim 1, wherein the rotatable assembly further comprises a stationary housing in which one or more components of the rotatable assembly are positioned.

10. Apparatus as in claim 1, wherein the rotatable assembly further comprises a rotatable housing in which one or more components of the rotatable assembly are positioned.

11. Apparatus as in claim 10, wherein the rotatable assembly further comprises a rotatable handgrip.

12. Apparatus as in claim 10, wherein the rotatable assembly further comprises a fixed handgrip.

13. Apparatus as in claim 1, further comprising a lever assembly, wherein:
the lever assembly is adapted to be mounted on or to the bar; and
the lever assembly is adapted to be operably connected to a controllable assembly to enable actuation of the controllable assembly.

14. Apparatus as in claim 13, wherein the actuated assembly comprises a kinetic energy conversion assembly.

15. Apparatus as in claim 14, wherein the kinetic energy conversion assembly comprises a brake assembly.

16. Apparatus as in claim 1, wherein:
the power-transmitting assembly is a first assembly that can be actuated and the vehicle further comprises a second assembly that can be actuated; and
the rotatable assembly is adapted to be operably connected to the second assembly to enable actuation of the second assembly.

17. Apparatus as in claim 16, wherein the second assembly is a kinetic energy conversion assembly.

18. Apparatus as in claim 16, wherein the second assembly is a power-producing assembly.

19. Apparatus as in claim 1, further comprising a lever assembly attached to the rotatable assembly, wherein the lever assembly is adapted to be operably connected to a kinetic energy conversion assembly to enable actuation of the kinetic energy conversion assembly.

20. Apparatus as in claim 1, wherein the machine comprises a vehicle.

21. Apparatus as in claim 20, wherein the machine comprises a two-wheeled vehicle.

22. Apparatus as in claim 21, wherein the machine comprises a motorcycle.

23. Apparatus as in claim 1, wherein the power-transmitting assembly comprises a clutch assembly.

24. Apparatus as in claim 1, wherein the rotatable assembly is adapted to enable removal from the bar without altering the composition of the bar.

25. Apparatus for effecting control of the operation of a machine that comprises a bar and a kinetic energy conversion assembly, comprising a rotatable assembly for receiving a rotational input from an operator, wherein:
the rotatable assembly is adapted to be mounted on or to the bar; and
the rotatable assembly is adapted to be operably connected to the kinetic energy conversion assembly to enable actuation of the kinetic energy conversion assembly.

26. Apparatus as in claim 25, wherein the rotatable assembly comprises a rotatable handgrip.

27. Apparatus as in claim 25, wherein the rotatable assembly is adapted to effect movement of a cable of the kinetic energy conversion assembly, thereby actuating the kinetic energy conversion assembly.

28. Apparatus as in claim 27, wherein the rotatable assembly further comprises a stationary housing in which one or more components of the rotatable assembly are positioned.

29. Apparatus as in claim 27, wherein the rotatable assembly further comprises a rotatable housing in which one or more components of the rotatable assembly are positioned.

30. Apparatus as in claim 25, wherein the rotatable assembly is adapted to effect movement of hydraulic fluid through a hydraulic line of the kinetic energy conversion assembly, thereby actuating the kinetic energy conversion assembly.

31. Apparatus as in claim 30, wherein the rotatable assembly further comprises a stationary housing in which one or more components of the rotatable assembly are positioned.

32. Apparatus as in claim 30, wherein the rotatable assembly further comprises a rotatable housing in which one or more components of the rotatable assembly are positioned.

33. Apparatus as in claim 25, wherein the rotatable assembly further comprises a stationary housing in which one or more components of the rotatable assembly are positioned.

34. Apparatus as in claim 25, wherein the rotatable assembly further comprises a rotatable housing in which one or more components of the rotatable assembly are positioned.

35. Apparatus as in claim 34, wherein the rotatable assembly further comprises a rotatable handgrip.

36. Apparatus as in claim 34, wherein the rotatable assembly further comprises a fixed handgrip.

37. Apparatus as in claim 25, further comprising a lever assembly, wherein:
the lever assembly is adapted to be mounted on or to the bar; and
the lever assembly is adapted to be operably connected to a controllable assembly to enable actuation of the controllable assembly.

38. Apparatus as in claim 37, wherein the actuated assembly is a power-transmitting assembly.

39. Apparatus as in claim 38, wherein the power-transmitting assembly comprises a clutch assembly.

40. Apparatus as in claim 25, wherein the rotatable assembly is a first assembly that enables actuation of the kinetic energy conversion assembly and the machine further comprises a second assembly for actuating the kinetic energy conversion assembly.

41. Apparatus as in claim 40, wherein the second assembly comprises a foot-actuated pedal.

42. Apparatus as in claim 40, wherein the rotatable assembly and second assembly are each adapted to effect movement of a cable or rod of the kinetic energy conversion assembly, thereby actuating the kinetic energy conversion assembly.

43. Apparatus as in claim 40, wherein the rotatable assembly and second assembly are each adapted to effect movement of hydraulic fluid through a hydraulic line of the kinetic energy conversion assembly, thereby actuating the kinetic energy conversion assembly.

44. Apparatus as in claim 25, wherein:
the kinetic energy conversion assembly is a first assembly that can be actuated and the vehicle further comprises a second assembly that can be actuated; and
the rotatable assembly is adapted to be operably connected to the second assembly to enable actuation of the second assembly.

45. Apparatus as in claim 44, wherein the second assembly is a power-transmitting assembly.

46. Apparatus as in claim 44, wherein the second assembly is a power-producing assembly.

47. Apparatus as in claim 25, further comprising a lever assembly attached to the rotatable assembly, wherein the lever assembly is adapted to be operably connected to a power-transmitting assembly to enable actuation of the power-transmitting assembly.

48. Apparatus as in claim 25, wherein the machine comprises a vehicle.

49. Apparatus as in claim 48, wherein the machine comprises a two-wheeled vehicle.

50. Apparatus as in claim 49, wherein the machine comprises a motorcycle.

51. Apparatus as in claim 25, wherein the kinetic energy conversion assembly comprises a brake assembly.

52. Apparatus as in claim 25, wherein the rotatable assembly is adapted to enable removal from the bar without altering the composition of the bar.
